(19) United States
(12) Patent Application Publication
(10) Pub. No.: US 2026/0226812 A1
(43) Pub. Date: Aug. 6, 2026

(54) LOW INTERFACIAL TENSION INJECTION FLUID FOR TREATING SUBTERRANEAN FORMATION

(71) Applicant: CHEVRON U.S.A. INC., San Ramon, CA (US)

(72) Inventors: Gayani Wasana PINNAWALA, Katy, TX (US); Guo-Qing TANG, Mountain View, CA (US); Mohamad Ali SALMAN, Houston, TX (US); Varadarajan DWARAKANATH, Houston, TX (US); Taimur MALIK, Houston, TX (US)

(21) Appl. No.: 19/530,811

(22) Filed: Feb. 5, 2026

Related U.S. Application Data
(60) Provisional application No. 63/754,502, filed on Feb. 5, 2025.

(51) Int. Cl. E21B 37/06; C09K 8/524

(52) U.S. Cl. CPC E21B 37/06; C09K 8/524

(57) ABSTRACT

Described herein are compositions and methods for treating a subterranean formation with a fluid. Described are also methods for treating scale deposit formation in a wellbore, on surface structures fluidly connected to a wellbore, on equipment connected to a wellbore, and/or in a subterranean formation.

### CROSS REFERENCE TO RELATED APPLICATION

This application claims priority to U.S. provisional application No. 63/754,502, filed on Feb. 5, 2025, the entire disclosure of which is incorporated herein by reference. The application is also related to U.S. Pat. No. 12,352,149 which is incorporated herein by reference.

### BACKGROUND

Enhanced oil recovery (EOR) is an increasingly important supplemental technique for recovering oil from a reservoir after primary and secondary recovery. Many hydrocarbon reservoirs trap a significant amount of oil that is bound tightly and difficult to remove by traditional water flooding methods. There is an ongoing need to develop cost-effective and improved additives for oil recovery from hydrocarbon reservoirs.

### SUMMARY

Described herein are methods for treating a subterranean formation with a fluid, including: (a) combining a single-phase liquid surfactant package with an aqueous-based injection fluid to form a low interfacial tension (IFT) injection fluid having an interfacial tension (IFT) of from 0.005 to 1 with a hydrocarbon phase present in the subterranean formation; and (b) introducing the low interfacial tension (IFT) injection fluid into the subterranean formation.

Described herein are also methods for treating scale deposit formation in a wellbore, on surface structures fluidly connected to a wellbore, on equipment connected to a wellbore, and/or in a subterranean formation, including: (a) combining a single-phase liquid surfactant package with an aqueous-based injection fluid to form a low interfacial tension (IFT) injection fluid having an interfacial tension (IFT) of from 0.005 to 1 with a hydrocarbon phase present in the subterranean formation; (b) introducing the low interfacial tension (IFT) injection fluid into the wellbore, on surface structures fluidly connected to the wellbore, on equipment connected to the wellbore, and/or in the subterranean formation; and (c) allowing the low interfacial tension (IFT) injection fluid to contact the wellbore, the surface structures fluidly connected to the wellbore, the equipment connected to the wellbore, and/or the subterranean formation for a period of time.

Described herein are also methods for fracturing an unconventional subterranean formation with a fluid, including: (a) combining a single-phase liquid surfactant package with an aqueous-based injection fluid to form a low interfacial tension (IFT) injection fluid having an interfacial tension (IFT) of from 0.005 to 1 with a hydrocarbon phase present in the subterranean formation; and (b) injecting the low interfacial tension (IFT) injection fluid through a wellbore and into the unconventional subterranean formation at a sufficient pressure and at a sufficient rate to fracture the unconventional subterranean formation.

Described herein are also methods for treating a subterranean formation with a fluid, including: (a) combining a single-phase liquid surfactant package with an aqueous-based injection fluid to form a low interfacial tension (IFT) injection fluid having an interfacial tension (IFT) of from 0.005 to 1 with a hydrocarbon phase present in the subterranean formation; and (b) introducing the low IFT injection fluid into the unconventional subterranean formation.

In some embodiments, the single-phase liquid surfactant package can include a non-ionic surfactant and an anionic surfactant. In some embodiments, the single-phase liquid surfactant package can include a non-ionic surfactant and at least two anionic surfactants. In some embodiments, the single-phase liquid surfactant package can include at least two non-ionic surfactants and at least two anionic surfactants.

In some embodiments, the single-phase liquid surfactant package can include at least two non-ionic surfactants and an anionic surfactant.

### BRIEF DESCRIPTION OF THE DRAWINGS

The drawings illustrate only example embodiments of methods, systems, and devices for stabilizing injection fluids and are therefore not to be considered limiting of its scope, as aspects of the disclosure may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIG. 1 is a graph showing interfacial tension for formulation 1 (C16-18 ethoxylated alcohol and disulfonate) and formulation 2 (C16-18 ethoxylated alcohol, Guerbet C28 alkoxylate alcohol, and disulfonate) with different shale and tight reservoir oils.

FIG. 2 is graph showing oil recovery over imbibition time for imbibition test for 0.3% formulation 2 in brine, 0.3% formulation 1 in brine, and brine at 158° F.

FIG. 3 is a graph showing the IFT of formulations 48, 38, 53, 51, and 52.

FIGS. 4A-4C show results of oil recovery over time for formulation 39 compared to formulation 1. FIG. 4A shows a graph of oil recovery over imbibition time for formulation 39 compared to formulation 1. FIGS. 6B-6C show images of produced oil using formulation 39 at 10 minutes (4B) and 60 minutes (4C), the images show no emulsion issue.

FIGS. 5A-5D show results of oil recovery over time for a formulation including 0.15:0.15:0.2 C16-18-25EO, C12-14-40EO, and a disulfonate (formulation 40) compared to formulation 1. FIG. 5A shows a graph of oil recovery over imbibition time for formulation 40 compared to formulation 1. FIGS. 5B-5D show images of produced oil using formulation 40 at 10 minutes (5B), 60 minutes (5C), and 180 minutes (5D), the images show no emulsion issue.

FIGS. 6A-6C show results of oil recovery over time for formulation 40 at different concentrations. FIG. 6A shows a graph of oil recovery over imbibition time for formulation 40 at 0.5% and 0.3%. FIGS. 6B-6C show images of produced oil using 0.5% formulation 40 at 10 minutes (6B) and 30 minutes (6C), the images show no emulsion issue at 30 minutes.

FIGS. 7A-7E show results of oil recovery over time for formulation 40 compared to formulation 1 for volatile oil. FIG. 7A shows a graph of oil recovery over imbibition time for formulation 40 compared to formulation 1. FIG. 7B shows an image of produced oil using 0.5% formulation 1 at 1000 minutes, the image shows emulsion issue. FIGS. 7C-7E show images of produced oil using 0.3% formulation 40 at 5 minutes (7C), 30 minutes (7D), and 90 minutes (7E), the images show no emulsion issue.

FIGS. 8A-8D are graphs showing the aqueous stability temperature at different salinities for formulation 2 (8A), formulation C12-14 ethoxylated alcohol and disulfonate (3:2) (8B), formulation 1 (8C), and formulation C9-11 ethoxylate alcohol and disulfonate 1:0.3 (8D).

### DETAILED DESCRIPTION

A number of embodiments of the disclosure have been described. Nevertheless, it will be understood that various modifications may be made without departing from the spirit and scope of the invention. Accordingly, other embodiments are within the scope of the following claims.

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs. Unless otherwise specified, all percentages are in weight percent and the pressure is in atmospheres. All citations referred to herein are expressly incorporated by reference.

### General Definitions

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Ranges can be expressed herein as from “about” one particular value, and/or to “about” another particular value. By “about” is meant within 10% of the value, e.g., within 9, 8, 7, 6, 5, 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. A range may be construed to include the start and the end of the range. For example, a range of 10% to 20% (i.e., range of 10%-20%) can includes 10% and also includes 20%, and includes percentages in between 10% and 20%, unless explicitly stated otherwise herein.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if a composition is described herein as including a component of type A, a component of type B, a component of type C, or any combination thereof, it is understood that this phrase describes all of the various individual and collective combinations and permutations of these components. For example, in some embodiments, the composition described by this phrase could include only a component of type A. In some embodiments, the composition described by this phrase could include only a component of type B. In some embodiments, the composition described by this phrase could include only a component of type C. In some embodiments, the composition described by this phrase could include a component of type A and a component of type B. In some embodiments, the composition described by this phrase could include a component of type A and a component of type C. In some embodiments, the composition described by this phrase could include a component of type B and a component of type C. In some embodiments, the composition described by this phrase could include a component of type A, a component of type B, and a component of type C. In some embodiments, the composition described by this phrase could include two or more components of type A (e.g., A1 and A2). In some embodiments, the composition described by this phrase could include two or more components of type B (e.g., B1 and B2). In some embodiments, the composition described by this phrase could include two or more components of type C (e.g., C1 and C2). In some embodiments, the composition described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the composition described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the composition described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

The term “hydrocarbon” refers to a compound containing only carbon and hydrogen atoms.

“Hydrocarbon-bearing formation” or simply “formation” refers to the rock matrix in which a wellbore may be drilled. For example, a formation refers to a body of rock that is sufficiently distinctive and continuous such that it can be mapped. It should be appreciated that while the term “formation” generally refers to geologic formations of interest, that the term “formation,” as used herein, may, in some instances, include any geologic points or volumes of interest (such as a survey area).

“Unconventional formation” is a subterranean hydrocarbon-bearing formation that generally requires intervention in order to recover hydrocarbons from the reservoir at economic flow rates or volumes. For example, an unconventional formation includes reservoirs having an unconventional microstructure in which fractures are used to recover hydrocarbons from the reservoir at sufficient flow rates or volumes (e.g., an unconventional reservoir generally needs to be fractured under pressure or have naturally occurring fractures in order to recover hydrocarbons from the reservoir at sufficient flow rates or volumes).

In some embodiments, the unconventional formation can include a reservoir having a permeability of less than 25 millidarcy (mD) (e.g., 20 mD or less, 15 mD or less, 10 mD or less, 5 mD or less, 1 mD or less, 0.5 mD or less, 0.1 mD or less, 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, 0.000001 mD or less, or less). In some embodiments, the unconventional formation can include a reservoir having a permeability of at least 0.000001 mD (e.g., at least 0.000005 mD, at least 0.00001 mD, 0.00005 mD, at least 0.0001 mD, 0.0005 mD, 0.001 mD, at least 0.005 mD, at least 0.01 mD, at least 0.05 mD, at least 0.1 mD, at least 0.5 mD, at least 1 mD, at least 5 mD, at least 10 mD, at least 15 mD, or at least 20 mD).

The unconventional formation can include a reservoir having a permeability ranging from any of the minimum values described above to any of the maximum values described above. For example, in some embodiments, the unconventional formation can include a reservoir having a permeability of from 0.000001 mD to 25 mD (e.g., from 0.001 mD to 25 mD, from 0.001 mD to 10 mD, from 0.01 mD to 10 mD, from 0.1 mD to 10 mD, from 0.001 mD to 5 mD, from 0.01 mD to 5 mD, or from 0.1 mD to 5 mD). The permeability of a particular formation can be determined by averaging measured permeability values from a series of representative core samples obtained from the formation.

The formation may include faults, fractures (e.g., naturally occurring fractures, fractures created through hydraulic fracturing, etc.), geobodies, overburdens, underburdens, horizons, salts, salt welds, etc. The formation may be onshore, offshore (e.g., shallow water, deep water, etc.), etc.

Furthermore, the formation may include hydrocarbons, such as liquid hydrocarbons (also known as oil or petroleum), gas hydrocarbons, a combination of liquid hydrocarbons and gas hydrocarbons (e.g., including gas condensate), etc.

The formation, the hydrocarbons, or both may also include non-hydrocarbon items, such as pore space, connate water, brine, fluids from enhanced oil recovery, etc. The formation may also be divided up into one or more hydrocarbon zones, and hydrocarbons can be produced from each desired hydrocarbon zone.

The term formation may be used synonymously with the term “reservoir” or “subsurface reservoir” or “subsurface region of interest” or “subsurface formation” or “subsurface volume of interest” or “subterranean formation”. For example, in some embodiments, the reservoir may be, but is not limited to, a shale reservoir, a carbonate reservoir, a tight sandstone reservoir, a tight siltstone reservoir, etc. Indeed, the terms “formation,” “hydrocarbon,” and the like are not limited to any description or configuration described herein.

A “wellbore” refers to a single hole, usually cylindrical, that is drilled into a subsurface volume of interest. A wellbore may be drilled in one or more directions. For example, a wellbore may include a vertical wellbore, a horizontal wellbore, a deviated wellbore, and/or other type of wellbore. A wellbore may be drilled in the formation for exploration and/or recovery of resources. For example, a wellbore may be drilled in the formation to aid in extraction and/or production of resources such as hydrocarbons. As another example, a wellbore may be drilled in the formation for fluid injection. A plurality of wellbores (e.g., tens to hundreds of wellbores) are often used in a field depending on the desired outcome.

A wellbore may be drilled into a formation using practically any drilling technique and equipment known in the art, such as geosteering, directional drilling, etc. Drilling the wellbore may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling (SWD) tools, wireline tools, logging-while-drilling (LWD) tools, or other downhole tools. After drilling to a predetermined depth, the drill string and the drill bit may be removed, and then the casing, the tubing, and/or other equipment may be installed according to the design of the wellbore. The equipment to be used in drilling the wellbore may be dependent on the design of the wellbore, the formation, the hydrocarbons, and/or other factors.

A wellbore may include a plurality of components, such as, but not limited to, a casing, a liner, a tubing string, a sensor, a packer, a screen, a gravel pack, artificial lift equipment (e.g., an electric submersible pump (ESP)), and/or other components. If a wellbore is drilled offshore, the wellbore may include one or more of the previous components plus other offshore components, such as a riser. A wellbore may also include equipment to control fluid flow into the wellbore, control fluid flow out of the wellbore, or any combination thereof. For example, a wellbore may include a wellhead, a choke, a valve, and/or other control devices. These control devices may be located on the surface, in the subsurface (e.g., downhole in the wellbore), or any combination thereof. In some embodiments, the same control devices may be used to control fluid flow into and out of the wellbore. In some embodiments, different control devices may be used to control fluid flow into and out of a wellbore. In some embodiments, the rate of flow of fluids through the wellbore may depend on the fluid handling capacities of the surface facility that is in fluidic communication with the wellbore. The equipment to be used in controlling fluid flow into and out of a wellbore may be dependent on the wellbore, the formation, the surface facility, and/or other factors. Moreover, sand control equipment and/or sand monitoring equipment may also be installed (e.g., downhole and/or on the surface). A wellbore may also include any completion hardware that is not discussed separately. The term “wellbore” may be used synonymously with the terms “borehole,” “well,” or “well bore.” The term “wellbore” is not limited to any description or configuration described herein.

“Single-phase liquid or fluid,” as used herein, refers to a fluid which only has a single-phase, i.e. only a water phase. A single-phase fluid is not an emulsion. A single-phase fluid is in a thermodynamically stable state such that it does not macroscopically separate into distinct layers or precipitate out solid particles.

“Aqueous stable,” as used herein, refers to a solution whose soluble components remain dissolved and is a single phase as opposed to precipitating as particulates or phase separating into 2 or more phases. As such, aqueous stable solutions are clear and transparent statically and when agitated. Conversely, solutions may be described as “aqueous unstable” when components precipitate from solution as particulates or phase separates into 2 or more phases. The aqueous stability of solutions can be assessed by evaluating whether the Tyndall Effect (light scattering by suspended particulates) is observed when monochromatic light is directed through the solution. If a sample exhibits the Tyndall effect, the solution may be characterized as “aqueous unstable.” Conversely, if a sample does not exhibit the Tyndall effect, the solution may be characterized as “aqueous stable.”

“Slickwater,” as used herein, refers to water-based injection fluid comprising a friction reducer which is typically pumped at high rates to fracture a reservoir. Optionally when employing slickwater, smaller sized proppant particles (e.g., 40/70 or 50/140 mesh size) are used due to the fluid having a relatively low viscosity (and therefore a diminished ability to transport sizable proppants relative to more viscous fluids). In some embodiments, proppants are added to some stages of completion/stimulation during production of an unconventional reservoir. In some embodiments, slickwater is injected with a small quantity of proppant.

“Friction reducer,” as used herein, refers to a chemical additive that alters fluid rheological properties to reduce friction created within the fluid as it flows through small-diameter tubulars or similar restrictions (e.g., valves, pumps). Generally polymers, or similar friction reducing agents, add viscosity to the fluid, which reduces the turbulence induced as the fluid flows. Reductions in fluid friction of greater than 50% are possible depending on the friction reducer utilized, which allows the injection fluid to be injected into a wellbore at a much higher injection rate (e.g., between 60 to 100 barrels per minute) and also lower pumping pressure during proppant injection.

In some embodiments, the friction reducer can include, for example, a synthetic polymer selected from polyacrylamides, polyacrylic acid (PAA), polyvinyl alcohol (PVA), co-polymers of polyacrylamide (PAM) and 2-acrylamido 2-methylpropane sulfonic acid, or any combination thereof.

In some embodiments, the aqueous fluid can include a friction reducer. Examples of friction reducers are known in the art. Examples of suitable polymers include synthetic polymers such as polyacrylamides. Examples of suitable polymers include synthetic polymers such as partially hydrolyzed polyacrylamides (HPAMs or PHPAs) and hydrophobically-modified associative polymers (APs). Also included are co-polymers of polyacrylamide (PAM) and one or both of 2-acrylamido 2-methylpropane sulfonic acid (and/or sodium salt) commonly referred to as AMPS (i.e., acrylamido tertiobutyl sulfonic acid or ATBS), N-vinyl pyrrolidone (NVP), and the NVP-based synthetic may be single-, co-, or ter-polymers. In one embodiment, the synthetic polymer is polyacrylic acid (PAA). In one embodiment, the synthetic polymer is polyvinyl alcohol (PVA). Copolymers may be made of any combination or mixture above, for example, a combination of NVP and ATBS. Indeed, the terminology “mixtures thereof” or “combinations thereof” can include “modifications thereof” herein.

In some embodiments, the friction reducer can be present in the aqueous fluid in a concentration of at least 0.1 gpt (e.g., at least 0.5 gpt, at least 1 gpt, at least 2 gpt, at least 3 gpt, or at least 4 gpt). In some embodiments, the friction reducer can be present in the aqueous fluid in a concentration of 5 gpt or less (e.g., 4 gpt or less, 3 gpt or less, 2 gpt or less, 1 gpt or less, or 0.5 gpt or less).

The friction reducer can be present in the aqueous fluid in a concentration ranging from any of the minimum values described above to any of the maximum values described above. For example, in some embodiments, the friction reducer can be present in the aqueous fluid in a concentration ranging from 0.1 gpt to 5 gpt (e.g., from 0.1 gpt to 4.5 gpt, from 0.1 gpt to 4 gpt, from 0.1 gpt to 3.5 gpt, from 0.1 gpt to 3 gpt, from 0.1 gpt to 2.5 gpt, from 0.1 gpt to 2 gpt, from 0.1 gpt to 1.5 gpt, from 0.1 gpt to 1 gpt, from 0.1 gpt to 0.5 gpt, from 1 gpt to 2 gpt, from 1 gpt to 3 gpt, from 1 gpt to 4 gpt, from 1 gpt to 5 gpt, from 0.5 gpt to 2 gpt, from 0.5 gpt to 3 gpt, from 0.5 gpt to 4 gpt, from 0.5 gpt to 5 gpt, from 2 gpt to 4 gpt, from 2 gpt to 5 gpt, from 2 gpt to 3 gpt, from 3 gpt to 5 gpt, from 3 gpt to 4 gpt, or from 4 gpt to 5 gpt).

“Injection fluid” or “LPS injection fluid,” as used herein, refers to any fluid which is injected into a reservoir via a well. The injection fluid may include one or more of an acid, a polymer, a friction reducer, a gelling agent, a crosslinker, a scale inhibitor, a breaker, a pH adjusting agent, a non-emulsifier agent, an iron control agent, a corrosion inhibitor, a biocide, a clay stabilizing agent, a proppant, a wettability alteration chemical, a co-solvent (e.g., a C1-C5 alcohol, or an alkoxylated C1-C5 alcohol), or any combination thereof, to increase the efficacy of the injection fluid.

“Fracturing fluid,” as used herein, refers to a low interfacial tension fluid that is injected into the well under pressure in order to cause fracturing within a portion of the reservoir.

The term “interfacial tension” or “IFT” as used herein refers to the surface tension between test oil and water of different salinities containing a surfactant formulation at different concentrations. Typically, interfacial tensions are measured using a spinning drop tensiometer or calculated from phase behavior experiments. The units of the “interfacial tension” or “IFT” used herein is in dynes/cm unless otherwise stated.

The term “proximate” is defined as “near”. If item A is proximate to item B, then item A is near item B. For example, in some embodiments, item A may be in contact with item B. For example, in some embodiments, there may be at least one barrier between item A and item B such that item A and item B are near each other, but not in contact with each other. The barrier may be a fluid barrier, a non-fluid barrier (e.g., a structural barrier), or any combination thereof. Both scenarios are contemplated within the meaning of the term “proximate.”

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e., organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity).

Heavier crudes generally yield more heat upon burning, but have lower gravity as defined by the American Petroleum Institute (API) (i.e., API gravity) and market price in comparison to light (or sweet) crude oils. Crude oil may also be characterized by its Equivalent Alkane Carbon Number (EACN). The term “API gravity” refers to the measure of how heavy or light a petroleum liquid is compared to water. If an oil's API gravity is greater than 10, it is lighter and floats on water, whereas if it is less than 10, it is heavier and sinks. API gravity is thus an inverse measure of the relative density of a petroleum liquid and the density of water. API gravity may also be used to compare the relative densities of petroleum liquids. For example, if one petroleum liquid floats on another and is therefore less dense, it has a greater API gravity.

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin-based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are sensitive to temperature changes than the paraffin-based crudes. (iii) Mixed based crude oils contain both paraffin and naphthenes, as well as aromatic hydrocarbons. Most crude oils fit this latter category.

“Reactive” crude oil, as referred to herein, is crude oil containing natural organic acidic components (also referred to herein as unrefined petroleum acid) or their precursors such as esters or lactones. These reactive crude oils can generate soaps (carboxylates) when reacted with alkali. More terms used interchangeably for crude oil throughout this disclosure are hydrocarbons, hydrocarbon material, or active petroleum material. An “oil bank” or “oil cut” as referred to herein, is the crude oil that does not contain the injected chemicals and is pushed by the injected fluid during an enhanced oil recovery process. A “nonactive oil,” as used herein, refers to an oil that is not substantially reactive or crude oil not containing significant amounts of natural organic acidic components or their precursors such as esters or lactones such that significant amounts of soaps are generated when reacted with alkali. A nonactive oil as referred to herein includes oils having an acid number of less than 0.5 mg KOH/g of oil.

“Unrefined petroleum acids” as referred to herein are carboxylic acids contained in active petroleum material (reactive crude oil). The unrefined petroleum acids contain C₁₁-C₂₀ alkyl chains, including napthenic acid mixtures. The recovery of such “reactive” oils may be performed using alkali (e.g., NaOH, NaHCO₃, or Na₂CO₃) in a surfactant composition. The alkali reacts with the acid in the reactive oil to form soap in situ. These in situ generated soaps serve as a source of surfactants minimizing the levels of added surfactants, thus enabling efficient oil recovery from the reservoir.

The term “polymer” refers to a molecule having a structure that essentially includes the multiple repetitions of units derived, actually or conceptually, from molecules of low relative molecular mass. In some embodiments, the polymer is an oligomer.

The term “productivity” as applied to a petroleum or oil well refers to the capacity of a well to produce hydrocarbons (e.g., unrefined petroleum); that is, the ratio of the hydrocarbon flow rate to the pressure drop, where the pressure drop is the difference between the average reservoir pressure and the flowing bottom hole well pressure (i.e., flow per unit of driving force).

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. More generally, the less viscous a fluid is, the greater its ease of fluidity.

The term “salinity” as used herein, refers to concentration of salt dissolved in an aqueous phase. Examples for such salts are without limitation, sodium chloride, magnesium and calcium sulfates, and bicarbonates. In more particular, the term salinity as it pertains to the present invention refers to the concentration of salts in brine and surfactant solutions.

Unless defined otherwise, all technical and scientific terms used herein have the same meanings as commonly understood by one of skill in the art to which the disclosed invention belongs. Unless otherwise specified, all percentages are in weight percent and the pressure is in atmospheres.

### Methods

Described herein are methods for treating a subterranean formation with a fluid, including: (a) combining a single-phase liquid surfactant package described herein with an aqueous-based injection fluid to form a low interfacial tension (IFT) injection fluid having an interfacial tension (IFT) of from 0.005 to 1 with a hydrocarbon phase present in the subterranean formation; and (b) introducing the low interfacial tension (IFT) injection fluid into the subterranean formation. In some embodiments, the subterranean formation can include scale deposit.

In some embodiments, the scale deposit can include an asphaltene precipitate, paraffin, or any combination thereof. In some embodiments, the scale deposit can include an asphaltene precipitate. In some embodiments, the method can further include (c) allowing the low interfacial tension (IFT) injection fluid to contact the subterranean formation for a period of time; and (d) producing fluids from the subterranean formation through the wellbore. In some embodiments, the scale deposit can include paraffin.

Described herein are methods for treating scale deposit formation in a wellbore, on surface structures fluidly connected to a wellbore, on equipment connected to a wellbore, and/or in a subterranean formation, including: (a) combining a single-phase liquid surfactant package described herein with an aqueous-based injection fluid to form a low interfacial tension (IFT) injection fluid having an interfacial tension (IFT) of from 0.005 to 1 with a hydrocarbon phase present in the subterranean formation; (b) introducing the low interfacial tension (IFT) injection fluid into the wellbore, on surface structures fluidly connected to the wellbore, on equipment connected to the wellbore, and/or in the subterranean formation; and (c) allowing the low interfacial tension (IFT) injection to contact the wellbore, the surface structures fluidly connected to the wellbore, the equipment connected to the wellbore, and/or the subterranean formation for a period of time.

In some embodiments, the method can further include injecting an aqueous solution into the wellbore, on surface structures fluidly connected to the wellbore, on equipment connected to the wellbore, and/or in the subterranean formation to remove the scale after the allowing step.

In some embodiments, the method can further include ceasing introduction of the low interfacial tension (IFT) injection fluid into the wellbore, on surface structures fluidly connected to the wellbore, on equipment connected to the wellbore, and/or in the subterranean formations before the allowing step.

In some embodiments, the method can further include (d) producing fluids from the subterranean formation through the wellbore.

In some embodiments, the subterranean formation can include an asphaltene concentration of at least 1.5% (e.g., at least 1.6%, at least 1.7%, at least 1.8%, at least 1.9%, at least 2%, at least 2.1%, at least 2.2%, at least 2.3%, at least 2.4%, at least 2.5%, at least 2.6%, at least 2.7%, at least 2.8%, or at least 2.9%).

In some embodiments, the subterranean formation can include an asphaltene concentration of 3% or less (e.g., 1.6% or less, 1.7% or less, 1.8% or less, 1.9% or less, 2% or less, 2.1% or less, 2.2% or less, 2.3% or less, 2.4% or less, 2.5% or less, 2.6% or less, 2.7% or less, 2.8% or less, or 2.9% or less).

The subterranean formation can include an asphaltene concentration ranging from any of the minimum values described above to any of the maximum values described above. For example, in some embodiments, the subterranean formation can include an asphaltene concentration of from 1.5% to 3% (e.g., from 1.5% to 1.75%, from 1.5% to 2%, from 1.5% to 20.25%, from 1.5% to 2.5%, from 1.5% to 20.75%, from 1.75% to 2%, from 1.75% to 20.25%, from 1.75% to 2.5%, from 1.75% to 20.75%, from 1.75% to 3%, from 2% to 20.25%, from 2% to 2.5%, from 2% to 20.75%, from 2% to 3%, from 20.25% to 2.5%, from 20.25% to 20.75%, from 20.25% to 3%, from 2.5% to 2.75%, from 2.5% to 3%, or from 2.75% to 3%).

In some embodiments, the subterranean formation can be an unconventional subterranean formation. In some embodiments, the subterranean formation can be a conventional subterranean formation.

In some embodiments, the introduction of the low interfacial tension (IFT) injection fluid can remove scale and allow for release of hydrocarbons from pores in a rock matrix. The low interfacial tension (IFT) injection fluid can be used during any portion (or during the entirety of a treatment operation. In some embodiments, the low interfacial tension (IFT) injection fluid can be used as part of a completion and/or fracturing operation. For example, the low interfacial tension (IFT) injection fluid can be injected into an unconventional subterranean formation to form and/or extend fractures within the formation.

In certain embodiments, described herein are also methods for fracturing an unconventional subterranean formation with a fluid, including: (a) combining a single-phase liquid surfactant package described with an aqueous-based injection fluid to form a low interfacial tension fluid having an interfacial tension (IFT) of from 0.005 to 1 with a hydrocarbon phase present in the subterranean formation; and (b) injecting the low interfacial tension fluid through a wellbore and into the unconventional subterranean formation at a sufficient pressure and at a sufficient rate to fracture the unconventional subterranean formation.

Sufficient pressures and sufficient rates may vary depending upon depth, rock type, saturation, and/or fracture orientation. In some embodiments, a sufficient pressure and/or sufficient rate are those which may be useful to exceed the parting pressure of the reservoir rock and to transport the fluid and, if present, the proppant (such as sand) into the fractures to hold them open when pumping stops. In some embodiments, for frac operations a sufficient range of pressures may include exceeding the fracture gradient and may vary from as low as 0.4 psi/ft to 1.2 psi/ft rated to the depth of the target formation. The fracture gradient may be determined in some embodiments by conducting an MDT minifrac, step rate test, and/or estimated using Eaton's equation.

In some embodiments, pressure may be limited by wellhead and/or surface equipment ratings, and thus may vary from about 3000 psi to 10,000 psi or even up to 15,000 psi depending upon the equipment. Similarly, the rate may be limited depending upon, for example, whether and how many simultaneous wells are subject to treatment and, in some embodiments, may vary from 60 to 100 bpm per well depending upon on specific equipment and/or well characteristics.

For workover base well cyclic EOR treatments, similar rules apply though we currently treat below the fracture gradient at ranges from 1 to 40 bpm, surface pressures limited by equipment rating between 1,000-9,800 psi. This does not mean we couldn't treat above fracture gradient; many waterfloods inject above frac gradient and this would also be a possibility. This limit is applied to avoid uncontrolled fracturing and to comply with regulations

In some embodiments, the wellbore is a hydraulic fracturing wellbore associated with a hydraulic fracturing well, for example, that may have a substantially vertical portion only, or a substantially vertical portion and a substantially horizontal portion below the substantially vertical portion. In some embodiments, the fracturing operation can be performed in a new well (e.g., a well that has not been previously fractured). In other embodiments, the low interfacial tension (IFT) injection fluid can be used in a fracturing operation in an existing well (e.g., in a refracturing operation).

In some embodiments, the method can comprise performing a fracturing operation on a region of the unconventional subterranean formation proximate to a new wellbore. In some embodiments, the method can comprise performing a fracturing operation on a region of the unconventional subterranean formation proximate to an existing wellbore. In some embodiments, the method can comprise performing a refracturing operation on a previously fractured region of the unconventional subterranean formation proximate to a new wellbore. In some embodiments, the method can comprise performing a refracturing operation on a previously fractured region of the unconventional subterranean formation proximate to an existing wellbore. In some embodiments, the method can comprise performing a fracturing operation on a naturally fractured region of the unconventional subterranean formation proximate to a new wellbore (e.g., an infill well). In some embodiments, the method can comprise performing a fracturing operation on a naturally fractured region of the unconventional subterranean formation proximate to an existing wellbore.

In cases where the fracturing method comprises a refracturing method, the previously fractured region of the unconventional reservoir can have been fractured by any suitable type of fracturing operation. For example, the fracturing operation may include hydraulic fracturing, fracturing using electrodes such as described in U.S. Pat. No. 9,890,627 (Attorney Dkt. No. T-9622A), U.S. Pat. No. 9,840,898 (Attorney Dkt. No. T-9622B), U.S. Patent Publication No. 2018/0202273 (Attorney Dkt. No. T-9622A-CIP), or fracturing with any other available equipment or methodology. In some embodiments, the fracturing operation can further comprise adding a tracer to the low interfacial tension (IFT) injection fluid prior to introducing the low interfacial tension (IFT) injection fluid through the wellbore into the unconventional subterranean formation; recovering the tracer from the fluids produced from the unconventional subterranean formation through the wellbore, fluids recovered from a different wellbore in fluid communication with the unconventional subterranean formation, or any combination thereof, and comparing the quantity of tracer recovered from the fluids produced to the quantity of tracer introduced to the low interfacial tension (IFT) injection fluid. The tracer can comprise a proppant tracer, an oil tracer, a water tracer, or any combination thereof. Example tracers are known in the art, and described, for example, in U.S. Pat. No. 9,914,872 and Ashish Kumar et al., Diagnosing Fracture-Wellbore Connectivity Using Chemical Tracer Flowback Data, URTeC 2902023, Jul. 23-25, 2018, page 1-10, Texas, USA.

The low interfacial tension (IFT) injection fluids can be used at varying points throughout a fracturing operation. For example, the low interfacial tension (IFT) injection fluid can be used as an injection fluid during the first, middle or last part of the fracturing process, or throughout the entire fracturing process. In some embodiments, the fracturing process can include a plurality of stages and/or sub-stages. For example, the fracturing process can involve sequential injection of fluids in different stages, with each of the stages employing a different aqueous-based injection fluid system (e.g., with varying properties such as viscosity, chemical composition, etc.). Example fracturing processes of this type are described, for example, in U.S. Patent Application Publication Nos. 2009/0044945 and 2015/0083420, each of which is hereby incorporated herein by reference in its entirely.

In these embodiments, the low interfacial tension (IFT) injection fluid can be used as an injection fluid (optionally with additional components) during any or all of the stages and/or sub-stages. Stages and/or sub-stages can employ a wide variety of aqueous-based injection fluid systems, including linear gels, crosslinked gels, and friction-reduced water. Linear gel low interfacial tension fluids are formulated with a wide array of different polymers in an aqueous base. Polymers that are commonly used to formulate these linear gels include guar, hydroxypropyl guar (HPG), carboxymethyl HPG (CMHPG), and hydroxyethyl cellulose (HEC). Crosslinked gel low interfacial tension fluids utilize, for example, borate ions to crosslink the hydrated polymers and provide increased viscosity. The polymers most often used in these fluids are guar and HPG. The crosslink obtained by using borate is reversible and is triggered by altering the pH of the fluid system. The reversible characteristic of the crosslink in borate fluids helps them clean up more effectively, resulting in good retained permeability and conductivity. The single-phase liquid surfactant packages described herein can be added to any of these aqueous-based injection fluid systems.

In some embodiments, the single-phase liquid surfactant package can be combined with an aqueous-based injection fluid in a continuous process to form the low interfacial tension (IFT) injection fluid (which is subsequently injected). In other embodiments, the single-phase liquid surfactant package can be intermittently added to an aqueous-based injection fluid, thereby providing the low interfacial tension (IFT) injection fluid only during desired portions of the treatment operation (e.g., during one or more phases or stages of a fracturing operation). For example, the single-phase liquid surfactant package could be added when injecting slickwater, when injecting low interfacial tension fluid with proppant, during an acid wash, or during any combination thereof. In a specific embodiment, the single-phase liquid surfactant package is continuously added to the aqueous injection fluid after acid injection until completion of hydraulic fracturing and completion fluid flow-back. When intermittently dosed, the single-phase liquid surfactant package can be added to the aqueous-based injection fluid once an hour, once every 2 hours, once every 4 hours, once every 5 hours, once every 6 hours, twice a day, once a day, or once every other day, for example.

In some embodiments, when used in a fracturing operation, the low interfacial tension (IFT) injection fluid can have a total surfactant concentration of at least 0.01% by weight (e.g., at least 0.025% by weight, at least 0.05% by weight, at least 0.075% by weight, at least 0.1% by weight, at least 0.25% by weight, at least 0.5% by weight, or at least 0.75% by weight), based on the total weight of the low interfacial tension (IFT) injection fluid.

In some embodiments, when used in a fracturing operation, the low interfacial tension (IFT) injection fluid can have a total surfactant concentration of 1% by weight or less (e.g., 0.75% by weight or less, 0.5% by weight or less, 0.25% by weight or less, 0.1% by weight or less, 0.075% by weight or less, 0.05% by weight or less, or 0.025% by weight or less), based on the total weight of the low interfacial tension (IFT) injection fluid.

When used in a fracturing operation, the low interfacial tension (IFT) injection fluid can have a total surfactant concentration ranging from any of the minimum values described above to any of the maximum values described above. For example, in some embodiments, when used in a fracturing operation, the low interfacial tension (IFT) injection fluid can have a total surfactant concentration of from 0.01% to 1% by weight (from 0.01% to 0.75% by weight, from 0.01% to 0.5% by weight, from 0.01% to 0.25% by weight, from 0.01% to 0.1% by weight, from 0.01% to 0.075% by weight, from 0.01% to 0.05% by weight, from 0.01% to 0.025% by weight, from 0.025% to 1% by weight, from 0.025% to 0.75% by weight, from 0.025% to 0.5% by weight, from 0.025% to 0.25% by weight, from 0.025% to 0.1% by weight, from 0.025% to 0.075% by weight, from 0.025% to 0.05% by weight, from 0.05% to 1% by weight, from 0.05% to 0.75% by weight, from 0.05% to 0.5% by weight, from 0.05% to 0.25% by weight, from 0.05% to 0.1% by weight, from 0.05% to 0.075% by weight, from 0.075% to 1% by weight, from 0.075% to 0.75% by weight, from 0.075% to 0.5% by weight, from 0.075% to 0.25% by weight, from 0.075% to 0.1% by weight, from 0.1% to 1% by weight, from 0.1% to 0.75% by weight, from 0.1% to 0.5% by weight, from 0.1% to 0.25% by weight, from 0.5% to 1% by weight, from 0.5% to 0.75% by weight, from 0.75% to 1% by weight), based on the total weight of the low interfacial tension (IFT) injection fluid.

In some embodiments, the low interfacial tension (IFT) injection fluid can be used as part of a reservoir stimulation operation. In such operations, the fluid can be injected to alter the wettability of existing fractures within the formation (without further fracturing the formation significantly by either forming new fractures within the formation and/or extending the existing fractures within the formation). In such stimulation operations, no proppant is used, and fluid injection generally occurs at a lower pressure.

In some cases, the existing fractures can be naturally occurring fractures present within a formation. For example, in some embodiments, the formation can comprise naturally fractured carbonate or naturally fractured sandstone. The presence or absence of naturally occurring fractures within a subterranean formation can be assessed using standard methods known in the art, including seismic surveys, geology, outcrops, cores, logging, reservoir characterization including preparing grids, etc.

In some embodiments, methods for stimulating a subterranean formation with a fluid can include introducing a low interfacial tension (IFT) injection fluid described through a wellbore into the subterranean formation; allowing the low interfacial tension (IFT) injection fluid to imbibe into a rock matrix of the subterranean formation for a period of time; and producing fluids from the subterranean formation through the wellbore. In these methods, the same wellbore can be used for both introducing the low interfacial tension (IFT) injection fluid and producing fluids from the subterranean formation. In some embodiments, introduction of the low interfacial tension (IFT) injection fluid can increase the production of hydrocarbons from the same wellbore, from a different wellbore in fluid communication with the subterranean formation, or any combination thereof.

In some embodiments, the stimulation operation can further include preparing the low interfacial tension (IFT) injection fluid. For example, in some embodiments, the stimulation operation can further include combining a single-phase liquid surfactant package described herein with an aqueous-based injection fluid to form a low interfacial tension (IFT) injection fluid.

In some embodiments when used in a stimulation operation, the low interfacial tension (IFT) injection fluid can have a total surfactant concentration of at least 0.05% by weight (e.g., at least 0.075% by weight, at least 0.1% by weight, at least 0.25% by weight, at least 0.5% by weight, at least 0.75% by weight, at least 1% by weight, at least 1.25% by weight, at least 1.5% by weight, at least 2% by weight, at least 2.5% by weight, at least 3% by weight, at least 3.5% by weight, at least 4% by weight, or at least 4.5% by weight), based on the total weight of the low interfacial tension (IFT) injection fluid.

In some embodiments when used in a stimulation operation, the low interfacial tension (IFT) injection fluid can have a total surfactant concentration of 5% by weight or less (e.g., 4.5% by weight or less, 4% by weight or less, 3.5% by weight or less, 3% by weight or less, 2.5% by weight or less, 2% by weight or less, 1.5% by weight or less, 1% by weight or less, 0.5% by weight or less, 0.25% by weight or less, 0.1% by weight or less, or 0.075% by weight or less), based on the total weight of the low interfacial tension (IFT) injection fluid.

When used in a stimulation operation, the low interfacial tension (IFT) injection fluid can have a total surfactant concentration ranging from any of the minimum values described above to any of the maximum values described above. For example, in some embodiments, when used in a stimulation operation, the low interfacial tension (IFT) injection fluid can have a total surfactant concentration of from 0.05% to 5% by weight (from 0.075% to 5% by weight, from 0.1% to 5% by weight, from 0.5% to 5% by weight, from 0.75% to 5% by weight, from 1% to 5% by weight, from 1.5% to 5% by weight, from 2% to 5% by weight, from 2.5% to 5% by weight, from 3% to 5% by weight, from 3.5% to 5% by weight, from 4% to 5% by weight, from 4.5% to 5% by weight), based on the total weight of the low interfacial tension (IFT) injection fluid.

In some embodiments, introducing a low interfacial tension (IFT) injection fluid described through a wellbore into the subterranean formation can include injecting the low interfacial tension (IFT) injection fluid through the wellbore and into the subterranean formation at a sufficient pressure and at a sufficient rate to stimulate hydrocarbon production from naturally occurring fractures in the subterranean formation.

The low interfacial tension (IFT) injection fluid can be allowed to imbibe into the rock matrix of the subterranean formation for varying periods of time depending on the nature of the rock matrix. The imbibing can occur during the introducing step, between the introducing and producing step, or any combination thereof. In some examples, the low interfacial tension (IFT) injection fluid can be allowed to imbibe into the rock matrix of the subterranean formation for at least one day (e.g., at least two days, at least three days, at least four days, at least five days, at least six days, at least one week, at least two weeks, at least three weeks, at least one month, at least two months, at least three months, at least four months, or at least five months). In some examples, the low interfacial tension (IFT) injection fluid can be allowed to imbibe into the rock matrix of the subterranean formation for six months or less (e.g., five months or less, four months or less, three months or less, two months or less, one month or less, three weeks or less, two weeks or less, one week or less, six days or less, five days or less, four days or less, three days or less, or two days or less).

The low interfacial tension (IFT) injection fluid can be allowed to imbibe into the rock matrix of the subterranean formation for a period of time ranging from any of the minimum values described above to any of the maximum values described above. For example, the low interfacial tension (IFT) injection fluid can be allowed to imbibe into the rock matrix of the subterranean formation for from one day to six months. In one example, the wellbore can be a new wellbore; and the low interfacial tension (IFT) injection fluid can be allowed to imbibe into the rock matrix of the subterranean formation for from two weeks to one month. In another example, the wellbore can be a wellbore proximate to a previously fractured region of the unconventional subterranean formation; and the low interfacial tension (IFT) injection fluid can be allowed to imbibe into the rock matrix of the subterranean formation for from one day to two weeks.

In some embodiments, the wellbore used in the stimulation operation may have a substantially vertical portion only, or a substantially vertical portion and a substantially horizontal portion below the substantially vertical portion.

In some embodiments, the stimulation methods described herein can include stimulating a naturally fractured region of the subterranean formation proximate to a new wellbore (e.g., an infill well). In some embodiments, the stimulation methods described herein can include stimulating a naturally fractured region of the subterranean formation proximate to an existing wellbore.

In some embodiments, the stimulation methods described herein can include stimulating a previously fractured or previously refractured region of the subterranean formation proximate to a new wellbore (e.g., an infill well). In some embodiments, the stimulation methods described herein can include stimulating a previously fractured or previously refractured region of the subterranean formation proximate to an existing wellbore.

The previous fracturing operation may include hydraulic fracturing, fracturing using electrodes such as described in U.S. Pat. No. 9,890,627 (Attorney Dkt. No. T-9622A), U.S. Pat. No. 9,840,898 (Attorney Dkt. No. T-9622B), U.S. Patent Publication No. 2018/0202273 (Attorney Dkt. No. T-9622A-CIP), or fracturing with any other available equipment or methodology. The previous refracturing operation may include hydraulic fracturing, fracturing using electrodes such as described in U.S. Pat. No. 9,890,627 (Attorney Dkt. No. T-9622A), U.S. Pat. No. 9,840,898 (Attorney Dkt. No. T-9622B), U.S. Patent Publication No. 2018/0202273 (Attorney Dkt. No. T-9622A-CIP), or refracturing with any other available equipment or methodology. In some embodiments, after a formation that has fractures, such as naturally occurring factures, fractures from a fracture operation, fractures from a refracturing operation, or any combination thereof, the fractured formation may be stimulated. For example, a formation may be stimulated after a sufficient amount of time has passed since the fracturing operation with electrodes or refracturing operation with electrodes occurred in that formation so that the electrical pulses utilized to fracture or refracture that formation do not substantially affect the low interfacial tension (IFT) injection fluid.

In some embodiments, the stimulation operation can further comprise adding a tracer to the low interfacial tension (IFT) injection fluid prior to introducing the low interfacial tension (IFT) injection fluid through the wellbore into the subterranean formation; recovering the tracer from the fluids produced from the subterranean formation through the wellbore, fluids recovered from a different wellbore in fluid communication with the subterranean formation, or any combination thereof; and comparing the quantity of tracer recovered from the fluids produced to the quantity of tracer introduced to the low interfacial tension (IFT) injection fluid.

Single-phase liquid surfactant packages (as well as the resulting low interfacial tension (IFT) injection fluids) can be optimized for each reservoir and/or for the type of aqueous-based injection fluid. For example, a single-phase liquid surfactant package can be tested at a specific reservoir temperature and salinity, and with a specific aqueous-based injection fluid. Actual native reservoir fluids may also be used to test the compositions. In an embodiment, the single-phase liquid surfactant package is tested by determining the mean particle size distribution through dynamic light scattering. In specific embodiments, the mean particle size distribution of the aqueous-based injection fluid decreases after addition of the single-phase liquid surfactant package. In embodiments, the average diameter of particle size of the low interfacial tension (IFT) injection fluid (aqueous-based injection fluid plus single-phase liquid surfactant package) is less than 0.1 micrometers. In an embodiment, when tested at the specific reservoir temperature and salinity, the average diameter of the low interfacial tension (IFT) injection fluid is less than 0.1 micrometers. In specific embodiments, the average diameter in particle size distribution measurement of the low interfacial tension (IFT) injection fluid is less than the average pore size of the reservoir rock matrix.

In some embodiments, the subterranean formation can have a temperature of at least 75° F. (e.g., at least 80° F., at least 85° F., at least 90° F., at least 95° F., at least 100° F., at least 105° F., at least 110° F., at least 115F, at least 120° F., at least 125° F., at least 130° F., at least 135° F., at least 140° F., at least 145° F., at least 150° F., at least 155° F., at least 160° F., at least 165° F., at least 170° F., at least 175° F., at least 180° F., at least 190° F., at least 200° F., at least 205° F., at least 210° F., at least 215T, at least 220° F., at least 225° F., at least 230° F., at least 235° F., at least 240° F., at least 245° F., at least 250° F., at least 255° F., at least 260° F., at least 265° F., at least 270° F., at least 275° F., at least 280° F., at least 285° F., at least 290° F., at least 295° F., at least 300° F., at least 305° F., at least 310° F., at least 315° F., at least 320° F., at least 325° F., at least 330° F., at least 335° F., at least 340° F., or at least 345° F.). In some embodiments, the subterranean formation can have a temperature of 350° F. or less (e.g., 345° F. or less, 340° F. or less, 335° F. or less, 330° F. or less, 325° F. or less, 320° F. or less, 315° F. or less, 310° F. or less, 305° F. or less, 300° F. or less, 295° F. or less, 290° F. or less, 285° F. or less, 280° F. or less, 275° F. or less, 270° F. or less, 265° F. or less, 260° F. or less, 255° F. or less, 250° F. or less, 245° F. or less, 240° F. or less, 235° F. or less, 230° F. or less, 225° F. or less, 220° F. or less, 215° F. or less, 210° F. or less, 205° F. or less, 200° F. or less, 195° F. or less, 190° F. or less, 185° F. or less, 180° F. or less, 175° F. or less, 170° F. or less, 165° F. or less, 160° F. or less, 155° F. or less, 150° F. or less, 145° F. or less, 140° F. or less, 135° F. or less, 130° F. or less, 125° F. or less, 120° F. or less, 115° F. or less, 110° F. or less, 105° F. or less, 100° F. or less, 95° F. or less, 90° F. or less, 85° F. or less, or 80° F. or less).

The subterranean formation can have a temperature ranging from any of the minimum values described above to any of the maximum values described above. For example, in some embodiments, the subterranean formation can have a temperature of from 75° F. to 350° F. (approximately 24° C. to 176° C.), from 150° F. to 250° F. (approximately 66° C. to 121° C.), from 110° F. to 350° F. (approximately 43° C. to 176° C.), from 110° F. to 150° F. (approximately 43° C. to 66° C.), from 150° F. to 200° F. (approximately 66° C. to 93° C.), from 200° F. to 250° F. (approximately 93° C. to 121° C.), from 250° F. to 300° F. (approximately 121° C. to 149° C.), from 300° F. to 350° F. (approximately 149° C. to 176° C.), from 110° F. to 240° F. (approximately 43° C. to 116° C.), or from 240° F. to 350° F. (approximately 116° C. to 176° C.).

In some embodiments, the salinity of subterranean formation can be at least 5,000 ppm TDS (e.g., at least 25,000 ppm TDS, at least 50,000 ppm TDS, at least 75,000 ppm TDS, at least 100,000 ppm TDS, at least 125,000 ppm TDS, at least 150,000 ppm TDS, at least 175,000 ppm TDS, at least 200,000 ppm TDS, at least 225,000 ppm TDS, at least 250,000 ppm TDS, or at least 275,000 ppm TDS). In some embodiments, the salinity of subterranean formation can be 300,000 ppm TDS or less (e.g., 275,000 ppm TDS or less, 250,000 ppm TDS or less, 225,000 ppm TDS or less, 200,000 ppm TDS or less, 175,000 ppm TDS or less, 150,000 ppm TDS or less, 125,000 ppm TDS or less, 100,000 ppm TDS or less, 75,000 ppm TDS or less, 50,000 ppm TDS or less, or 25,000 ppm TDS or less).

The salinity of subterranean formation can range from any of the minimum values described above to any of the maximum values described above. For example, in some embodiments, the salinity of subterranean formation can be from 5,000 ppm TDS to 300,000 ppm TDS (e.g., from 100,000 ppm to 300,000 ppm TDS).

In some embodiments, the subterranean formation can be oil-wet. In some embodiments, the subterranean formation can be water-wet. In some embodiments, the subterranean formation can be mixed-wet.

In some embodiments, the low interfacial tension (IFT) injection fluid can be introduced at a wellhead pressure of at least 0 PSI (e.g., at least 1,000 PSI, at least 2,000 PSI, at least 3,000 PSI, at least 4,000 PSI, at least 5,000 PSI, at least 6,000 PSI, at least 7,000 PSI, at least 8,000 PSI, at least 9,000 PSI, at least 10,000 PSI, at least 15,000 PSI, at least 20,000 PSI, or at least 25,000 PSI). In some embodiments, the low interfacial tension (IFT) injection fluid can be introduced at a wellhead pressure of 30,000 PSI or less (e.g., 25,000 PSI or less, 20,000 PSI or less, 15,000 PSI or less, 10,000 PSI or less, 9,000 PSI or less, 8,000 PSI or less, 7,000 PSI or less, 6,000 PSI or less, 5,000 PSI or less, 4,000 PSI or less, 3,000 PSI or less, 2,000 PSI or less, or 1,000 PSI or less).

The low interfacial tension (IFT) injection fluid can be introduced at a wellhead pressure ranging from any of the minimum values described above to any of the maximum values described above. For example, in some embodiments, the low interfacial tension (IFT) injection fluid can be introduced at a wellhead pressure of from 0 PSI to 30,000 PSI (e.g., from 6,000 PSI to 30,000 PSI, or from 5,000 PSI to 10,000 PSI. In some embodiments, the low interfacial tension (IFT) injection fluid can be used in a reservoir stimulation operation, and the low interfacial tension (IFT) injection fluid can be introduced at a wellhead pressure of from 0 PSI to 1,000 PSI.

### Compositions

Described herein low interfacial tension (IFT) injection fluids formed by combining a single-phase liquid surfactant package with an aqueous-based injection fluid. In some embodiments, the single-phase liquid surfactant package can include at least two non-ionic surfactants and an anionic surfactant.

In some embodiments, the single-phase liquid surfactant package can include a non-ionic surfactant and an anionic surfactant.

In some embodiments, the single-phase liquid surfactant package can include a non-ionic surfactant and at least two anionic surfactants. In some embodiments, the single-phase liquid surfactant package can include at least two non-ionic surfactants and at least two anionic surfactants.

In some embodiments, the single-phase liquid surfactant package can include at least two non-ionic surfactants and an anionic surfactant. In some embodiments, the single-phase liquid surfactant package can include a first non-ionic surfactant, a second non-ionic surfactant, and an anionic surfactant.

In some embodiments, the non-ionic surfactants can comprise a hydrophobic tail comprising from 6 to 40 carbon atoms. In some embodiments, the non-ionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, or at least 39 carbon atoms). In some embodiments, the non-ionic surfactant can include a hydrophobic tail that comprises 40 carbon atoms or less (e.g., 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The non-ionic surfactant can include a hydrophobic tail that comprises a number of carbon atoms ranging from any of the minimum values described above to any of the maximum values described above. For example, the non-ionic surfactant can comprise a hydrophobic tail comprising from 6 to 10, from 6 to 12, from 6 to 15, from 6 to 25, from 6 to 30, from 6 to 32, from 6 to 40, from 8 to 32, from 10 to 15, from 10 to 32, from 13 to 22, from 16 to 18, from 16 to 25, from 16 to 30, from 20 to 30, from 20 to 32, from 23 to 32, from 26 to 35, from 26 to 40, from 33 to 40, from 33 to 40, or from 34 to 40, carbon atoms. In some cases, the hydrophobic tail may be a straight chain, and/or branched chain. The hydrophobic carbon tail may comprise single bonds, double bonds, triple bonds, or any combination thereof. In some embodiments, the hydrophobic tail can comprise a branched hydrophobic tail derived from Guerbet alcohols.

In embodiments, the non-ionic surfactant maybe a mix of surfactants with different length lipophilic tail chain lengths. For example, the non-ionic surfactant may be C9-C11:9EO, which indicates a mixture of non-ionic surfactants that have a lipophilic tail length of 9 carbon to 11 carbon, which is followed by a chain of 9 EOs. The hydrophilic moiety is an alkyleneoxy chain (e.g., an ethoxy (EO), butoxy (BO) and/or propoxy (PO) chain with two or more repeating units of EO, BO, and/or PO). In some embodiments, 8-65 repeating units of EO are present. In some embodiments, 7-65 repeating units of PO are present. In some embodiments, 0-25 repeating units of BO are present. For example, the non-ionic surfactant could comprise 30EO:35PO or 25EO.

In embodiments, the non-ionic surfactant may be a mix of surfactants with different length lipophilic tail chain lengths. For example, the non-ionic surfactant may be C23-C30:35PO:30EO, which indicates a mixture of non-ionic surfactants that have a lipophilic tail length of 23 carbon to 30 carbon, which is followed by a chain of 35 POs and 30 EOs. In some embodiments, the non-ionic surfactant can be linear such as C9-C11:9EO. In some embodiments, the non-ionic surfactant is a Guerbet PO(0-65) and EO(0-100) (Guerbet can be C10-C40); or alkyl PO(7-65) and EO(8-65): where the alkyl group is linear or branched C6-C40.

For example, in some embodiments, the non-ionic surfactant can include a branched or unbranched C6-C15:PO(7-65):EO(10-65), C16-C18:PO(7-65):EO(10-65), C16-C18:PO(7-34):EO(10-29), C16-C18:PO(36-65):EO(31-65), C19-C32:PO(7-65):EO(10-65),C8-C15:PO(7-50):EO(20-60), C19-C32:PO(7-50):EO(20-60), C16-C18:PO(7-34):EO(20-29), C16-C18:PO(36-50):EO(31-60), C10-C15:PO(7-65):EO(10-65), C19-C32:PO(7-65):EO(10-65), C24-C32:PO(20-40):EO(20-35), C6-C15:PO(30-40):EO(20-35), C19-C30:PO(30-40):EO(20-35), C20-C30:PO(30-40):EO(20-35), C6-C15:PO(30-40):EO(20-35), C19-C32:PO(30-40):EO(20-35), C20-C32:PO(30-40):EO(20-35), C6-C32:EO(20-30), C6-C32:EO(8-65), C6-C30:EO(20-25), C10-C25:EO(20-25), C9-C22:EO(8-65), or C14-C22:EO(15-25); a cyclic C6-C32:PO(7-65):EO(10-65) C32-C60:PO(7-65):EO(10-65), C40-C60:PO(7-65):EO(10-65), C50-C60:PO(7-65):EO(10-65), C32-C60:PO(36-65):EO(31-65), C32-C60:PO(7-50):EO(20-60), C32-C60:PO(7-34):EO(20-29), C32-C60:PO(36-50):EO(31-60), C32-C60:PO(20-40):EO(20-35), C32-C60:PO(30-40):EO(20-35), C40-C60:PO(30-40):EO(20-35), C50-C60:PO(30-40):EO(20-35), C32-C60:EO(20-30), C32-C60:EO(8-65), C32-C60:EO(20-25), C32-C60:EO(15-25), C40-C60:EO(20-30), C40-C60:EO(8-65), C40-C60:EO(20-25), C40-C60:EO(15-25), C50-C60:EO(20-30), C50-C60:EO(8-65), C50-C60:EO(20-25), or C50-C60:EO(15-25); or any combination thereof. Optionally, the lipophilic tail can include one or more unsaturations.

In some embodiments, the non-ionic surfactant can include a branched C6-C15:PO(7-65):EO(10-65), C16-C18:PO(7-34):EO(10-29), C16-C18:PO(36-65):EO(31-65), C19-C32:PO(7-65):EO(10-65),C8-C15:PO(7-50):EO(20-60), C19-C32:PO(7-50):EO(20-60), C16-C18:PO(7-34):EO(20-29), C16-C18:PO(36-50):EO(31-60), C10-C15:PO(7-65):EO(10-65), C19-C32:PO(7-65):EO(10-65), C24-C32:PO(20-40):EO(20-35), C6-C15:PO(30-40):EO(20-35), C19-C30:PO(30-40):EO(20-35), C20-C30:PO(30-40):EO(20-35), C6-C15:PO(30-40):EO(20-35), C19-C32:PO(30-40):EO(20-35), C20-C32:PO(30-40):EO(20-35), or any combination thereof. Optionally, the lipophilic tail can include one or more unsaturations.

In some embodiments, a non-ionic surfactants can include a branched C6-C15:PO(7-65):EO(10-65). In some embodiments, a non-ionic surfactants can include a branched C19-C40:PO(7-65):EO(10-65). In some embodiments, a non-ionic surfactants can include a branched C16-C18:PO(7-34):EO(10-29). In some embodiments, a non-ionic surfactants can include a branched C16-C18:PO(36-65):EO(31-65). Optionally, the lipophilic tail can include one or more unsaturations.

In some embodiments, a non-ionic surfactant can include a branched, unbranched, or cyclic C6-C32:EO(20-30), C6-C32:EO(8-65), C6-C30:EO(20-25), C10-C25:EO(20-25), C9-C22:EO(8-65), C14-C22:EO(15-25), cyclic C32-C60:EO(20-30), C32-C60:EO(8-65), C32-C60:EO(20-25), C32-C60:EO(15-25), C40-C60:EO(20-30), C40-C60:EO(8-65), C40-C60:EO(20-25), C40-C60:EO(15-25), C50-C60:EO(20-30), C50-C60:EO(8-65), C50-C60:EO(20-25), C50-C60:EO(15-25), or any combination thereof. In some embodiments, a non-ionic surfactant can include a branched C6-C32:EO(20-30), C6-C32:EO(8-65), C6-C32:EO(20-25), C10-C25:EO(20-25), C9-C22:EO(8-65), C14-C22:EO(15-25), or any combination thereof. In some embodiments, the non-ionic surfactant can include a branched C16-18:EO(25). Optionally, the lipophilic tail can include one or more unsaturations.

In some embodiments, the first non-ionic surfactant can include a branched or unbranched C6-C15:PO(7-65):EO(10-65), C16-C18:PO(7-65):EO(10-65), C16-C18:PO(7-34):EO(10-29), C16-C18:PO(36-65):EO(31-65), C19-C32:PO(7-65):EO(10-65),C8-C15:PO(7-50):EO(20-60), C19-C32:PO(7-50):EO(20-60), C16-C18:PO(7-34):EO(20-29), C16-C18:PO(36-50):EO(31-60), C10-C15:PO(7-65):EO(10-65), C19-C32:PO(7-65):EO(10-65), C24-C32:PO(20-40):EO(20-35), C6-C15:PO(30-40):EO(20-35), C19-C30:PO(30-40):EO(20-35), C20-C30:PO(30-40):EO(20-35), C6-C15:PO(30-40):EO(20-35), C19-C32:PO(30-40):EO(20-35), C20-C32:PO(30-40):EO(20-35), C6-C32:EO(20-30), C6-C32:EO(8-65), C6-C30:EO(20-25), C10-C25:EO(20-25), C9-C22:EO(8-65), or C14-C22:EO(15-25); a cyclic C6-C32:PO(7-65):EO(10-65) C32-C60:PO(7-65):EO(10-65), C40-C60:PO(7-65):EO(10-65), C50-C60:PO(7-65):EO(10-65), C32-C60:PO(36-65):EO(31-65), C32-C60:PO(7-50):EO(20-60), C32-C60:PO(7-34):EO(20-29), C32-C60:PO(36-50):EO(31-60), C32-C60:PO(20-40):EO(20-35), C32-C60:PO(30-40):EO(20-35), C40-C60:PO(30-40):EO(20-35), C50-C60:PO(30-40):EO(20-35), C32-C60:EO(20-30), C32-C60:EO(8-65), C32-C60:EO(20-25), C32-C60:EO(15-25), C40-C60:EO(20-30), C40-C60:EO(8-65), C40-C60:EO(20-25), C40-C60:EO(15-25), C50-C60:EO(20-30), C50-C60:EO(8-65), C50-C60:EO(20-25), or C50-C60:EO(15-25); or any combination thereof. Optionally, the lipophilic tail can include one or more unsaturations.

In some embodiments, the first non-ionic surfactant can include a branched C6-C15:PO(7-65):EO(10-65), C16-C18:PO(7-34):EO(10-29), C16-C18:PO(36-65):EO(31-65), C19-C32:PO(7-65):EO(10-65),C8-C15:PO(7-50):EO(20-60), C19-C32:PO(7-50):EO(20-60), C16-C18:PO(7-34):EO(20-29), C16-C18:PO(36-50):EO(31-60), C10-C15:PO(7-65):EO(10-65), C19-C32:PO(7-65):EO(10-65), C24-C32:PO(20-40):EO(20-35), C6-C15:PO(30-40):EO(20-35), C19-C30:PO(30-40):EO(20-35), C20-C30:PO(30-40):EO(20-35), C6-C15:PO(30-40):EO(20-35), C19-C32:PO(30-40):EO(20-35), C20-C32:PO(30-40):EO(20-35), or any combination thereof. In some embodiments, a first non-ionic surfactants can include a branched C6-C15:PO(7-65):EO(10-65). In some embodiments, a first non-ionic surfactants can include a branched C19-C40:PO(7-65):EO(10-65). In some embodiments, a first non-ionic surfactants can include a branched C16-C18:PO(7-34):EO(10-29). In some embodiments, a first non-ionic surfactants can include a branched C16-C18:PO(36-65):EO(31-65). Optionally, the lipophilic tail can include one or more unsaturations.

In some embodiments, the first non-ionic surfactant can include a Guerbet C20-30 propoxylated-ethoxylated alcohol. In some embodiments, the first non-ionic surfactant can include a Guerbet C28 propoxylated-ethoxylated alcohol. In some embodiments, the first non-ionic surfactant can include a branched C28:PO(35):EO(30).

In some embodiments, a second non-ionic surfactant can include a branched, or unbranched, or cyclic C6-C32:EO(20-30), C6-C32:EO(8-65), C6-C30:EO(20-25), C10-C25:EO(20-25), C9-C22:EO(8-65), C14-C22:EO(15-25); a cyclic C32-C60:EO(20-30), C32-C60:EO(8-65), C32-C60:EO(20-25), C32-C60:EO(15-25), C40-C60:EO(20-30), C40-C60:EO(8-65), C40-C60:EO(20-25), C40-C60:EO(15-25), C50-C60:EO(20-30), C50-C60:EO(8-65), C50-C60:EO(20-25), C50-C60:EO(15-25); or any combination thereof. In some embodiments, a second non-ionic surfactant can include a branched C6-C32:EO(20-30), C6-C32:EO(8-65), C6-C32:EO(20-25), C10-C25:EO(20-25), C9-C22:EO(8-65), C14-C22:EO(15-25), or any combination thereof. In some embodiments, the second non-ionic surfactant can include a branched C16-18:EO(25).

In some embodiments, the non-ionic surfactants and anionic surfactants are present in a ratio of non-ionic surfactants to anionic surfactants of from 1:1 to 2:1 (e.g., from 1:1 to 1:4, from 1:1 to 1:3, from 1:1 to 2:3, from 1:1 to 3:2, or 3:2 to 2:1).

In some embodiments, the first non-ionic surfactant and the second non-ionic surfactant are present in a ratio of first non-ionic surfactant to second non-ionic surfactant of from 4:1 to 1:2, (e.g., from 4:1 to 3:1, from 4:1 to 2:1, from 4:1 to 3:2, from 4:1 to 1:1, from 3:1 to 1:2, from 3:1 to 1:1, from 3:1 to 3:2, from 3:1 to 2:1, from 2:1 to 1:2, from 2:1 to 1:1, or from 1:2 to 1:1).

In some embodiments, the anionic surfactant and the first non-ionic surfactant are present in a ratio of anionic surfactant to first non-ionic surfactant of from 1.3:1 to 2:1 (e.g., from 1.3:1 to 3:2, or from 3:2 to 2:1).

In some embodiments, the anionic surfactant and the second non-ionic surfactant are present in a ratio of anionic surfactant to second non-ionic surfactant of from 1:1 to 3:2 (e.g., from 1.3:1 to 3:2 or from 1:1 to 1.3:1).

In some embodiments, the non-ionic surfactant(s) can have a concentration within the low interfacial tension (IFT) injection fluid of at least 0.015% by weight (e.g., at least 0.5%, at least 0.3%, at least 0.25%, at least 0.2%, at least 0.15%, at least 0.1%, at least 0.075%, at least 0.06%, at least 0.05%, or at least 0.03%) based on the total weight of the low interfacial tension (IFT) injection fluid.

In some embodiments, the non-ionic surfactant(s) can have a concentration within the low interfacial tension (IFT) injection fluid of 1% by weight or less (e.g., 0.5% or less, 0.3% or less, 0.25% or less, 0.2% or less, 0.15% or less, 0.1% or less, 0.075% or less, 0.06% or less, 0.05% or less, or 0.03% or less) based on the total weight of the low interfacial tension (IFT) injection fluid.

The non-ionic surfactant(s) can have a concentration within the low interfacial tension (IFT) injection fluid ranging from any of the minimum values described above to any of the maximum values described above. For example, in some embodiments, non-ionic surfactant(s) can have a concentration within the low interfacial tension (IFT) injection fluid of from 0.015% to 1% by weight (e.g., from 0.015% to 0.75%, from 0.015% to 0.5%, from 0.015% to 0.25%, from 0.015% to 0.1%, from 0.015% to 0.075%, from 0.015% to 0.05%, from 0.015% to 0.025%, from 0.025% to 1%, from 0.025% to 0.75%, from 0.025% to 0.5%, from 0.025% to 0.25%, from 0.025% to 0.1%, from 0.025% to 0.075%, from 0.025% to 0.05%, from 0.05% to 1%, from 0.05% to 0.75%, from 0.05% to 0.5%, from 0.05% to 0.25%, from 0.05% to 0.1%, from 0.05% to 0.075%, from 0.75% to 1%, from 0.075% to 0.75%, from 0.075% to 0.5%, from 0.075% to 0.25%, from 0.075% to 0.1%, from 0.1% to 1%, from 0.1% to 0.75%, from 0.1% to 0.5%, from 0.1% to 0.25%, from 0.25% to 1%, from 0.25% to 0.75%, from 0.25% to 0.5%, from 0.5% to 1%, from 0.5% to 0.75%, or from 0.75% to 10%) based on the total weight of the low interfacial tension (IFT) injection fluid.

In some embodiments, the anionic surfactant can include a hydrophobic tail that comprises from 6 to 60 carbon atoms. In some embodiments, the anionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the anionic surfactant can include a hydrophobic tail that comprises 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The anionic surfactant can include a hydrophobic tail that comprises a number of carbon atoms ranging from any of the minimum values described above to any of the maximum values described above. For example, in some embodiments, the anionic surfactant can comprise a hydrophobic tail comprising from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. The hydrophobic (lipophilic) carbon tail may be a straight chain, branched chain, and/or may comprise cyclic structures. The hydrophobic carbon tail may comprise single bonds, double bonds, triple bonds, or any combination thereof. In some embodiments, the anionic surfactant can include a branched hydrophobic tail derived from Guerbet alcohols. The hydrophilic portion of the anionic surfactant can comprise, for example, one or more sulfate moieties (e.g., one, two, or three sulfate moieties), one or more sulfonate moieties (e.g., one, two, or three sulfonate moieties), one or more sulfosuccinate moieties (e.g., one, two, or three sulfosuccinate moieties), one or more carboxylate moieties (e.g., one, two, or three carboxylate moieties), or any combination thereof.

In some embodiments, the anionic surfactant can comprise, for example a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof. In some examples, the anionic surfactant can comprise an internal olefin sulfonate (IOS), an isomerized olefin sulfonate, an alfa olefin sulfonate (AOS), an alkyl aryl sulfonate (AAS), a xylene sulfonate, an alkane sulfonate, a petroleum sulfonate, an alkyl diphenyl oxide (di)sulfonate, an alcohol sulfate, an alkoxy sulfate, an alkoxy sulfonate, an alkoxy carboxylate, an alcohol phosphate, or an alkoxy phosphate. In some embodiments, the anionic surfactant can comprise an alkoxy carboxylate surfactant, an alkoxy sulfate surfactant, an alkoxy sulfonate surfactant, an alkyl sulfonate surfactant, an aryl sulfonate surfactant, or an olefin sulfonate surfactant.

An “alkoxy carboxylate surfactant” or “alkoxy carboxylate” refers to a compound having an alkyl or aryl attached to one or more alkoxylene groups (typically —CH₂—CH(ethyl)-O—, —CH₂—CH(methyl)-O—, or —CH₂—CH₂—O—) which, in turn is attached to —COO⁻ or acid or salt thereof including metal cations such as sodium. In embodiments, the alkoxy carboxylate surfactant can be defined by the formulae below:

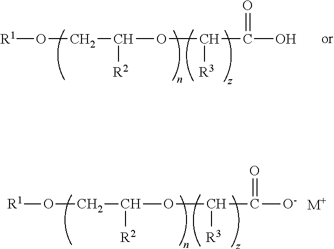

wherein R¹ is substituted or unsubstituted C6-C36 alkyl or substituted or unsubstituted aryl; R² is, independently for each occurrence within the compound, hydrogen or unsubstituted C1-C6 alkyl; R³ is independently hydrogen or unsubstituted C1-C6 alkyl, n is an integer from 0 to 175, z is an integer from 1 to 6 and M⁺ is a monovalent, divalent or trivalent cation. In some of these embodiments, R¹ can be an unsubstituted linear or branched C6-C36 alkyl.

In certain embodiments, the alkoxy carboxylate can be a C6-C32:PO(0-65):EO(0-100)-carboxylate (i.e., a C6-C32 hydrophobic tail, such as a branched or unbranched C6-C32 alkyl group, attached to from 0 to 65 propyleneoxy groups (—CH₂—CH(methyl)-O— linkers), attached in turn to from 0 to 100 ethyleneoxy groups (—CH₂—CH₂—O— linkers), attached in turn to —COO⁻ or an acid or salt thereof including metal cations such as sodium). In certain embodiments, the alkoxy carboxylate can be a branched or unbranched C6-C30:PO(30-40):EO(25-35)-carboxylate. In certain embodiments, the alkoxy carboxylate can be a branched or unbranched C6-C12:PO(30-40):EO(25-35)-carboxylate. In certain embodiments, the alkoxy carboxylate can be a branched or unbranched C6-C30:EO(8-30)-carboxylate.

An “alkoxy sulfate surfactant” or “alkoxy sulfate” refers to a surfactant having an alkyl or aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In some embodiment, the alkoxy sulfate surfactant has the formula R-(BO)ₑ-(PO)_{f}-(EO)_{g}-SO₃⁻ or acid or salt (including metal cations such as sodium) thereof, wherein R is C6-C32 alkyl, BO is —CH₂—CH(ethyl)-O—, PO is —CH₂—CH(methyl)-O—, and EO is —CH₂—CH₂—O—. The symbols e, f and g are integers from 0 to 50 wherein at least one is not zero.

In embodiments, the alkoxy sulfate surfactant can be an aryl alkoxy sulfate surfactant. The aryl alkoxy surfactant can be an alkoxy surfactant having an aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium.

An “alkyl sulfonate surfactant” or “alkyl sulfonate” refers to a compound that includes an alkyl group (e.g., a branched or unbranched C6-C32 alkyl group) attached to —SO₃⁻ or acid or salt thereof including metal cations such as sodium.

An “aryl sulfate surfactant” or “aryl sulfate” refers to a compound having an aryl group attached to —O—SO₃⁻ or acid or salt thereof including metal cations such as sodium. An “aryl sulfonate surfactant” or “aryl sulfonate” refers to a compound having an aryl group attached to —SO₃⁻ or acid or salt thereof including metal cations such as sodium. In some cases, the aryl group can be substituted, for example, with an alkyl group (an alkyl aryl sulfonate).

An “internal olefin sulfonate,” “isomerized olefin sulfonate,” or “IOS” refers to an unsaturated hydrocarbon compound comprising at least one carbon-carbon double bond and at least one SO₃⁻ group, or a salt thereof. As used herein, a “C20-C28 internal olefin sulfonate,” “a C20-C28 isomerized olefin sulfonate,” or “C20-C28 IOS” refers to an IOS, or a mixture of IOSs with an average carbon number of 20 to 28, or of 23 to 25. The C20-C28 IOS may comprise at least 80% of IOS with carbon numbers of 20 to 28, at least 90% of IOS with carbon numbers of 20 to 28, or at least 99% of IOS with carbon numbers of 20 to 28. As used herein, a “C15-C18 internal olefin sulfonate,” “C15-C18 isomerized olefin sulfonate,” or “C15-C18 IOS” refers to an IOS or a mixture of IOSs with an average carbon number of 15 to 18, or of 16 to 17. The C15-C18 IOS may comprise at least 80% of IOS with carbon numbers of 15 to 18, at least 90% of IOS with carbon numbers of 15 to 18, or at least 99% of IOS with carbon numbers of 15 to 18. The internal olefin sulfonates or isomerized olefin sulfonates may be alpha olefin sulfonates, such as an isomerized alpha olefin sulfonate. The internal olefin sulfonates or isomerized olefin sulfonates may also comprise branching. In certain embodiments, C15-18 IOS may be added to the single-phase liquid surfactant package when the low interfacial tension (IFT) injection fluid is intended for use in high temperature unconventional subterranean formations, such as formations above 130° F. (approximately 55° C.). The IOS may be at least 20% branching, 30% branching, 40% branching, 50% branching, 60% branching, or 65% branching. In some embodiments, the branching is between 20-98%, 30-90%, 40-80%, or around 65%. Examples of internal olefin sulfonates and the methods to make them are found in U.S. Pat. No. 5,488,148, U.S. Patent Application Publication 2009/0112014, and SPE 129766, all incorporated herein by reference.

In embodiments, the anionic surfactant can be a disulfonate, alkyldiphenyloxide disulfonate, mono alkyldiphenyloxide disulfonate, di alkyldiphenyloxide disulfonate, or a di alkyldiphenyloxide monosulfonate, where the alkyl group can be a C6-C36 linear or branched alkyl group. In embodiments, the anionic surfactant can be an alkylbenzene sulfonate or a dibenzene disufonate. In embodiments, the anionic surfactant can be benzenesulfonic acid, decyl(sulfophenoxy)-disodium salt; linear or branched C6-C36 alkyl:PO(0-65):EO(0-100) sulfate; or linear or branched C6-C36 alkyl:PO(0-65):EO(0-100) carboxylate. In embodiments, the anionic surfactant is an isomerized olefin sulfonate (C6-C32), internal olefin sulfonate (C6-C32) or internal olefin disulfonate (C6-C32). In some embodiments, the anionic surfactant is a Guerbet-PO(0-65)-EO(0-100) sulfate (Guerbet portion can be C6-C36). In some embodiments, the anionic surfactant is a Guerbet-PO(0-65)-EO(0-100) carboxylate (Guerbet portion can be C6-C36). In some embodiments, the anionic surfactant is alkyl PO(0-65) and EO(0-100) sulfonate: where the alkyl group is linear or branched C6-C36. In some embodiments, the anionic surfactant is a sulfosuccinate, such as a dialkylsulfosuccinate. In some embodiments, the sulfosuccinates can include, but are not limited to, sodium bis(1,3-dimethylbutyl) sulfosuccinate, dioctyl sulfosuccinate, sodium dihexyl sulfosuccinate, sulfosuccinic acid, monoester with alcohols C10-16 and EO, disodium salts, sodium diamyl sulfosuccinate, butanedioic acid, 2-sulfo-,1,4-dioctyl ester sodium salt, or any combination thereof. In some embodiments, the anionic surfactant is an alkyl aryl sulfonate (AAS) (e.g. an alkyl benzene sulfonate (ABS)), an alkoxy aryl sulfonate surfactant (e.g., tristyryl phenol alkoxylate polysulfonate), a C10-C32 internal olefin sulfate (IOS), a petroleum sulfonate, or an alkyl diphenyl oxide (di)sulfonate.

In some examples, the anionic surfactant can comprise a surfactant defined by the formula below:

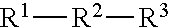

wherein R¹ comprises a branched or unbranched, saturated or unsaturated, cyclic or non-cyclic, hydrophobic carbon chain having 6-32 carbon atoms and an oxygen atom linking R¹ and R²; R² comprises an alkoxylated chain comprising at least one oxide group selected from the group consisting of ethylene oxide, propylene oxide, butylene oxide, and combinations thereof, and R³ comprises a branched or unbranched hydrocarbon chain comprising 2-12 carbon atoms and from 2 to 5 carboxylate groups.

In some examples, the anionic surfactant can comprise a surfactant defined by the formula below:

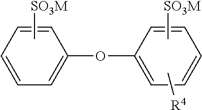

wherein R⁴ is a branched or unbranched, saturated or unsaturated, cyclic or non-cyclic, hydrophobic carbon chain having 6-32 carbon atoms; and M represents a counterion (e.g., Na+, K+). In some embodiments, R⁴ is a branched or unbranched, saturated or unsaturated, cyclic or non-cyclic, hydrophobic carbon chain having 6-16 carbon atoms.

In some embodiments, the anionic surfactant can include a disulfonate, a sulfosuccinate, or any combination thereof. In some embodiments, the anionic surfactant can include a disulfonate.

In some embodiments, the anionic surfactant can include a sulfosuccinate. In some embodiments, the anionic surfactant can include a disulfonate and a sulfosuccinate.

In some embodiments, the single-phase liquid surfactant can include a first non-ionic surfactants can include a branched or unbranched C6-C40:PO(7-65):EO(10-65), a second non-ionic surfactants can include a branched or unbranched C6-C40:EO(8-65), and a disulfonate, a sulfosuccinate, or any combination thereof.

In some embodiments, the single-phase liquid surfactant can include a first non-ionic surfactants can include a branched or unbranched C6-C40:PO(7-65):EO(10-65), a second non-ionic surfactants can include a branched or unbranched C6-C40:EO(8-65), and a disulfonate.

In some embodiments, the single-phase liquid surfactant can include a first non-ionic surfactants can include a branched or unbranched C6-C40:PO(7-65):EO(10-65), a second non-ionic surfactants can include a branched or unbranched C6-C40:EO(8-65), and a sulfosuccinate.

In some embodiments, the single-phase liquid surfactant can include a first non-ionic surfactants can include a branched or unbranched C6-C40:PO(7-65):EO(10-65), a second non-ionic surfactants can include a branched or unbranched C6-C40:EO(8-65), and a disulfonate and a sulfosuccinate.

In some embodiments, the anionic surfactant(s) can have a concentration within the low interfacial tension (IFT) injection fluid of at least 0.005% by weight (e.g., at least 0.75%, at least 0.5%, at least 0.3%, at least 0.25%, at least 0.2%, at least 0.15%, at least 0.1%, at least 0.075%, at least 0.06%, at least 0.05%, at least 0.03%, at least 0.02, at least 0.01, or at least 0.0075) based on the total weight of the low interfacial tension (IFT) injection fluid.

In some embodiments, the anionic surfactant(s) can have a concentration within the low interfacial tension (IFT) injection fluid of 1% by weight or less (e.g., 0.75% or less, 0.5% or less, 0.3% or less, 0.25% or less, 0.2% or less, 0.15% or less, 0.1% or less, 0.075% or less, 0.06% or less, 0.05% or less, 0.03% or less, 0.02% or less, 0.01% or less, 0.0075% or less) based on the total weight of the low interfacial tension (IFT) injection fluid.

The anionic surfactant(s) can have a concentration within the low interfacial tension (IFT) injection fluid ranging from any of the minimum values described above to any of the maximum values described above. For example, in some embodiments, anionic surfactant(s) can have a concentration within the low interfacial tension (IFT) injection fluid of from 0.005% to 1% by weight (e.g., from 0.005% to 0.75%, from 0.005% to 0.5%, from 0.005% to 0.025%, from 0.005% to 0.01%, from 0.01% to 1%, from 0.01% to 0.75%, from 0.01% to 0.5%, from 0.01% to 0.025%, from 0.025% to 0.75%, from 0.025% to 0.5%, from 0.025% to 0.25%, from 0.025% to 0.1%, from 0.025% to 0.075%, from 0.025% to 0.05%, from 0.015% to 0.75%, from 0.015% to 0.5%, from 0.015% to 0.25%, from 0.015% to 0.1%, from 0.015% to 0.075%, from 0.015% to 0.05%, from 0.015% to 0.025%, from 0.025% to 1%, from 0.025% to 0.75%, from 0.025% to 0.5%, from 0.025% to 0.25%, from 0.025% to 0.1%, from 0.025% to 0.075%, from 0.025% to 0.05%, from 0.05% to 1%, from 0.05% to 0.75%, from 0.05% to 0.5%, from 0.05% to 0.25%, from 0.05% to 0.1%, from 0.05% to 0.075%, from 0.75% to 1%, from 0.075% to 0.75%, from 0.075% to 0.5%, from 0.075% to 0.25%, from 0.075% to 0.1%, from 0.1% to 1%, from 0.1% to 0.75%, from 0.1% to 0.5%, from 0.1% to 0.25%, from 0.25% to 1%, from 0.25% to 0.75%, from 0.25% to 0.5%, from 0.5% to 1%, from 0.5% to 0.75%, or from 0.75% to 1%) based on the total weight of the low interfacial tension (IFT) injection fluid.

In some embodiments, the low interfacial tension (IFT) injection fluid can further include a paraffin inhibitor. In some embodiments, the low interfacial tension (IFT) injection fluid can further include an asphaltene inhibitor.

In some embodiments, the low interfacial tension (IFT) injection fluid can have a maximum particle size of less than 0.1 micrometers in diameter in particle size distribution measurements performed at a temperature and salinity of the subterranean formation.

In specific embodiments, after injection into a reservoir, the low interfacial tension (IFT) injection fluid retains the lowered particle size distribution within the reservoir. In certain embodiments, the low interfacial tension (IFT) injection fluid lowers the particle size distribution of the reservoir fluid after being injected into the reservoir and mixing with the reservoir fluid. In some embodiments, the mean particle size distribution of the low interfacial tension (IFT) injection fluid is less than an average pore size of a rock matrix in the subterranean formation.

In some embodiments, the low interfacial tension (IFT) injection fluid can have a maximum particle size of greater than 0.1 micrometers in diameter in particle size distribution measurements performed at a temperature and salinity of the subterranean formation.

In some embodiments, the single-phase liquid surfactant package can further include water. In some of these embodiments, the single-phase liquid surfactant package does not include a hydrocarbon.

In some embodiments, the single-phase liquid surfactant package can further include one or more secondary surfactants. The one or more secondary surfactants can include one or more additional non-ionic surfactants, one or more anionic surfactants, one or more cationic surfactants, one or more zwitterionic surfactants, or any combination thereof.

In some embodiments, the one or more secondary surfactants can comprise at least 10% by weight (e.g., at least 15% by weight, at least 20% by weight, at least 25% by weight, at least 30% by weight, at least 35% by weight, at least 40% by weight, at least 45% by weight, at least 50% by weight, at least 55% by weight, at least 60% by weight, at least 65% by weight, at least 70% by weight, at least 75% by weight, at least 80% by weight, or at least 85% by weight) of single-phase liquid surfactant package, based on the total weight of the single-phase liquid surfactant package. In some embodiments, the one or more secondary surfactants can comprise 90% by weight or less (e.g., 85% by weight or less, 80% by weight or less, 75% by weight or less, 70% by weight or less, 65% by weight or less, 60% by weight or less, 55% by weight or less, 50% by weight or less, 45% by weight or less, 40% by weight or less, 35% by weight or less, 30% by weight or less, 25% by weight or less, 20% by weight or less, or 15% by weight or less) of the single-phase liquid surfactant package, based on the total weight of the single-phase liquid surfactant package.

The one or more secondary surfactants can be present in the single-phase liquid surfactant package in an amount ranging from any of the minimum values described above to any of the maximum values described above. For example, in some embodiments, the one or more secondary surfactants can comprise from 10% to 90% by weight (e.g., from 10% to 50% by weight) of the single-phase liquid surfactant package, based on the total weight of the single-phase liquid surfactant package.

In some embodiments, the secondary surfactant can include a non-ionic surfactant. In embodiments, the hydrophilic-lipophilic balance (HLB) of the non-ionic surfactant is greater than 10 (e.g., greater than 9, greater than 8, or greater than 7). In some embodiments, the HLB of the non-ionic surfactant is from 7 to 10.

The non-ionic surfactant can comprise a hydrophobic tail comprising from 6 to 60 carbon atoms. In some embodiments, the non-ionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the non-ionic surfactant can include a hydrophobic tail that comprises 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The non-ionic surfactant can include a hydrophobic tail that comprises a number of carbon atoms ranging from any of the minimum values described above to any of the maximum values described above. For example, the non-ionic surfactant can comprise a hydrophobic tail comprising from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. In some cases, the hydrophobic tail may be a straight chain, branched chain, and/or may comprise cyclic structures. The hydrophobic carbon tail may comprise single bonds, double bonds, triple bonds, or any combination thereof. In some cases, the hydrophobic tail can comprise an alkyl group, with or without an aromatic ring (e.g., a phenyl ring) attached to it. In some embodiments, the hydrophobic tail can comprise a branched hydrophobic tail derived from Guerbet alcohols.

Example non-ionic surfactants include alkyl aryl alkoxy alcohols, alkyl alkoxy alcohols, or any combination thereof. In embodiments, the non-ionic surfactant may be a mix of surfactants with different length lipophilic tail chain lengths. For example, the non-ionic surfactant may be C9-C11:9EO, which indicates a mixture of non-ionic surfactants that have a lipophilic tail length of 9 carbon to 11 carbon, which is followed by a chain of 9 EOs. The hydrophilic moiety is an alkyleneoxy chain (e.g., an ethoxy (EO), butoxy (BO) and/or propoxy (PO) chain with two or more repeating units of EO, BO, and/or PO). In some embodiments, 1-100 repeating units of EO are present. In some embodiments, 0-65 repeating units of PO are present. In some embodiments, 0-25 repeating units of BO are present. For example, the non-ionic surfactant could comprise 10EO:5PO or 5EO. In embodiments, the non-ionic surfactant may be a mix of surfactants with different length lipophilic tail chain lengths. For example, the non-ionic surfactant may be C9-C11:PO9:EO2, which indicates a mixture of non-ionic surfactants that have a lipophilic tail length of 9 carbon to 11 carbon, which is followed by a chain of 9 POs and 2 EOs. In specific embodiments, the non-ionic surfactant is linear C9-C11:9EO. In some embodiments, the non-ionic surfactant is a Guerbet PO(0-65) and EO(0-100) (Guerbet can be C6-C36); or alkyl PO(0-65) and EO(0-100): where the alkyl group is linear or branched C1-C36. In some embodiments, one of the at least two non-ionic surfactant is not a Guerbet PO(0-65) and EO(0-100) (Guerbet can be C6-C36. In some examples, the non-ionic surfactant can comprise a branched or unbranched C6-C32:PO(0-65):EO(0-100) (e.g., a branched or unbranched C6-C30:PO(30-40):EO(25-35), or a branched or unbranched C6-C32:PO(30-40):EO(25-45), a branched or unbranched C6-C12:PO(30-40):EO(25-35), a branched or unbranched C6-30:EO(8-30), a branched or unbranched C6-32:EO(8-50), or any combination thereof). In some embodiments, the non-ionic surfactant is one or more alkyl polyglucosides.

In some embodiments, the secondary surfactant can include an anionic surfactant. Suitable anionic surfactants for use as a secondary surfactant include a hydrophobic tail that comprises from 6 to 60 carbon atoms. In some embodiments, the anionic surfactant can include a hydrophobic tail that comprises at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the anionic surfactant can include a hydrophobic tail that comprises 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The anionic surfactant can include a hydrophobic tail that comprises a number of carbon atoms ranging from any of the minimum values described above to any of the maximum values described above. For example, in some embodiments, the anionic surfactant can comprise a hydrophobic tail comprising from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. The hydrophobic (lipophilic) carbon tail may be a straight chain, branched chain, and/or may comprise cyclic structures. The hydrophobic carbon tail may comprise single bonds, double bonds, triple bonds, or any combination thereof. In some embodiments, the anionic surfactant can include a branched hydrophobic tail derived from Guerbet alcohols. The hydrophilic portion of the anionic surfactant can comprise, for example, one or more sulfate moieties (e.g., one, two, or three sulfate moieties), one or more sulfonate moieties (e.g., one, two, or three sulfonate moieties), one or more sulfosuccinate moieties (e.g., one, two, or three sulfosuccinate moieties), one or more carboxylate moieties (e.g., one, two, or three carboxylate moieties), or any combination thereof.

In some embodiments, the anionic surfactant can comprise, for example a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof. In some examples, the anionic surfactant can comprise an internal olefin sulfonate (IOS), an isomerized olefin sulfonate, an alfa olefin sulfonate (AOS), an alkyl aryl sulfonate (AAS), a xylene sulfonate, an alkane sulfonate, a petroleum sulfonate, an alkyl diphenyl oxide (di)sulfonate, an alcohol sulfate, an alkoxy sulfate, an alkoxy sulfonate, an alkoxy carboxylate, an alcohol phosphate, or an alkoxy phosphate. In some embodiments, the anionic surfactant can comprise an alkoxy carboxylate surfactant, an alkoxy sulfate surfactant, an alkoxy sulfonate surfactant, an alkyl sulfonate surfactant, an aryl sulfonate surfactant, or an olefin sulfonate surfactant.

An “alkoxy carboxylate surfactant” or “alkoxy carboxylate” refers to a compound having an alkyl or aryl attached to one or more alkoxylene groups (typically —CH₂—CH(ethyl)-O—, —CH₂—CH(methyl)-O—, or —CH₂—CH₂—O—) which, in turn is attached to —COO⁻ or acid or salt thereof including metal cations such as sodium. In embodiments, the alkoxy carboxylate surfactant can be defined by the formulae below:

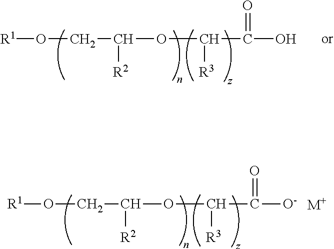

wherein R¹ is substituted or unsubstituted C6-C36 alkyl or substituted or unsubstituted aryl; R² is, independently for each occurrence within the compound, hydrogen or unsubstituted C1-C6 alkyl; R³ is independently hydrogen or unsubstituted C1-C6 alkyl, n is an integer from 0 to 175, z is an integer from 1 to 6 and M⁺ is a monovalent, divalent or trivalent cation. In some of these embodiments, R¹ can be an unsubstituted linear or branched C6-C36 alkyl.

In certain embodiments, the alkoxy carboxylate can be a C6-C32:PO(0-65):EO(0-100)-carboxylate (i.e., a C6-C32 hydrophobic tail, such as a branched or unbranched C6-C32 alkyl group, attached to from 0 to 65 propyleneoxy groups (—CH₂—CH(methyl)-O— linkers), attached in turn to from 0 to 100 ethyleneoxy groups (—CH₂—CH₂—O— linkers), attached in turn to —COO⁻ or an acid or salt thereof including metal cations such as sodium). In certain embodiments, the alkoxy carboxylate can be a branched or unbranched C6-C30:PO(30-40):EO(25-35)-carboxylate. In certain embodiments, the alkoxy carboxylate can be a branched or unbranched C6-C12:PO(30-40):EO(25-35)-carboxylate. In certain embodiments, the alkoxy carboxylate can be a branched or unbranched C6-C30:EO(8-30)-carboxylate.

An “alkoxy sulfate surfactant” or “alkoxy sulfate” refers to a surfactant having an alkyl or aryl attached to one or more alkoxylene groups (typically —CH₂—CH(ethyl)-O—, —CH₂—CH(methyl)-0-, or —CH₂—CH₂—O—) which, in turn is attached to —SO₃⁻ or acid or salt thereof including metal cations such as sodium. In some embodiment, the alkoxy sulfate surfactant has the formula R-(BO)ₑ-(PO)_{f}-(EO)_{g}-SO₃⁻ or acid or salt (including metal cations such as sodium) thereof, wherein R is C6-C32 alkyl, BO is —CH₂—CH(ethyl)-O—, PO is —CH₂—CH(methyl)-O—, and EO is —CH₂—CH₂—O—. The symbols e, f and g are integers from 0 to 50 wherein at least one is not zero.

In embodiments, the alkoxy sulfate surfactant can be an aryl alkoxy sulfate surfactant. The aryl alkoxy surfactant can be an alkoxy surfactant having an aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium.

An “alkyl sulfonate surfactant” or “alkyl sulfonate” refers to a compound that includes an alkyl group (e.g., a branched or unbranched C6-C32 alkyl group) attached to —SO₃⁻ or acid or salt thereof including metal cations such as sodium.

An “aryl sulfate surfactant” or “aryl sulfate” refers to a compound having an aryl group attached to —O—SO₃⁻ or acid or salt thereof including metal cations such as sodium. An “aryl sulfonate surfactant” or “aryl sulfonate” refers to a compound having an aryl group attached to —SO₃⁻ or acid or salt thereof including metal cations such as sodium. In some cases, the aryl group can be substituted, for example, with an alkyl group (an alkyl aryl sulfonate).

An “internal olefin sulfonate,” “isomerized olefin sulfonate,” or “IOS” refers to an unsaturated hydrocarbon compound comprising at least one carbon-carbon double bond and at least one SO₃⁻ group, or a salt thereof. As used herein, a “C20-C28 internal olefin sulfonate,” “a C20-C28 isomerized olefin sulfonate,” or “C20-C28 IOS” refers to an IOS, or a mixture of IOSs with an average carbon number of 20 to 28, or of 23 to 25. The C20-C28 IOS may comprise at least 80% of IOS with carbon numbers of 20 to 28, at least 90% of IOS with carbon numbers of 20 to 28, or at least 99% of IOS with carbon numbers of 20 to 28. As used herein, a “C15-C18 internal olefin sulfonate,” “C15-C18 isomerized olefin sulfonate,” or “C15-C18 IOS” refers to an IOS or a mixture of IOSs with an average carbon number of 15 to 18, or of 16 to 17. The C15-C18 IOS may comprise at least 80% of IOS with carbon numbers of 15 to 18, at least 90% of IOS with carbon numbers of 15 to 18, or at least 99% of IOS with carbon numbers of 15 to 18. The internal olefin sulfonates or isomerized olefin sulfonates may be alpha olefin sulfonates, such as an isomerized alpha olefin sulfonate. The internal olefin sulfonates or isomerized olefin sulfonates may also comprise branching. In certain embodiments, C15-18 IOS may be added to the single-phase liquid surfactant package when the low interfacial tension (IFT) injection fluid is intended for use in high temperature unconventional subterranean formations, such as formations above 130° F. (approximately 55° C.). The IOS may be at least 20% branching, 30% branching, 40% branching, 50% branching, 60% branching, or 65% branching. In some embodiments, the branching is between 20-98%, 30-90%, 40-80%, or around 65%. Examples of internal olefin sulfonates and the methods to make them are found in U.S. Pat. No. 5,488,148, U.S. Patent Application Publication 2009/0112014, and SPE 129766, all incorporated herein by reference.

In embodiments, the anionic surfactant can be a disulfonate, alkyldiphenyloxide disulfonate, mono alkyldiphenyloxide disulfonate, di alkyldiphenyloxide disulfonate, or a di alkyldiphenyloxide monosulfonate, where the alkyl group can be a C6-C36 linear or branched alkyl group. In embodiments, the anionic surfactant can be an alkylbenzene sulfonate or a dibenzene disufonate. In embodiments, the anionic surfactant can be benzenesulfonic acid, decyl(sulfophenoxy)-disodium salt; linear or branched C6-C36 alkyl:PO(0-65):EO(0-100) sulfate; or linear or branched C6-C36 alkyl:PO(0-65):EO(0-100) carboxylate. In embodiments, the anionic surfactant is an isomerized olefin sulfonate (C6-C32), internal olefin sulfonate (C6-C32) or internal olefin disulfonate (C6-C32). In some embodiments, the anionic surfactant is a Guerbet-PO(0-65)-EO(0-100) sulfate (Guerbet portion can be C6-C36). In some embodiments, the anionic surfactant is a Guerbet-PO(0-65)-EO(0-100) carboxylate (Guerbet portion can be C6-C36). In some embodiments, the anionic surfactant is alkyl PO(0-65) and EO(0-100) sulfonate: where the alkyl group is linear or branched C6-C36. In some embodiments, the anionic surfactant is a sulfosuccinate, such as a dialkylsulfosuccinate. In some embodiments, the sulfosuccinates can include, but are not limited to, sodium bis(1,3-dimethylbutyl) sulfosuccinate, dioctyl sulfosuccinate, sodium dihexyl sulfosuccinate, sulfosuccinic acid, monoester with alcohols C10-16 and EO, disodium salts, sodium diamyl sulfosuccinate, butanedioic acid, 2-sulfo-,1,4-dioctyl ester sodium salt, or any combination thereof. In some embodiments, the anionic surfactant is an alkyl aryl sulfonate (AAS) (e.g. an alkyl benzene sulfonate (ABS)), an alkoxy aryl sulfonate surfactant (e.g., tristyryl phenol alkoxylate polysulfonate), a C10-C32 internal olefin sulfate (IOS), a petroleum sulfonate, or an alkyl diphenyl oxide (di)sulfonate.

In some examples, the anionic surfactant can comprise a surfactant defined by the formula below:

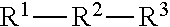

wherein R¹ comprises a branched or unbranched, saturated or unsaturated, cyclic or non-cyclic, hydrophobic carbon chain having 6-32 carbon atoms and an oxygen atom linking R¹ and R²; R² comprises an alkoxylated chain comprising at least one oxide group selected from the group consisting of ethylene oxide, propylene oxide, butylene oxide, and combinations thereof, and R³ comprises a branched or unbranched hydrocarbon chain comprising 2-12 carbon atoms and from 2 to 5 carboxylate groups.

In some examples, the anionic surfactant can comprise a surfactant defined by the formula below:

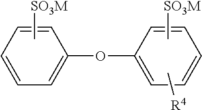

wherein R⁴ is a branched or unbranched, saturated or unsaturated, cyclic or non-cyclic, hydrophobic carbon chain having 6-32 carbon atoms; and M represents a counterion (e.g., Na⁺, K⁺). In some embodiments, R⁴ is a branched or unbranched, saturated or unsaturated, cyclic or non-cyclic, hydrophobic carbon chain having 6-16 carbon atoms.

Example cationic surfactants include surfactant analogous to those described above, except bearing primary, secondary, or tertiary amines, or quaternary ammonium cations, as a hydrophilic head group. “Zwitterionic” or “zwitterion” as used herein refers to a neutral molecule with a positive (or cationic) and a negative (or anionic) electrical charge at different locations within the same molecule. Example zwitterionic surfactants include betains and sultains.

Examples of suitable surfactants are disclosed, for example, in U.S. Pat. Nos. 3,811,504, 3,811,505, 3,811,507, 3,890,239, 4,463,806, 6,022,843, 6,225,267, 7,629,299, 7,770,641, 9,976,072, 8,211, 837, 9,422,469, 9,605,198, and 9,617,464; WIPO Patent Application Nos. WO/2008/079855, WO/2012/027757 and WO/2011/094442; as well as U.S. Patent Application Nos. 2005/0199395, 2006/0185845, 2006/0189486, 2009/0270281, 2011/0046024, 2011/0100402, 2011/0190175, 2007/0191633, 2010/004843, 2011/0201531, 2011/0190174, 2011/0071057, 2011/0059873, 2011/0059872, 2011/0048721, 2010/0319920, 2010/0292110, and 2017/0198202, each of which is hereby incorporated by reference herein in its entirety for its description of example surfactants.

Optionally, the single-phase liquid surfactant package can include one or more additional components. For example, the single-phase liquid surfactant package can further comprise an acid, a polymer, a friction reducer, a gelling agent, a crosslinker, a scale inhibitor, a breaker, a pH adjusting agent, a non-emulsifier agent, an iron control agent, a corrosion inhibitor, a biocide, a clay stabilizing agent, a proppant, a wettability alteration chemical, a co-solvent (e.g., a C1-C5 alcohol, or an alkoxylated C1-C5 alcohol), or any combination thereof.

In some embodiments, the single-phase liquid surfactant package can further include one or more co-solvents. Suitable co-solvents include alcohols, such as lower carbon chain alcohols such as isopropyl alcohol, ethanol, n-propyl alcohol, n-butyl alcohol, sec-butyl alcohol, n-amyl alcohol, sec-amyl alcohol, n-hexyl alcohol, sec-hexyl alcohol and the like; alcohol ethers, polyalkylene alcohol ethers, polyalkylene glycols, poly(oxyalkylene)glycols, poly(oxyalkylene)glycol ethers, ethoxylated phenol, dimethyl ether (DME), or any other common organic co-solvent or combinations of any two or more co-solvents. In one embodiment, the co-solvent can comprise alkyl ethoxylate (C1-C6)-XEO X=1-30 -linear or branched. In some embodiments, the co-solvent can comprise ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), or any combination thereof.

Prior to injection into a well, the single-phase liquid surfactant package is combined with an aqueous-based injection fluid to form a low interfacial tension (IFT) injection fluid. The single-phase liquid surfactant package may be added directly into the aqueous-based injection fluid, or the single-phase liquid surfactant package may be diluted (e.g., with water or an aqueous-based injection fluid) prior to being added to the injection fluid. In embodiments, the aqueous-based injection fluid prior to addition of the single-phase liquid surfactant package is an aqueous-based injection fluid that was previously injected into the well. When added, the single-phase liquid surfactant package can decrease the particle size distribution within the aqueous-based injection fluid, creating a low interfacial tension (IFT) injection fluid.

In example embodiments, the aqueous-based injection fluid can comprise any type of water, treated or untreated, and can vary in salt content. For example, the water can include sea water, brackish water, flowback or produced water, wastewater (e.g., reclaimed or recycled), brine (e.g., reservoir or synthetic brine), fresh water (e.g., fresh water comprises <1,000 ppm TDS water), or any combination thereof. In certain examples, the water can include hard water or hard brine. In some embodiments, the water can include at least 10 ppm of divalent metal ions (e.g., at least 100 ppm, at least 500 ppm, at least 1,000 ppm, at least 5,000 ppm, at least 10,000 ppm, at least 20,000 ppm, or at least 30,000 ppm). In some embodiments, the water can include 30,000 ppm or less of divalent metal ions (e.g., 20,000 ppm or less, 10,000 ppm or less, 5,000 ppm or less, 1,000 ppm or less, 500 ppm or less, 100 ppm or less, or 50 ppm or less). In certain embodiments, the from 10 ppm to 30,000 ppm of divalent metal ions.

The water can have a concentration of divalent metal ions ranging from any of the minimum values described above to any of the maximum values described above. For example, in some embodiments, the water can include from 10 ppm to 30,000 ppm of divalent metal ions (e.g., from 50 ppm to 30,000 ppm, from 100 ppm to 30,000 ppm, from 500 ppm to 30,000 ppm, from 1000 ppm to 30,000 ppm, from 5000 ppm to 30,000 ppm, from 10,000 ppm to 30,000 ppm, from 20,000 ppm to 30,000 ppm, from 10 ppm to 20,000 ppm, from 50 ppm to 20,000 ppm, from 100 ppm to 20,000 ppm, from 500 ppm to 20,000 ppm, from 1000 ppm to 20,000 ppm, from 5000 ppm to 20,000 ppm, from 10,000 ppm to 20,000 ppm, from 10 ppm to 10,000 ppm, from 50 ppm to 10,000 ppm, from 100 ppm to 10,000 ppm, from 500 ppm to 10,000 ppm, from 1000 ppm to 10,000 ppm, from 5000 ppm to 10,000 ppm, from 10 ppm to 5,000 ppm, from 50 ppm to 5,000 ppm, from 100 ppm to 5,000 ppm, from 500 ppm to 5,000 ppm, from 1000 ppm to 5,000 ppm, from 10 ppm to 1,000 ppm, from 50 ppm to 1,000 ppm, from 100 ppm to 20,000 ppm, from 500 ppm to 1,000 ppm, from 10 ppm to 500 ppm, from 50 ppm to 500 ppm, from 100 ppm to 500 ppm, from 10 ppm to 100 ppm, from 50 ppm to 100 ppm, or from 10 ppm to 50 ppm). In some embodiments, the divalent metal ions can be chosen from Ca²⁺, Mg²⁺, Sr²⁺, and Ba²⁺, or any combination thereof.

In some embodiments, the water can have salinity of at least 5,000 ppm TDS (e.g., at least 10,000 ppm TDS, at least 20,000 ppm TDS, at least 30,000 ppm TDS, at least 50,000 ppm TDS, at least 75,0000 ppm TDS, at least 100,000 ppm TDS, at least 150,000 ppm TDS, at least 200,000 ppm TDS, at least 250,000 ppm TDS, or at least 275,000 ppm TDS). In some embodiments, the water can have a salinity of 300,000 ppm TDS or less (e.g., 275,000 ppm TDS or less, 250,000 ppm TDS or less, 200,000 ppm TDS or less, 150,000 ppm TDS or less, 100,000 ppm TDS or less, 50,000 ppm TDS or less, 30,000 ppm TDS or less, 25,000 ppm TDS or less, 20,000 ppm TDS or less, 15,000 ppm TDS or less, or 10,000 ppm TDS or less).

The water can have a salinity ranging from any of the minimum values described above to any of the maximum values described above. For example, in some embodiments, the water can have a salinity of at least 5,000 ppm TDS to 300,000 ppm TDS, such as a salinity of from 5,000 ppm TDS to 10,000 ppm TDS, from 5,000 ppm TDS to 15,000 ppm TDS, from 5,000 ppm TDS to 30,000 ppm TDS, from 5,000 ppm TDS to 50,000 ppm TDS, from 5,000 ppm TDS to 100,000 ppm TDS, from 5,000 ppm TDS to 150,000 ppm TDS, from 5,000 ppm TDS to 200,000 ppm TDS, from 5,000 ppm TDS to 250,000 ppm TDS, from 5,000 ppm TDS to 300,000 ppm TDS, from 15,000 ppm TDS to 30,000 ppm TDS, from 15,000 ppm TDS to 50,000 ppm TDS, from 15,000 ppm TDS to 100,000 ppm TDS, from 15,000 ppm TDS to 150,000 ppm TDS, from 15,000 ppm TDS to 200,000 ppm TDS, from 15,000 ppm TDS to 250,000 ppm TDS, from 15,000 ppm TDS to 300,000 ppm TDS, from 20,000 ppm TDS to 50,000 ppm TDS, from 20,000 ppm TDS to 100,000 ppm TDS, from 20,000 ppm TDS to 150,000 ppm TDS, from 20,000 ppm TDS to 200,000 ppm TDS, from 20,000 ppm TDS to 250,000 ppm TDS, from 20,000 ppm TDS to 300,000 ppm TDS, from 25,000 ppm TDS to 50,000 ppm TDS, from 25,000 ppm TDS to 100,000 ppm TDS, from 25,000 ppm TDS to 150,000 ppm TDS, from 25,000 ppm TDS to 200,000 ppm TDS, from 25,000 ppm TDS to 250,000 ppm TDS, from 25,000 ppm TDS to 300,000 ppm TDS, from 50,000 ppm TDS to 100,000 ppm TDS, from 50,000 ppm TDS to 150,000 ppm TDS, from 50,000 ppm TDS to 200,000 ppm TDS, from 50,000 ppm TDS to 250,000 ppm TDS, from 50,000 ppm TDS to 300,000 ppm TDS, from 100,000 ppm TDS to 150,000 ppm TDS, from 100,000 ppm TDS to 200,000 ppm TDS, from 100,000 ppm TDS to 250,000 ppm TDS, from 100,000 ppm TDS to 300,000 ppm TDS, from 150,000 ppm TDS to 200,000 ppm TDS, from 150,000 ppm TDS to 250,000 ppm TDS, from 150,000 ppm TDS to 300,000 ppm TDS, from 200,000 ppm TDS to 250,000 ppm TDS, from 200,000 ppm TDS to 300,000 ppm TDS, or from 250,000 ppm TDS to 300,000 ppm TDS.

In some embodiments, the aqueous-based injection fluid can include slickwater.

The low interfacial tension (IFT) injection fluids can include from 30% to 99.85% by weight of the total composition of water, for example from 70% to 98% water.

In some embodiments, the aqueous-based injection fluid can include an acid, a polymer, a friction reducer, a gelling agent, a crosslinker, a breaker, a pH adjusting agent, a non-emulsifier agent, an iron control agent, a scale inhibitor, a corrosion inhibitor, a biocide, a clay stabilizing agent, a proppant, a wettability alteration chemical, a co-solvent (e.g., a C1-C5 alcohol, or an alkoxylated C1-C5 alcohol), or any combination thereof. In certain embodiments, the aqueous-based injection fluid can comprise an acid (e.g., at least 10% acid, such as from 10% to 20% by weight acid). In certain embodiments, the low interfacial tension (IFT) injection fluid can include a proppant.

Once combined with the aqueous-based injection fluid, the non-ionic surfactant can have a concentration within the low interfacial tension (IFT) injection fluid of at least 0.001% by weight (e.g., at least 0.005%, at least 0.0075% by weight, at least 0.01% by weight, at least 0.025%, at least 0.05%, or at least 0.075% by weight) based on the total weight of the low interfacial tension (IFT) injection fluid.

Once combined with the aqueous-based injection fluid, in some embodiments, the non-ionic surfactant(s) can have a concentration within the low interfacial tension (IFT) injection fluid of 0.1% by weight or less (e.g., 0.075% by weight or less, 0.05% by weight or less, 0.025% by weight or less, 0.01% by weight or less, 0.0075% by weight or less, 0.005% by weight or less, or 0.0025% by weight or less) based on the total weight of the low interfacial tension (IFT) injection fluid.

Once combined with the aqueous-based injection fluid, the non-ionic surfactant(s) can have a concentration within the low interfacial tension (IFT) injection fluid ranging from any of the minimum values described above to any of the maximum values described above. For example, in some embodiments, non-ionic surfactant(s) can have a concentration within the low interfacial tension (IFT) injection fluid of from 0.001% to 0.1% by weight (e.g., from 0.0025% to 0.1% by weight, from 0.005% to 0.1% by weight, from 0.0075% to 0.1% by weight, from 0.01% to 0.1% by weight, from 0.025% to 0.1% by weight, from 0.05% to 0.1% by weight, from 0.075% to 0.1% by weight, from 0.001% to 0.75% by weight, from 0.0025% to 0.075% by weight, from 0.005% to 0.075% by weight, from 0.0075% to 0.075% by weight, from 0.01% to 0.075% by weight, from 0.025% to 0.075% by weight, from 0.05% to 0.075% by weight, from 0.001% to 0.05% by weight, from 0.0025% to 0.05% by weight, from 0.005% to 0.05% by weight, from 0.0075% to 0.05% by weight, from 0.01% to 0.05% by weight, from 0.025% to 0.05% by weight, from 0.001% to 0.0025% by weight, from 0.0025% to 0.025% by weight, from 0.005% to 0.025% by weight, from 0.0075% to 0.025% by weight, from 0.01% to 0.025% by weight, from 0.001% to 0.01% by weight, from 0.0025% to 0.01% by weight, from 0.005% to 0.01% by weight, from 0.0075% to 0.01% by weight, from 0.001% to 0.0075% by weight, from 0.0025% to 0.0075% by weight, from 0.005% to 0.0075% by weight, from 0.001% to 0.005% by weight, from 0.0025% to 0.005% by weight, or from 0.001% to 0.005% by weight), based on the total weight of the low interfacial tension (IFT) injection fluid.

When present, the one or more secondary surfactants can have a concentration within the low interfacial tension (IFT) injection fluid of at least 0.001% by weight (e.g., at least 0.005%, at least 0.0075% by weight, at least 0.01% by weight, at least 0.025%, at least 0.05%, or at least 0.075% by weight) based on the total weight of the low interfacial tension (IFT) injection fluid.

When present, the one or more secondary surfactants can have a concentration within the low interfacial tension (IFT) injection fluid of 0.1% by weight or less (e.g., 0.075% or less, 0.05% or less, 0.025% or less, 0.01% or less, 0.0075% or less, 0.005% or less, or 0.0025% or less) based on the total weight of the low interfacial tension (IFT) injection fluid.

When present, the one or more secondary surfactants can have a concentration within the low interfacial tension (IFT) injection fluid ranging from any of the minimum values described above to any of the maximum values described above. For example, in some embodiments, when present, the one or more secondary surfactants can have a concentration within the low interfacial tension (IFT) injection fluid of from 0.001% to 0.1% by weight (e.g., from 0.0025% to 0.1% by weight, from 0.005% to 0.1% by weight, from 0.0075% to 0.1% by weight, from 0.01% to 0.1% by weight, from 0.025% to 0.1% by weight, from 0.05% to 0.1% by weight, from 0.075% to 0.1% by weight, from 0.001% to 0.75% by weight, from 0.0025% to 0.075% by weight, from 0.005% to 0.075% by weight, from 0.0075% to 0.075% by weight, from 0.01% to 0.075% by weight, from 0.025% to 0.075% by weight, from 0.05% to 0.075% by weight, from 0.001% to 0.05% by weight, from 0.0025% to 0.05% by weight, from 0.005% to 0.05% by weight, from 0.0075% to 0.05% by weight, from 0.01% to 0.05% by weight, from 0.025% to 0.05% by weight, from 0.001% to 0.0025% by weight, from 0.0025% to 0.025% by weight, from 0.005% to 0.025% by weight, from 0.0075% to 0.025% by weight, from 0.01% to 0.025% by weight, from 0.001% to 0.01% by weight, from 0.0025% to 0.01% by weight, from 0.005% to 0.01% by weight, from 0.0075% to 0.01% by weight, from 0.001% to 0.0075% by weight, from 0.0025% to 0.0075% by weight, from 0.005% to 0.0075% by weight, from 0.001% to 0.005% by weight, from 0.0025% to 0.005% by weight, or from 0.001% to 0.005% by weight), based on the total weight of the low interfacial tension (IFT) injection fluid.

In other embodiments, the one or more secondary surfactants are absent.

In some embodiments, the total concentration of all surfactants in the low interfacial tension (IFT) injection fluid can be at least 0.005% by weight (e.g., at least 0.0075% by weight, at least 0.01% by weight, at least 0.025%, at least 0.05%, at least 0.075% by weight, or at least 0.1%) based on the total weight of the low interfacial tension (IFT) injection fluid.

In some embodiments, the total concentration of all surfactants in the low interfacial tension (IFT) injection fluid can be 0.5% by weight or less (e.g., 0.1% by weight or less, 0.075% by weight or less, 0.05% by weight or less, 0.025% by weight or less, 0.01% by weight or less, 0.0075% by weight or less, 0.005% by weight or less, or 0.0025% by weight or less) based on the total weight of the low interfacial tension (IFT) injection fluid.

The total concentration of all surfactants in the low interfacial tension (IFT) fluid injection can ranging from any of the minimum values described above to any of the maximum values described above. For example, in some embodiments, the total concentration of all surfactants in the low interfacial tension (IFT) injection fluid can be from 0.005% to 0.5% by weight (e.g., from 0.0025% to 0.5% by weight, from 0.005% to 0.5% by weight, from 0.0075% to 0.5% by weight, from 0.01% to 0.5% by weight, from 0.025% to 0.5% by weight, from 0.05% to 0.5% by weight, from 0.075% to 0.5% by weight, from 0.0025% to 0.1% by weight, from 0.005% to 0.1% by weight, from 0.0075% to 0.1% by weight, from 0.01% to 0.1% by weight, from 0.025% to 0.1% by weight, from 0.05% to 0.1% by weight, from 0.075% to 0.1% by weight, from 0.001% to 0.075% by weight, from 0.0025% to 0.075% by weight, from 0.005% to 0.075% by weight, from 0.0075% to 0.075% by weight, from 0.01% to 0.075% by weight, from 0.025% to 0.075% by weight, from 0.05% to 0.075% by weight, from 0.001% to 0.05% by weight, from 0.0025% to 0.05% by weight, from 0.005% to 0.05% by weight, from 0.0075% to 0.05% by weight, from 0.01% to 0.05% by weight, from 0.025% to 0.05% by weight, from 0.001% to 0.0025% by weight, from 0.0025% to 0.025% by weight, from 0.005% to 0.025% by weight, from 0.0075% to 0.025% by weight, from 0.01% to 0.025% by weight, from 0.001% to 0.01% by weight, from 0.0025% to 0.01% by weight, from 0.005% to 0.01% by weight, from 0.0075% to 0.01% by weight, from 0.001% to 0.0075% by weight, from 0.0025% to 0.0075% by weight, from 0.005% to 0.0075% by weight, from 0.001% to 0.005% by weight, from 0.0025% to 0.005% by weight, or from 0.001% to 0.005% by weight), based on the total weight of the low interfacial tension (IFT) injection fluid.

When present, the one or more co-solvents can have a concentration within the low interfacial tension (IFT) injection fluid of less than 2%, less than 1.5%, less than 1%, less than 0.5%, less than 0.2%, less than 0.1%, less than 0.075%, less than 0.05%, or less than 0.01%. For example, the one or more co-solvents can have a concentration within the low interfacial tension (IFT) injection fluid of from 0.001% to 1.5% by weight (e.g., 0.05% to 0.5% by weight), based on the total weight of the low interfacial tension (IFT) injection fluid.

After the single-phase liquid surfactant package has been combined with the aqueous-based injection fluid, the low interfacial tension (IFT) injection fluid may be a single-phase fluid or may be an emulsion depending on the amount of oil within the injection fluid.

In some embodiments, the two or more surfactants in the single-phase liquid surfactant package can decrease the interfacial tension (IFT) of the low interfacial tension (IFT) injection fluid with hydrocarbons in the reservoir. Reducing the IFT can decrease pressure required to drive an aqueous-based injection fluid into the formation matrix. In addition, decreasing the IFT reduces water block during production, facilitating the flow of hydrocarbons from the formation to the wellbore (e.g., facilitating the flow of hydrocarbons back through the fractures and to the wellbore). In this way, hydrocarbon recovery can be facilitated by the two or more surfactants in the single-phase liquid surfactant package.

In some embodiments, the interfacial tension (IFT) of the injection fluid can be of 1 or less (e.g., 0.9 or less, 0.8 or less, 0.7 or less, 0.6 or less, 0.5 or less, 0.4 or less, 0.3 or less, 0.25 or less, 0.2 or less, 0.15 or less, 0.1 or less, 0.09 or less, 0.08 or less, 0.07 or less, 0.06 or less, 0.05 or less, 0.04 or less, 0.03 or less, 0.02 or less, 0.01 or less, 0.009 or less, 0.008 or less, 0.007 or less, or 0.006 or less).

In some embodiments, the interfacial tension (IFT) of the injection fluid can be of at least 0.005 (e.g., at least 0.9, at least 0.8, at least 0.7, at least 0.6, at least 0.5, at least 0.4, at least 0.3, at least 0.25, at least 0.2, at least 0.15, at least 0.1, at least 0.09, at least 0.08, at least 0.07, at least 0.06, at least 0.05, at least 0.04, at least 0.03, at least 0.02, at least 0.01, at least 0.009, at least 0.008, at least 0.007, or at least 0.006).

In some embodiments, the interfacial tension (IFT) of the injection fluid can be from 0.005 to 1 (e.g., from 0.005 to 0.9, from 0.005 to 0.75, from 0.005 to 0.5, from 0.005 to 0.25, from 0.005 to 0.1, from 0.005 to 0.075, from 0.005 to 0.05, from 0.005 to 0.025, from 0.005 to 0.01, from 0.005 to 0.0075, from 0.0075 to 1, from 0.0075 to 0.9, from 0.0075 to 0.75, from 0.0075 to 0.5, from 0.0075 to 0.25, from 0.0075 to 0.1, from 0.0075 to 0.075, from 0.0075 to 0.05, from 0.0075 to 0.025, from 0.0075 to 0.01, from 0.01 to 1, from 0.01 to 0.9, from 0.01 to 0.75, from 0.01 to 0.5, from 0.01 to 0.25, from 0.01 to 0.1, from 0.01 to 0.075, from 0.01 to 0.05, from 0.01 to 0.025, from 0.025 to 1, from 0.025 to 0.9, from 0.025 to 0.75, from 0.025 to 0.5, from 0.025 to 0.25, from 0.025 to 0.1, from 0.025 to 0.075, from 0.025 to 0.05, from 0.05 to 1, from 0.05 to 0.9, from 0.05 to 0.75, from 0.05 to 0.5, from 0.05 to 0.25, from 0.05 to 0.1, from 0.05 to 0.075, from 0.075 to 1, from 0.075 to 0.9, from 0.075 to 0.75, from 0.075 to 0.5, from 0.075 to 0.25, from 0.075 to 0.1, from 0.1 to 1, from 0.1 to 0.9, from 0.1 to 0.75, from 0.1 to 0.5, from 0.1 to 0.25, from 0.25 to 1, 0.25 to 0.9, from 0.25 to 0.75, from 0.25 to 0.5, from 0.5 to 1, from 0.5 to 0.9, from 0.5 to 0.75, from 0.75 to 0.9, or from 0.75 to 1).

In some embodiments, the two or more surfactants in the single-phase liquid surfactant package (and ultimately the low interfacial tension (IFT) injection fluid) can change the wettability of the reservoir. In particular, in embodiments where the reservoir is oil-wet or mixed-wet. By increasing the water-wetness of the reservoir, the formation will imbibe injected aqueous-based injection fluid into the formation matrix, leading to a corresponding flow of hydrocarbon from regions within the formation back to the fracture.

In some embodiments, the single-phase liquid surfactant package (and ultimately the low interfacial tension (IFT) injection fluid) can improve hydrocarbon recovery by increasing the aqueous stability of the low interfacial tension (IFT) injection fluid at the temperature and salinity of the reservoir and decreasing the interfacial tension (IFT) of the low interfacial tension (IFT) injection fluid with hydrocarbons in the reservoir. In some embodiments, the single-phase liquid surfactant package (and ultimately the low interfacial tension (IFT) injection fluid) can improve hydrocarbon recovery by increasing the aqueous stability of the low interfacial tension (IFT) injection fluid at the temperature and salinity of the reservoir and increasing the wettability of the reservoir. In certain embodiments, the single-phase liquid surfactant package (and ultimately the low interfacial tension (IFT) injection fluid) can improve hydrocarbon recovery by increasing the aqueous stability of the low interfacial tension (IFT) injection fluid at the temperature and salinity of the reservoir, decreasing the interfacial tension (IFT) of the low interfacial tension (IFT) injection fluid with hydrocarbons in the reservoir, and changing the wettability of the reservoir.

### Example Compositions

| Composition | Components |
|---|---|
| 1 | 0.15% C16-18-25EO |
| | 0.15% C28-35PO-30EO |
| | 0.2% disulfonate |
| 2 | 0.15% C16-18-25EO |
| | 0.15% C12-14-40EO |
| | 0.2% disulfonate |
| 3 | 0.15% C16-18-25EO |
| | 0.15% C12-14-40EO |
| | 0.2% sulfosuccinate |
| 4 | 0.15% C12-14-40EO |
| | 0.15% C28-35PO-30EO |
| | 0.2% disulfonate |
| 5 | 0.15% C12-14-40EO |
| | 0.15% C28-35PO-30EO |
| | 0.2% sulfosuccinate |
| 6 | 0.18% C16-18-25EO |
| | 0.12% Disulfonate |
| 7 | 0.09% C16-18-25EO |
| | 0.09% C28-35PO-30EO |
| | 0.12% disulfonate |
| 8 | 0.3% C28-35PO-30EO |
| | 0.2% Disulfonate |
| 9 | 0.25% C16-18 IOS |
| | 0.25% C9-11-8EO |
| 10 | 0.25% C16-18 IOS |
| | 0.25% C16-18-25EO |
| 11 | 0.25% C16-18 IOS |
| | 0.25% C28-35PO-30EO |
| 12 | 0.4% C16-18 IOS |
| | 0.1% C28-35PO-30EO |
| 13 | 0.3% C16-18 IOS |
| | 0.2% C28-35PO-30EO |
| 14 | 0.125% C16-18 IOS |
| | 0.125% C28-35PO-30EO |
| 15 | 0.15% C16-18 IOS |
| | 0.1% C13-9PO-Sulfate |
| 16 | 0.125% C13-9PO-Sulfate |
| | 0.125% C16-18-25EO |
| 17 | 0.125% C13-9PO-Sulfate |
| | 0.125% C9-11-8EO |
| 18 | 0.125% C13-9PO-Sulfate |
| | 0.125% C28-35PO-30EO |
| 19 | 0.1% C13-9PO-Sulfate |
| | 0.1% C9-11-8EO |
| | 0.1% C16-18-25EO |
| 20 | 0.1% C13-9PO-Sulfate |
| | 0.1% C9-11-8EO |
| | 0.1% C16-18 IOS |
| 21 | 0.1% C13-9PO-Sulfate |
| | 0.1% C9-11-8EO |
| | 0.1% Disulfonate |
| 22 | 0.06-0.14% Guerbet C10 ethoxylated |
| | alcohol |
| | 0.14-0.06% disulfonate |
| 23 | 0.06-0.19% C16-18-25EO |
| | 0.14-0.01% disulfonate |
| 24 | 0.06-0.14% Guerbet C10 ethoxylated |
| | alcohol |
| | 0.14-0.06% disulfonate |
| 25 | 0.06-0.19% C16-18-25EO |
| | 0.14-0.06% disulfonate |
| 26 | 0.1% Guerbet C10 ethoxylated alcohol |
| | 0.1% disulfonate |
| 27 | 0.12% C16-18-25EO |
| | 0.08% disulfonate |
| 28 | 0.1% C9-11-8EO |
| | 0.1% disulfonate |
| 29 | 0.12% C11-15 30EO |
| | 0.08% disulfonate |
| 30 | 0.1% C11-15 30EO |
| | 0.01-0.1% disulfonate |
| 31 | 0.25% C16-18-25EO |
| | 0.25% disulfonate |
| 32 | 0.25% C11-15 30EO |
| | 0.25% disulfonate |
| 33 | 0.18% C16-18-25EO |
| | 0.12% disulfonate |
| 34 | 0.24% C16-18-25EO |
| | 0.16% disulfonate |
| 35 | 0.24% C16-18-25EO |
| | 0.16% disulfonate |
| 36 | 0.12% C28-35PO-30EO |
| | 0.08% disulfonate |
| 37 | 0.18% oleyl-30EO |
| | 0.12% disulfonate |
| 38 | 0.18% C16-18-25EO |
| | 0.12% disulfonate |
| 39 | 0.18% oleyl-25-EO |
| | 0.12% disulfonate |
| 40 | 0.18% oleyl-20-EO |
| | 0.12% disulfonate |
| 41 | 0.06% C28-35PO-30EO |
| | 0.12% C16-18-25EO |
| | 0.12% disulfonate |
| 42 | 0.15% C16-18-25EO |
| | 0.15% C28-35PO-30EO |
| | 0.2% sulfosuccinate |
| 43 | 0.09% C16-18-25EO |
| | 0.09% C28-35PO-30EO |
| | 0.12% sulfosuccinate |
| 44 | 0.3% C28-35PO-30EO |
| | 0.2% sulfosuccinate |
| 45 | 0.18% C16-18-25EO |
| | 0.12% sulfosuccinate |
| | 0.09% C16-18-25EO |
| | 0.09% C28-35PO-30EO |
| 46 | 0.12% sulfosuccinate |
| 47 | 0.3% C28-35PO-30EO |
| | 0.2% sulfosuccinate |
| 48 | 0.25% C16-18 IOS |
| | 0.25% C16-18-25EO |
| 49 | 0.25% C16-18 IOS |
| | 0.25% C28-35PO-30EO |
| 50 | 0.4% C16-18 IOS |
| | 0.1% C28-35PO-30EO |
| 51 | 0.3% C16-18 IOS |
| | 0.2% C28-35PO-30EO |
| 52 | 0.125% C16-18 IOS |
| | 0.125% C28-35PO-30EO |
| 53 | 0.15% C16-18 IOS |
| | 0.1% C13-9PO-Sulfate |
| 54 | 0.125% C13-9PO-Sulfate |
| | 0.125% C16-18-25EO |
| 55 | 0.125% C13-9PO-Sulfate |
| | 0.125% C9-11-8EO |
| 56 | 0.125% C13-9PO-Sulfate |
| | 0.125% C28-35PO-30EO |
| 57 | 0.1% C13-9PO-Sulfate |
| | 0.1% C9-11-8EO |
| | 0.1% C16-18-25EO |
| 58 | 0.1% C13-9PO-Sulfate |
| | 0.1% C9-11-8EO |
| | 0.1% C16-18 IOS |
| 59 | 0.1% C13-9PO-Sulfate |
| | 0.1% C9-11-8EO |
| | 0.1% sulfosuccinate |
| 60 | 0.06-0.14% Guerbet C10 ethoxylated |
| | alcohol |
| | 0.14-0.06% sulfosuccinate |
| 61 | 0.06-0.19% C16-18-25EO |
| | 0.14-0.01% sulfosuccinate |
| 62 | 0.06-0.14% Guerbet C10 ethoxylated |
| | alcohol |
| | 0.14-0.06% sulfosuccinate |
| 63 | 0.06-0.19% C16-18-25EO |
| | 0.14-0.06% sulfosuccinate |
| 64 | 0.1% Guerbet C10 ethoxylated alcohol |
| | 0.1% sulfosuccinate |
| 65 | 0.12% C16-18-25EO |
| | 0.08% sulfosuccinate |
| 66 | 0.1% C9-11-8EO |
| | 0.1% sulfosuccinate |
| 67 | 0.12% C11-15 30EO |
| | 0.08% sulfosuccinate |
| 68 | 0.1% C11-15 30EO |
| | 0.01-0.1% sulfosuccinate |
| 69 | 0.25% C16-18-25EO |
| | 0.25% sulfosuccinate |
| 70 | 0.25% C11-15 30EO |
| | 0.25% sulfosuccinate |
| 71 | 0.18% C16-18-25EO |
| | 0.12% sulfosuccinate |
| 72 | 0.24% C16-18-25EO |
| | 0.16% sulfosuccinate |
| 73 | 0.24% C16-18-25EO |
| | 0.16% sulfosuccinate |
| 74 | 0.12% C28-35PO-30EO |
| | 0.08% sulfosuccinate |
| 75 | 0.18% oleyl-30EO |
| | 0.12% sulfosuccinate |
| 76 | 0.18% C28-35PO-30EO |
| | 0.12% sulfosuccinate |
| 77 | 0.18% C16-18-25EO |
| | 0.12% sulfosuccinate |
| 78 | 0.18% oleyl-25-EO |
| | 0.12% sulfosuccinate |
| 79 | 0.18% oleyl-20-EO |
| | 0.12% sulfosuccinate |
| 80 | 0.06% C28-35PO-30EO |
| | 0.12% C16-18-25EO |
| | 0.12% sulfosuccinate |
| 81 | 0.09% C18-35PO-45EO |
| | 0.09% C16-18-25EO |
| | 0.12% sulfosuccinate |
| 82 | 0.15% C16-18-25EO |
| | 0.15% C28-35PO-30EO-sulfate |
| | 0.2% disulfonate |
| 83 | 0.15% C16-18-25EO-sulfate |
| | 0.15% C28-35PO-30EO |
| | 0.2% disulfonate |
| 84 | 0.15% C16-18-25EO-sulfate |
| | 0.15% C28-35PO-30EO-sulfate |
| | 0.2% disulfonate |
| 85 | 0.15% C16-18-25EO-sulfate |
| | 0.15% C28-35PO-30EO |
| | 0.2% disulfonate |
| 86 | 0.09% C16-18-25EO |
| | 0.09% C28-35PO-30EO-sulfate |
| | 0.12% disulfonate |
| 87 | 0.18% C16-18-25EO-sulfate |
| | 0.12% Disulfonate |
| 88 | 0.09% C16-18-25EO-sulfate |
| | 0.09% C28-35PO-30EO-sulfate |
| | 0.12% disulfonate |
| 89 | 0.3% C28-35PO-30EO-sulfate |
| | 0.2% Disulfonate |
| 90 | 0.25% C16-18 IOS |
| | 0.25% C9-11-8EO |
| 91 | 0.25% C16-18 IOS |
| | 0.25% C16-18-25EO |
| 92 | 0.25% C16-18 IOS |
| | 0.25% C28-35PO-30EO |
| 93 | 0.4% C16-18 IOS |
| | 0.1% C28-35PO-30EO |
| 94 | 0.3% C16-18 IOS |
| | 0.2% C28-35PO-30EO |
| 95 | 0.15% C16-18 IOS |
| | 0.1% C13-9PO-Sulfate |
| 96 | 0.125% C13-9PO-Sulfate |
| | 0.125% C16-18-25EO |
| 97 | 0.125% C13-9PO-Sulfate |
| | 0.125% C9-11-8EO |
| 98 | 0.125% C13-9PO-Sulfate |
| | 0.125% C28-35PO-30EO |
| 99 | 0.1% C13-9PO-Sulfate |
| | 0.1% C9-11-8EO |
| | 0.1% C16-18-25EO |
| 100 | 0.1% C13-9PO-Sulfate |
| | 0.1% C9-11-8EO |
| | 0.1% C16-18 IOS |
| 101 | 0.1% C13-9PO-Sulfate |
| | 0.1% C9-11-8EO |
| | 0.1% Disulfonate |
| 102 | 0.06-0.14% Guerbet C10 ethoxylated |
| | alcohol |
| | 0.14-0.06% disulfonate |
| | 0.06-0.19% C16-18-25EO |
| 103 | 0.14-0.01% disulfonate |
| | 0.06-0.14% Guerbet C10 ethoxylated |
| | alcohol |
| | 0.14-0.06% disulfonate |
| 104 | 0.06-0.19% C16-18-25EO |
| | 0.14-0.06% disulfonate |
| | 0.1% Guerbet C10 ethoxylated alcohol |
| 105 | 0.1% disulfonate |
| | 0.12% C16-18-25EO |
| | 0.08% disulfonate |
| 106 | 0.1% C9-11-8EO |
| | 0.1% disulfonate |
| 107 | 0.12% C11-15 30EO |
| | 0.08% disulfonate |
| 108 | 0.1% C11-15 30EO |
| | 0.01-0.1% disulfonate |
| 109 | 0.25% C16-18-25EO |
| | 0.25% disulfonate |
| 110 | 0.25% C11-15 30EO |
| | 0.25% disulfonate |
| 111 | 0.18% C16-18-25EO |
| | 0.12% disulfonate |
| 112 | 0.24% C16-18-25EO |
| | 0.16% disulfonate |
| 113 | 0.24% C16-18-25EO |
| | 0.16% disulfonate |
| 114 | 0.12% C28-35PO-30EO |
| | 0.08% disulfonate |
| 115 | 0.18% oleyl-30EO |
| | 0.12% disulfonate |
| 116 | 0.18% C16-18-25EO |
| | 0.12% disulfonate |
| 117 | 0.18% oleyl-25-EO |
| | 0.12% disulfonate |
| 118 | 0.18% oleyl-20-EO |
| | 0.12% disulfonate |
| 119 | 0.06% C28-35PO-30EO |
| | 0.12% C16-18-25EO |
| | 0.12% disulfonate |
| 120 | 0.06% C28-35PO-30EO-sulfate |
| | 0.12% C16-18-25EO |
| | 0.12% disulfonate |
| 121 | 0.15% C16-18-25EO |
| | 0.15% C28-35PO-30EO-carboxylate |
| | 0.2% disulfonate |
| 122 | 0.15% C16-18-25EO-carboxylate |
| | 0.15% C28-35PO-30EO |
| | 0.2% disulfonate |
| 123 | 0.15% C16-18-25EO-carboxylate |
| | 0.15% C28-35PO-30EO-carboxylate |
| | 0.2% disulfonate |
| 124 | 0.15% C16-18-25EO-carboxylate |
| | 0.15% C28-35PO-30EO |
| | 0.2% disulfonate |
| 126 | 0.09% C16-18-25EO |
| | 0.09% C28-35PO-30EO-carboxylate |
| | 0.12% disulfonate |
| 127 | 0.09% C16-18-25EO-carboxylate |
| | 0.09% C28-35PO-30EO-carboxylate |
| | 0.12% disulfonate |
| 128 | 0.3% C28-35PO-30EO-carboxylate |
| | 0.2% Disulfonate |
| 129 | 0.25% C16-18 IOS |
| | 0.25% C9-11-8EO |
| 130 | 0.25% C16-18 IOS |
| | 0.25% C16-18-25EO |
| 131 | 0.25% C16-18 IOS |
| | 0.25% C28-35PO-30EO |
| 132 | 0.4% C16-18 IOS |
| | 0.1% C28-35PO-30EO |
| 133 | 0.3% C16-18 IOS |
| | 0.2% C28-35PO-30EO |
| 134 | 0.06-0.14% Guerbet C10 ethoxylated |
| | alcohol |
| | 0.14-0.06% disulfonate |
| 135 | 0.06-0.19% C16-18-25EO |
| | 0.14-0.01% disulfonate |
| 136 | 0.06-0.14% Guerbet C10 ethoxylated |
| | alcohol |
| | 0.14-0.06% disulfonate |
| 138 | 0.06-0.19% C16-18-25EO |
| | 0.14-0.06% disulfonate |
| 139 | 0.1% Guerbet C10 ethoxylated alcohol |
| | 0.1% disulfonate |
| 140 | 0.12% C16-18-25EO |
| | 0.08% disulfonate |
| 141 | 0.1% C9-11-8EO |
| | 0.1% disulfonate |
| 142 | 0.12% C11-15 30EO |
| | 0.08% disulfonate |
| 143 | 0.1% C11-15 30EO |
| | 0.01-0.1% disulfonate |
| 144 | 0.25% C16-18-25EO |
| | 0.25% disulfonate |
| 145 | 0.25% C11-15 30EO |
| | 0.25% disulfonate |
| 146 | 0.18% C16-18-25EO |
| | 0.12% disulfonate |
| 147 | 0.24% C16-18-25EO |
| | 0.16% disulfonate |
| 148 | 0.24% C16-18-25EO |
| | 0.16% disulfonate |
| 149 | 0.12% C28-35PO-30EO |
| | 0.08% disulfonate |
| 150 | 0.18% oleyl-30EO |
| | 0.12% disulfonate |
| 151 | 0.18% oleyl-25-EO |
| | 0.12% disulfonate |
| 152 | 0.18% oleyl-20-EO |
| | 0.12% disulfonate |
| 153 | 0.06% C28-35PO-30EO |
| | 0.12% C16-18-25EO |
| | 0.12% disulfonate |
| 154 | 0.06% C28-35PO-30EO-carboxylate |
| | 0.12% C16-18-25EO |
| | 0.12% disulfonate |
| 155 | 0.15% C16-18-25EO |
| | 0.15% C28-35PO-30EO-sulfate |
| | 0.2% sulfosuccinate |
| 156 | 0.15% C16-18-25EO-sulfate |
| | 0.15% C28-35PO-30EO |
| | 0.2% sulfosuccinate |
| 157 | 0.15% C16-18-25EO-sulfate |
| | 0.15% C28-35PO-30EO-sulfate |
| | 0.2% sulfosuccinate |
| 158 | 0.15% C16-18-25EO-sulfate |
| | 0.15% C28-35PO-30EO |
| | 0.2% sulfosuccinate |
| 159 | 0.09% C16-18-25EO-sulfate |
| | 0.09% C28-35PO-30EO-sulfate |
| | 0.12% sulfosuccinate |
| 160 | 0.3% C28-35PO-30EO-sulfate |
| | 0.2% sulfosuccinate |
| 161 | 0.25% C16-18 IOS |
| | 0.25% C9-11-8EO |
| 162 | 0.25% C16-18 IOS |
| | 0.25% C16-18-25EO |
| 163 | 0.25% C16-18 IOS |
| | 0.25% C28-35PO-30EO |
| 164 | 0.4% C16-18 IOS |
| | 0.1% C28-35PO-30EO |
| 165 | 0.3% C16-18 IOS |
| | 0.2% C28-35PO-30EO |
| 166 | 0.125% C16-18 IOS |
| | 0.125% C28-35PO-30EO |
| 167 | 0.15% C16-18 IOS |
| | 0.1% C13-9PO-Sulfate |
| 168 | 0.125% C13-9PO-Sulfate |
| | 0.125% C16-18-25EO |
| 169 | 0.125% C13-9PO-Sulfate |
| | 0.125% C9-11-8EO |
| 170 | 0.125% C13-9PO-Sulfate |
| | 0.125% C28-35PO-30EO |
| 171 | 0.1% C13-9PO-Sulfate |
| | 0.1% C9-11-8EO |
| | 0.1% C16-18-25EO |
| 172 | 0.1% C13-9PO-Sulfate |
| | 0.1% C9-11-8EO |
| | 0.1% C16-18 IOS |
| 173 | 0.1% C13-9PO-Sulfate |
| | 0.1% C9-11-8EO |
| | 0.1% sulfosuccinate |
| 174 | 0.06-0.14% Guerbet C10 ethoxylated |
| | alcohol |
| | 0.14-0.06% sulfosuccinate |
| 175 | 0.06-0.19% C16-18-25EO |
| | 0.14-0.01% sulfosuccinate |
| 176 | 0.06-0.14% Guerbet C10 ethoxylated |
| | alcohol |
| | 0.14-0.06% sulfosuccinate |
| 177 | 0.06-0.19% C16-18-25EO |
| | 0.14-0.06% sulfosuccinate |
| 178 | 0.1% Guerbet C10 ethoxylated alcohol |
| | 0.1% sulfosuccinate |
| 179 | 0.12% C16-18-25EO |
| | 0.08% sulfosuccinate |
| 180 | 0.1% C9-11-8EO |
| | 0.1% sulfosuccinate |
| 181 | 0.12% C11-15 30EO |
| | 0.08% sulfosuccinate |
| 182 | 0.1% C11-15 30EO |
| | 0.01-0.1% sulfosuccinate |
| 183 | 0.25% C16-18-25EO |
| | 0.25% sulfosuccinate |
| 184 | 0.25% C11-15 30EO |
| | 0.25% sulfosuccinate |
| 185 | 0.18% C16-18-25EO |
| | 0.12% sulfosuccinate |
| 186 | 0.24% C16-18-25EO |
| | 0.16% sulfosuccinate |
| 187 | 0.24% C16-18-25EO |
| | 0.16% sulfosuccinate |
| 188 | 0.12% C28-35PO-30EO |
| | 0.08% sulfosuccinate |
| 189 | 0.18% oleyl-30EO |
| | 0.12% sulfosuccinate |
| 190 | 0.18% C16-18-25EO |
| | 0.12% sulfosuccinate |
| 191 | 0.18% oleyl-25-EO |
| | 0.12% sulfosuccinate |
| 192 | 0.18% oleyl-20-EO |
| | 0.12% sulfosuccinate |
| 193 | 0.06% C28-35PO-30EO |
| | 0.12% C16-18-25EO |
| | 0.12% sulfosuccinate |
| 194 | 0.06% C28-35PO-30EO-sulfate |
| | 0.12% C16-18-25EO |
| | 0.12% sulfosuccinate |
| 195 | 0.15% C16-18-25EO-carboxylate |
| | 0.15% C28-35PO-30EO |
| | 0.2% sulfosuccinate |
| 196 | 0.15% C16-18-25EO-carboxylate |
| | 0.15% C28-35PO-30EO-carboxylate |
| | 0.2% sulfosuccinate |
| 197 | 0.15% C16-18-25EO-carboxylate |
| | 0.15% C28-35PO-30EO |
| | 0.2% sulfosuccinate |
| 198 | 0.09% C16-18-25EO |
| | 0.09% C28-35PO-30EO-carboxylate |
| | 0.12% sulfosuccinate |
| 199 | 0.18% C16-18-25EO-carboxylate |
| | 0.12% sulfosuccinate |
| 200 | 0.09% C16-18-25EO-carboxylate |
| | 0.09% C28-35PO-30EO-carboxylate |
| | 0.12% sulfosuccinate |
| 201 | 0.3% C28-35PO-30EO-carboxylate |
| | 0.2% sulfosuccinate |
| 202 | 0.25% C16-18 IOS |
| | 0.25% C9-11-8EO |
| 203 | 0.25% C16-18 IOS |
| | 0.25% C16-18-25EO |
| 204 | 0.25% C16-18 IOS |
| | 0.25% C28-35PO-30EO |
| 205 | 0.4% C16-18 IOS |
| | 0.1% C28-35PO-30EO |
| 206 | 0.3% C16-18 IOS |
| | 0.2% C28-35PO-30EO |
| 207 | 0.125% C16-18 IOS |
| | 0.125% C28-35PO-30EO |
| 208 | 0.06-0.14% Guerbet C10 ethoxylated |
| | alcohol |
| | 0.14-0.06% sulfosuccinate |
| 209 | 0.06-0.19% C16-18-25EO |
| | 0.14-0.01% sulfosuccinate |
| 210 | 0.06-0.14% Guerbet C10 ethoxylated |
| | alcohol |
| | 0.14-0.06% sulfosuccinate |
| 211 | 0.06-0.19% C16-18-25EO |
| | 0.14-0.06% sulfosuccinate |
| 212 | 0.1% Guerbet C10 ethoxylated alcohol |
| | 0.1% sulfosuccinate |
| 213 | 0.12% C16-18-25EO |
| | 0.08% sulfosuccinate |
| 214 | 0.1% C9-11-8EO |
| | 0.1% sulfosuccinate |
| 215 | 0.12% C11-15 30EO |
| | 0.08% sulfosuccinate |
| 216 | 0.1% C11-15 30EO |
| | 0.01-0.1% sulfosuccinate |
| 217 | 0.25% C16-18-25EO |
| | 0.25% sulfosuccinate |
| 218 | 0.25% C11-15 30EO |
| | 0.25% sulfosuccinate |
| 219 | 0.18% C16-18-25EO |
| | 0.12% sulfosuccinate |
| 220 | 0.24% C16-18-25EO |
| | 0.16% sulfosuccinate |
| 221 | 0.24% C16-18-25EO |
| | 0.16% sulfosuccinate |
| 222 | 0.12% C28-35PO-30EO |
| | 0.08% sulfosuccinate |
| 223 | 0.18% oleyl-30EO |
| | 0.12% sulfosuccinate |
| 224 | 0.18% C16-18-25EO |
| | 0.12% sulfosuccinate |
| 225 | 0.18% oleyl-25-EO |
| | 0.12% sulfosuccinate |
| 226 | 0.18% oleyl-20-EO |
| | 0.12% sulfosuccinate |
| 227 | 0.06% C28-35PO-30EO |
| | 0.12% C16-18-25EO |
| | 0.12% sulfosuccinate |
| 228 | 0.09% C28-35PO-30EO-carboxylate |
| | 0.09% C12-14-40EO |
| | 0.12% disulfonate |
| 229 | 0.06% C28-35PO-30EO-carboxylate |
| | 0.12% C16-18-25EO |
| | 0.12% sulfosuccinate |
| 230 | 0.09% C28-35PO-30EO-carboxylate |
| | 0.09% C12-14-40EO |
| | 0.12% sulfosuccinate |
| 231 | 0.18% C12-14-40EO |
| | 0.12% Disulfonate |
| 232 | 0.18% C12-14-40EO |
| | 0.12% sulfosuccinate |
| 233 | 0.18% C12-14-40EO |
| | 0.12% disulfonate |

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1

### Core Test

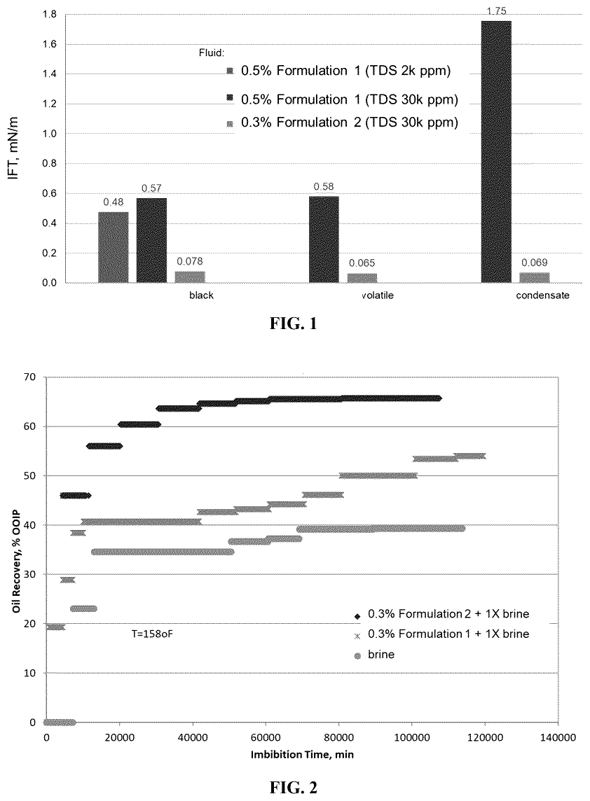

Table 1. shows that on average, the core scale oil recovery by injection fluid ranges from 43.1 to 54.5%, with an average of 49.2%. Lower IFT formulation (bold) gives an average oil recovery of 52.8 which are better than formulation 1 (C16-18 ethoxylated alcohol and disulfonate) and injection brine (IB) with reduced chemical concentration. **Strong emulsion is produced, *weak emulsion is produced. The results are shown in FIG. 1 for interfacial tension for formulation 1 and formulation 2 (C16-18 ethoxylated alcohol, Guerbet C28 propoxylated-ethoxylated alcohol, and disulfonate) with Oils.

| | Oil recovery, % | | |
|---|---|---|---|
| Injection Fluid | Black | Volatile | Condensate |
| Injection brine (IB) | 12 | 15 | X |
| 0.5% formulation 1 (0.3% C16-18-25EO, 0.2% | 45.1** | 38.2** | X |
| disulfonate) + IB | | | |
| 0.5% formulation 1 (0.3% C16-18-25EO, 0.2% | 55.5 | 42.7 | 52 |
| disulfonate) + synthetic formation brine (FB) | | | |
| 0.3% formulation 2 (0.09% C16-18-25EO | X | X | 57* |
| 0.09% Guerbet C28-35PO-30EO, and 0.12% | | | |
| disulfonate) + FB | | | |
| Avg. oil recovery, % | 50.3 | 43.1 | 54.5 |

### Imbibition Test

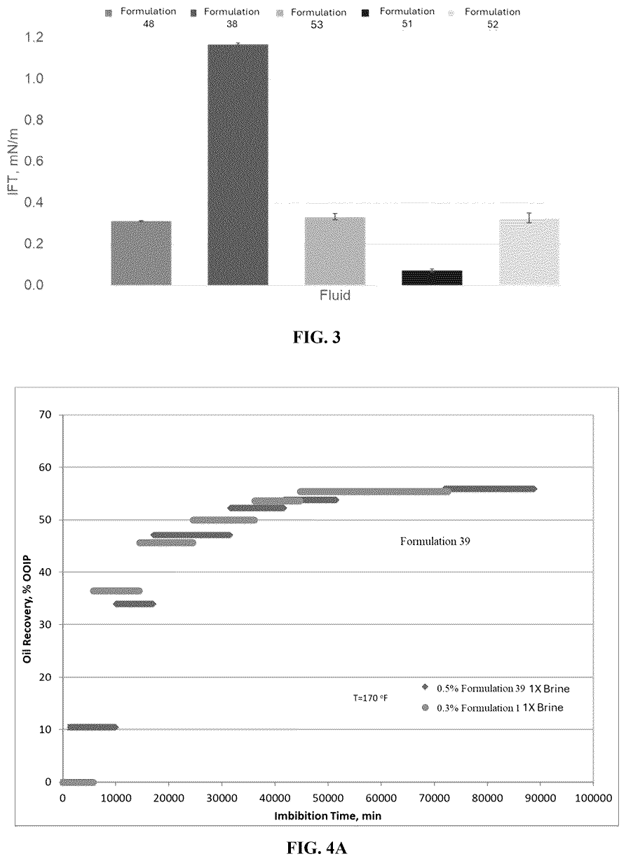

Results for imbibition test with low lIFT formulations (formulation 2 (′0.01) and formulation 1 (~0.8)) are shown in FIG. 2.

Table 2. shows low IFT formulation IFT at 148,000 ppm and 76 C/mN/m

| | | IFT at 148,000 |
|---|---|---|
| | | ppm and 76 |
| Formulation | Components | C./mN/m |
| 0.3% formulation 1 | 0.18% C16-18 25EO 0.12% | 0.88 |
| | disulfonate | |
| 0.3% formulation 2 | 0.09% C16-18 25EO | 0.086 |
| | 0.09% Guerbet C28 35PO- | |
| | 30EO | |
| | 0.12% disulfonate | |

| | | IFT at 178,000 |
|---|---|---|
| | | ppm and 76° |
| Formulation | Components | C./mN/m |
| 0.5% formulation 1 | 0.3% C16-18 25EO | 0.88 |
| | 0.2% disulfonate | |
| 0.5% formulation 7 | 0.3% Guerbet C28 35PO- | 0.07 |
| | 30EO | |
| | 0.2% disulfonate | |
| 0.3% formulation 2 | 0.09% C16-18 25EO | 0.086 |
| | 0.09% Guerbet C28 35PO- | |
| | 30EO | |
| | 0.12% disulfonate | |

Table 4. shows additional low IFT formulation tested.

| Formulation | Components |
|---|---|
| 0.5% Formulation 8 | 0.25% C16-18 IOS |
| | 0.25% C9-11-8EO |
| 0.5% Formulation 9 | 0.25% C16-18 IOS |
| | 0.25% C16-18 25EO |
| 0.5% Formulation 10 | 0.25% C16-18 IOS |
| | 0.25% Guerbet C28 propoxylated- |
| | ethoxylated alcohol |
| 0.5% Formulation 11 | 0.4% C16-18 IOS |
| | 0.1% Guerbet C28 propoxylated- |
| | ethoxylated alcohol |
| 0.5% Formulation 12 | 0.3% C16-18 IOS |
| | 0.2% Guerbet C28 propoxylated- |
| | ethoxylated alcohol |
| 0.25% Formulation 13 | 0.125% C16-18 IOS |
| | 0.125% Guerbet C28 propoxylated- |
| | ethoxylated alcohol |
| 0.25% Formulation 14 | 0.125% C16-18 IOS |
| | 0.125% Guerbet C28 propoxylated- |
| | ethoxylated alcohol |
| 0.25% Formulation 15 | 0.15% C16-18 IOS |
| | 0.1% C13 propoxylated sulfate |
| 0.25% Formulation 16 | 0.125% C13 propoxylated sulfate |
| | 0.125% C16-18 ethoxylated alcohol |
| 0.25% Formulation 17 | 0.125% C13 propoxylated sulfate |
| | 0.125% C9-11 ethoxylated alcohol |
| 0.25% Formulation 18 | 0.125% C13 propoxylate sulfate |
| | 0.125% Guerbet C28 propoxylated- |
| | ethoxylated alcohol |
| 0.3% Formulation 19 | 0.1% C13 propoxylated sulfate |
| | 0.1% C9-11-ethoxylated alcohol |
| | 0.1% C16-18 ethoxylated alcohol |
| 0.3% Formulation 20 | 0.1% C13 propoxylated sulfate |
| | 0.1% C9-11 ethoxylated alcohol |
| | 0.1% C16-18 IOS |
| 0.3% Formulation 21 | 0.1% C13 propoxylated sulfate |
| | 0.1% C9-11- ethoxylated alcohol |
| | 0.1% disulfonate |
| 0.20% Formulation 22 | 0.06-0.14% Guerbet C10 ethoxylated |
| | alcohol |
| | 0.14-0.06% disulfonate |
| 0.20% Formulation 23 | 0.06-0.19% C16-18 ethoxylated alcohol |
| | 0.14-0.01% disulfonate |
| 0.20% Formulation 24 | 0.06-0.14% Guerbet C10 ethoxylated |
| | alcohol |
| | 0.14-0.06% disulfonate |
| 0.20% Formulation 25 | 0.06-0.19% C16-18 ethoxylated alcohol |
| | 0.14-0.06% disulfonate |
| 0.20% Formulation 26 | 0.1% Guerbet C10 ethoxylated alcohol |
| | 0.1% disulfonate |
| 0.20% Formulation 27 | 0.12% C16-18 ethoxylated alcohol |
| | 0.08% disulfonate |
| 0.20% Formulation 29 | 0.1% C9-11 ethoxylated alcohol 0.1% |
| | disulfonate |
| 0.20% Formulation 31 | 0.12% C11-15 ethoxylated alcohol |
| | 0.08% disulfonate |
| Formulation 32 | 0.1% C11-15 ethoxylated alcohol 0.01- |
| | 0.1% disulfonate |
| 0.50% Formulation 33 | 0.25% C16-18 ethoxylated alcohol |
| | 0.25% disulfonate |
| 0.50% Formulation 35 | 0.3% C16-18 ethoxylated alcohol |
| | 0.2% disulfonate |
| 0.50% Formulation 36 | 0.25% C11-15 ethoxylated alcohol |
| | 0.25% disulfonate |
| 0.30% Formulation 38 | 0.18% C16-18 ethoxylated alcohol |
| | 0.12% disulfonate |
| 0.40% Formulation 53 | 0.24% C16-18 ethoxylated alcohol |
| | 0.16% disulfonate |
| 0.50% Formulation 54 | 0.3% C16-18 ethoxylated alcohol |
| | 0.2% disulfonate |
| 0.20% Formulation 45 | 0.12% Guerbet C28 propoxylated- |
| | ethoxylated alcohol |
| | 0.08% disulfonate |
| 0.20% Formulation 46 | 0.12% Guerbet C28 propoxylated- |
| | ethoxylated alcohol |
| | 0.08% disulfonate |

Table 5. shows low IFT formulation IFT at 178,000 ppm and 76° C./mN/m

| | | Total |
|---|---|---|
| | | TDS |
| Formulation | Components | (ppm) |
| 0.3% Formulation 38 | 0.18% C16-18 ethoxylated alcohol | 200K |
| | 0.12% disulfonate | |
| 0.3% Formulation 49 | 0.18% oleyl ethoxylated alcohol 0.12% | 200K |
| | disulfonate | |
| 0.36% Formulation 50 | 0.18% oleyl ethoxylated alcohol 0.18% | >211K |
| | disulfonate | |
| 0.3% Formulation 2 | 0.09% C16-18 ethoxylated alcohol | 200K |
| | 0.09% Guerbet C28 propoxylated- | |
| | ethoxylated alcohol | |
| | 0.12% disulfonate | |
| 0.3% Formulation 48 | 0.18% Guerbet C28 propoxylated- | >211K |
| | ethoxylated alcohol | |
| | 0.12% disulfonate | |

### Interfacial Tension

### Test Conditions:

Oil phase: condensate, Fluid: brine x5, Temperature 169° F. (76° C.), measurement using spinning drop tensimeter.

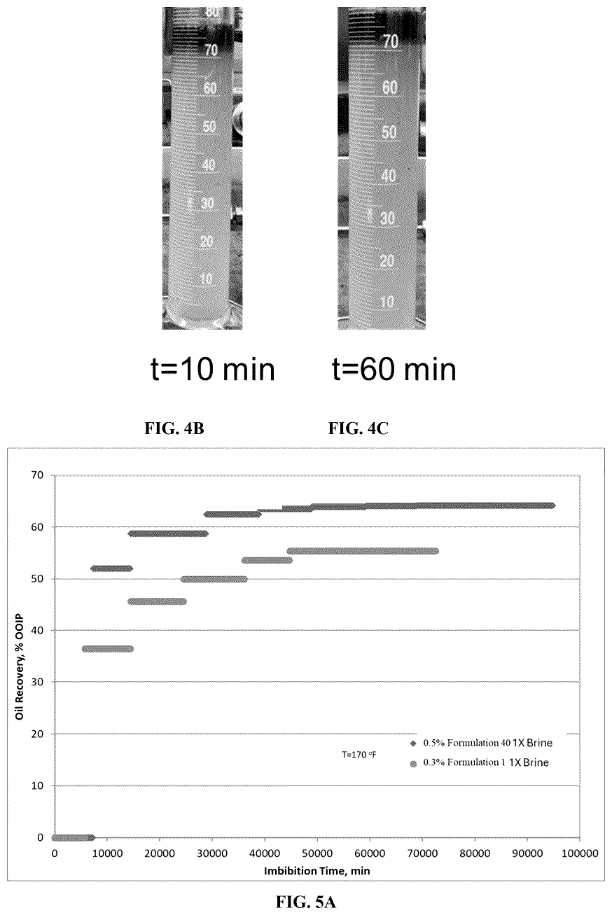

Results are shown in FIG. 3 for the formulations on Table 6. Formulation 51 had an IFT of 0.07 mN/in, Formulations 48, 53, and 52 had an lIFT of 0.3 mN/in, and Formulation 38 had an IFT of 1.1 mN/in.

TABLE 6
Formulation used for interfacial tension measurements.

| | | Aqueous stability |
|---|---|---|
| | | Total TDS (ppm,) at |
| Formulation | Components | 75° C. |
| 0.3% Formulation 48 | 0.18% Guerbet C28 | >211,000 |
| | propoxylated- | |
| | ethoxylated alcohol | |
| | 0.12% disulfonate | |
| 0.3% Formulation 38 | 0.18% C16-18 | 188,000 |
| | ethoxylated alcohol | |
| | 0.12% disulfonate | |
| | 0.045% EGBE | |
| 0.3% Formulation 53 | 0.18% C16-18 | 200,000 |
| | ethoxylated alcohol | |
| | 0.12% disulfonate-2 | |
| 0.3% Formulation 49 | 0.18% oleyl ethoxylated | 200,000 |
| | alcohol | |
| | 0.12% disulfonate | |
| 0.3% Formulation 51 | 0.09% Guerbet C28 | 200,000 |
| | propoxylated- | |
| | ethoxylated alcohol | |
| | 0.09% C16-18 | |
| | ethoxylated alcohol | |
| | 0.12% disulfonate | |
| 0.3% Formulation 52 | 0.06% Guerbet C28 | 188,000 |
| | propoxylated- | |
| | ethoxylated alcohol | |
| | 0.12% C16-18 | |
| | ethoxylated alcohol | |
| | 0.12% disulfonate | |

### Assessment of Formulations 39 and 40

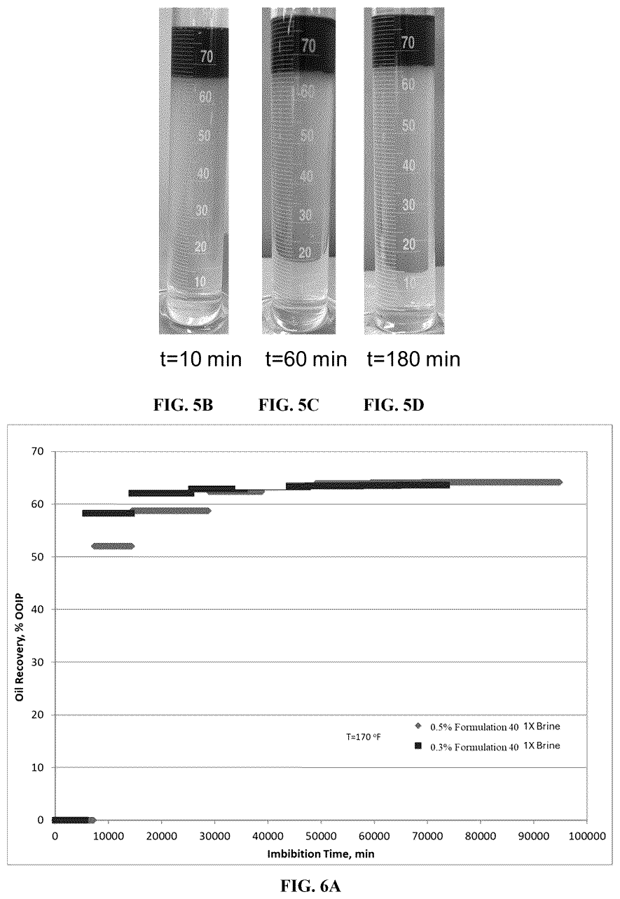

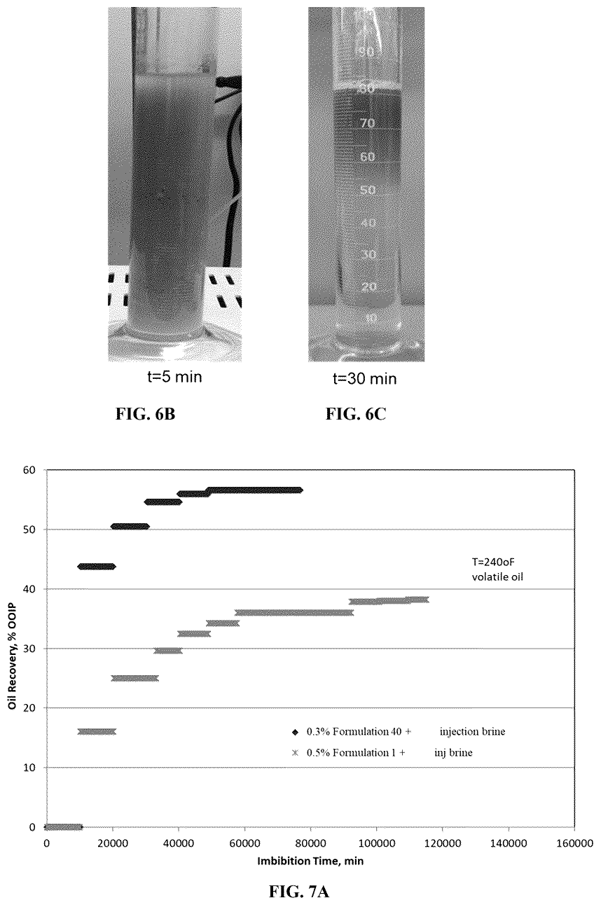

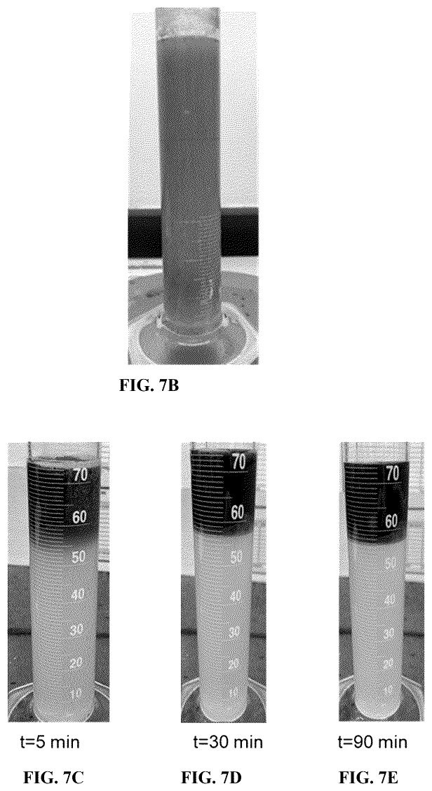

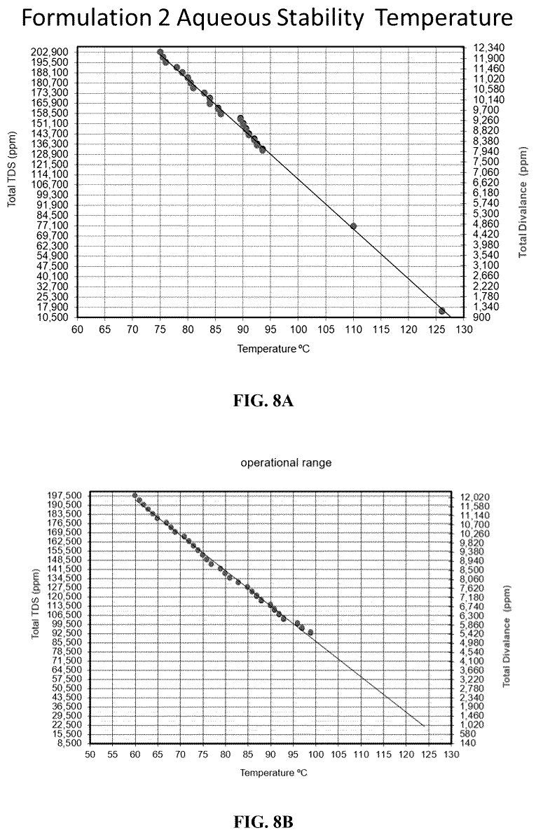

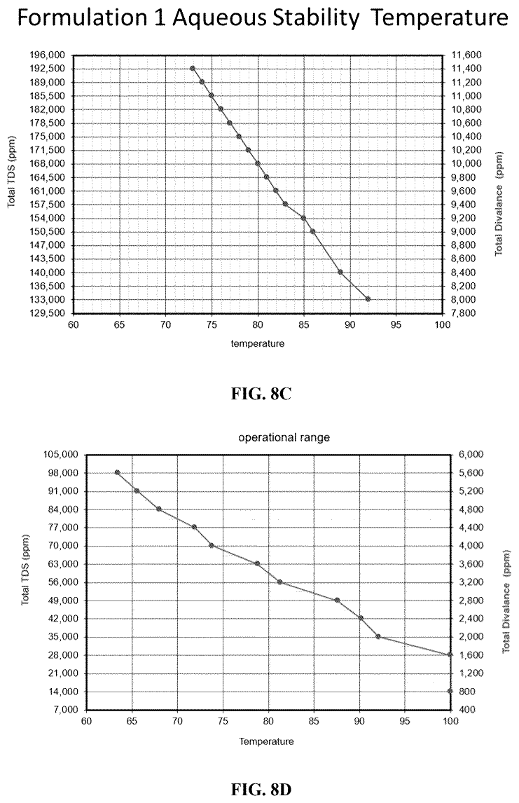

Results of oil recovery are shown in FIGS. 4A-8E. FIGS. 4A-4C show results of oil recovery over time for formulation 39 (3:2 ratio of C12-14-40EO (ethoxylated alcohol) to disulfonate) compared to formulation 1. FIGS. 4B-4C are images showing no emulsion issue for produced oil using formulation 39 at 10 minutes (4B) and 60 minutes (4C). FIGS. 5A-5D show results of oil recovery over time for formulation 40 (0.15:0.15:0.2 ratio of C12-14-40EO (ethoxylated) alcohol to C16-18 ethoxylated alcohol to disulfonate) compared to formulation 1. FIGS. 5B-5D are images showing no emulsion issue for produced oil using formulation 40 at 10 minutes (SB), 60 minutes (SC), and 180 minutes (SD3). FIGS. 6A-6C show results of oil recovery over time for formulation 40 at different concentrations. FIG. 6D are images showing no emulsion issues at 30 minutes for produced oil using formulation 40. FIGS. 7A-7E show results of oil recovery over time for formulation 40 compared to formulation 1 for volatile oil. FIGS. 7C-7E are images showing no emulsion issue for produced oil using 0.3% formulation 40 at 5 minutes (7C), 30 minutes (7D), and 90 minutes (7E).

### Embodiments

1. A method for treating a subterranean formation with a fluid, comprising:
(a) combining a single-phase liquid surfactant package with an aqueous-based injection fluid to form a low interfacial tension (IFT) injection fluid having an interfacial tension (IFT) of from 0.005 to 1 with a hydrocarbon phase present in the subterranean formation; and
(b) introducing the low IFT injection fluid into the unconventional subterranean formation;
wherein the low IFT injection fluid has a maximum particle size of less than 0.1 micrometers in diameter in particle size distribution measurements performed at a temperature and salinity of the subterranean formation.

2. The method of any one of embodiments 1-2, wherein the method further comprises
(c) allowing the low interfacial tension (IFT) injection fluid to contact the wellbore, the surface structures fluidly connected to the wellbore, the equipment connected to the wellbore, and/or the subterranean formation for a period of time.

3. A method for treating scale deposit formation in a wellbore, on surface structures fluidly connected to a wellbore, on equipment connected to a wellbore, and/or in a subterranean formation, comprising:
(a) combining a single-phase liquid surfactant package with an aqueous-based injection fluid to form a low interfacial tension (IFT) injection fluid having an interfacial tension (IFT) of from 0.005 to 1 with a hydrocarbon phase present in the subterranean formation;
(b) introducing the low interfacial tension (IFT) injection fluid into the wellbore, on surface structures fluidly connected to the wellbore, on equipment connected to the wellbore, and/or in the subterranean formation; and
(c) allowing the low interfacial tension (IFT) injection fluid to contact the wellbore, the surface structures fluidly connected to the wellbore, the equipment connected to the wellbore, and/or the subterranean formation for a period of time.

4. The method of any one of embodiments 1-3, wherein the single-phase liquid surfactant package comprises at least two non-ionic surfactants and an anionic surfactant.

5. The method of embodiment 4, wherein the single-phase liquid surfactant package comprises a first non-ionic surfactant, a second non-ionic surfactant, and an anionic surfactant.

6. The method of embodiment 5, wherein the first non-ionic surfactant comprises a branched or unbranched C6-C15:PO(7-65):EO(10-65), C16-C18:PO(7-65):EO(10-65), or C19-C32:PO(7-65):EO(10-65); a cyclic C6-C60:PO(7-65):EO(10-65), or C32-C60:PO(7-65):EO(10-65), and the second non-ionic surfactant comprises a branched or unbranched C6-C32:EO(8-65), C6-C32:EO(20-30), C6-C32:EO(20-25), C10-C25:EO(20-25), C9-C22:EO(8-65), C12-C14:EO(8-65), or C14-C22:EO(15-25).

7. The method of embodiment 5 or embodiment 6, wherein the anionic surfactant comprises a disulfonate, sulfosuccinate, or any combination thereof.

8. The method of any one of embodiments 3-7, wherein the scale deposit comprises an asphaltene precipitate.

9. The method of any one of embodiments 3-8, wherein the scale deposit comprises a paraffin.

10. The method of any of embodiments 3-9, wherein the method further comprises injecting an aqueous solution into the wellbore, on surface structures fluidly connected to the wellbore, on equipment connected to the wellbore, and/or in the subterranean formation to remove the scale after the allowing step.

11. The method of any one of embodiments 3-10, wherein the method further comprises ceasing introduction of the low interfacial tension (IFT) fluid into the wellbore, on surface structures fluidly connected to the wellbore, on equipment connected to the wellbore, and/or in the subterranean formations before the allowing step.

12. The method of any one of embodiments 2-11, wherein the method further comprises:
(d) producing fluids from the subterranean formation through the wellbore.

13. The method of any one of embodiments 1-12, wherein the subterranean formation comprises an asphaltene concentration of from 1.5% to 3%.

14. The method of embodiment 13, wherein the subterranean formation comprises a scale deposit.

15. The method of embodiment 14, wherein the scale deposit comprises an asphaltene precipitate.

16. The method of any one of embodiments 14-15, wherein the scale deposit comprises a paraffin.

17. The method of any one of embodiments 1-16, wherein the introduction of the low interfacial tension (IFT) fluid stimulates the subterranean formation.

18. The method of any one of embodiments 1-17, wherein the introduction of the low interfacial tension (IFT) fluid removes scale and allows for release of hydrocarbons from pores in a rock matrix.

19. The method of any one of embodiments 2-18, wherein the period of time is from one day to six months, such as from two weeks to one month.

20. The method of any one of embodiments 3-19, wherein the low interfacial tension (IFT) fluid has a maximum particle size of less than 0.1 micrometers in diameter in particle size distribution measurements performed at a temperature and salinity of the subterranean formation.

21. The method of any one of embodiments 3-19, wherein the low interfacial tension (IFT) fluid has a particle size of greater than 0.1 micrometers in diameter in particle size distribution measurements performed at a temperature and salinity of the subterranean formation.

22. The method of any one of embodiments 1-21, wherein the interfacial tension of the low interfacial tension (IFT) fluid is from about 0.01 to about 1 with a hydrocarbon phase present in the subterranean formation.

23. The method of any one of embodiments 1-21, wherein the interfacial tension of the low interfacial tension (IFT) fluid is from 0.005 to 0.1 with a hydrocarbon phase present in the subterranean formation.

24. The method of any one of embodiments 1-21, wherein the interfacial tension of the low interfacial tension (IFT) fluid is from 0.01 to 0.1 (e.g., 0.01 to 0.05) with a hydrocarbon phase present in the subterranean formation.

25. The method of any one of embodiments 1-24, wherein the low interfacial tension (IFT) fluid further comprises a paraffin inhibitor.

26. The method of any one of embodiments 1-25, wherein the low interfacial tension (IFT) fluid further comprises an asphaltene inhibitor.

27. The method of any one of embodiments 1-26, wherein the subterranean formation is an unconventional subterranean formation.

28. The method of any one of embodiments 1-27, wherein the subterranean formation is a conventional subterranean formation.

29. The method of any one of embodiments 1-28, wherein the low interfacial tension (IFT) fluid further comprises a proppant.

30. The method of any of embodiments 1-29, wherein the non-ionic surfactant and anionic surfactant are present in a ratio of non-ionic surfactant to anionic surfactant of from 1:1 to 2:1 (e.g., from 1:1 to 1:4, from 1:1 to 1:3, from 1:1 to 2:3, from 1:1 to 3:2, or 3:2 to 2:1).

31. The method of any of embodiments 1-30, wherein the first non-ionic surfactant and the second non-ionic surfactant are present in a ratio of first non-ionic surfactant to second non-ionic surfactant of from 4:1 to 1:2 (e.g., from 4:1 to 3:1, from 4:1 to 2:1, from 4:1 to 3:2, from 4:1 to 1:1, from 3:1 to 1:2, from 3:1 to 1:1, from 3:1 to 3:2, from 3:1 to 2:1, from 2:1 to 1:2, from 2:1 to 1:1, or from 1:2 to 1:1).

32. The method of any of embodiments 1-31, wherein the anionic surfactant and the first non-ionic surfactant are present in a ratio of anionic surfactant to first non-ionic surfactant of from 1.3:1 to 2:1 (e.g., from 1.3:1 to 3:2, or from 3:2 to 2:1).

33. The method of any of embodiments 1-32, the low interfacial tension (IFT) fluid comprises sea water, brackish water, flowback or produced water, wastewater (e.g., reclaimed or recycled), river water, brine (e.g., reservoir or synthetic brine), fresh water (e.g., fresh water comprises <1,000 ppm TDS water), or any combination thereof.

34. The method of any of embodiments 1-33, wherein the non-ionic surfactant has a concentration within the low interfacial tension (IFT) fluid of from 0.015% to 1% by weight, based on the total weight of the low interfacial tension (IFT) fluid.

35. The method of any of embodiments 1-34, wherein the anionic surfactant has a concentration within the low interfacial tension (IFT) fluid of from 0.005% to 1% by weight by weight, based on the total weight of the low interfacial tension (IFT) fluid.

36. The method of any of embodiments 1-35, wherein the single-phase liquid surfactant package further comprises one or more secondary surfactants.

37. The method of embodiment 36, wherein the one or more secondary surfactants comprise an anionic, a non-ionic surfactant, a cationic surfactant, a zwitterionic surfactant, or any combination thereof.

38. The method of embodiment 37, wherein the one or more secondary surfactants comprise a non-ionic surfactant.

39. The method of any of embodiments 37-38, wherein the non-ionic surfactant comprises a branched or unbranched C6-C32:PO(0-65):EO(0-100), a branched or unbranched C6-C32:PO(30-40):EO(25-35), a branched or unbranched C6-C12:PO(30-40):EO(25-35), a branched or unbranched C6-C32:EO(8-30), or any combination thereof.

40. The method of embodiment 36, wherein the one or more secondary surfactants comprise an anionic surfactant.

41. The method of embodiment 40, wherein the anionic surfactant comprises a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof.

42. The method of any of embodiments 40-41, wherein the anionic surfactant comprises a branched or unbranched C6-C32:PO(0-65):EO(0-100)-carboxylate, a branched or unbranched C6-C32:PO(30-40):EO(25-35)-carboxylate, a branched or unbranched C6-C12: PO(30-40):EO(25-35)-carboxylate, C6-C32:PO(0-65):EO(0-100)-sulfate, C6-C32:PO(0-65):EO(0-100)-disulfate, C6-C32:PO(0-65):EO(0-100)-sulfonate, C6-C32:PO(0-65):EO(0-100)-disulfonate, C6-C32:PO(0-65):EO(0-100)-sulfosuccinate, C6-C32:PO(0-65):EO(0-100)-disulfosuccinate, a branched or unbranched C6-C32:EO(8-30)-carboxylate, or any combination thereof.

43. The method of any of embodiments 40-42, wherein the anionic surfactant comprises a surfactant defined by the formula below

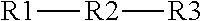

wherein
   R1 comprises a branched or unbranched, saturated or unsaturated, cyclic or non-cyclic, hydrophobic carbon chain having 6-32 carbon atoms and an oxygen atom linking R1 and R2;
   R2 comprises an alkoxylated chain comprising at least one oxide group selected from the group consisting of ethylene oxide, propylene oxide, butylene oxide, and combinations thereof, and
   R3 comprises a branched or unbranched hydrocarbon chain comprising 2-12 carbon atoms and from 2 to 5 carboxylate groups.

44. The method of any of embodiments 40-43, wherein the anionic surfactant comprises a C10-C30 internal olefin sulfonate, a C8-C30 alkyl benzene sulfonate (ABS), a sulfosuccinate surfactant, or any combination thereof.

45. The method of any of embodiments 40-44, wherein the anionic surfactant comprises a surfactant defined by the formula below

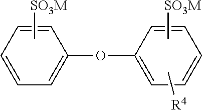

wherein
   R4 is a branched or unbranched, saturated or unsaturated, cyclic or non-cyclic, hydrophobic carbon chain having 6-32 carbon atoms; and
   M represents a counterion.

46. The method of any of embodiments 36-45, wherein the one or more secondary surfactants comprise from 10% to 90% by weight of the single-phase liquid surfactant package.

47. The method of any of embodiments 36-46, wherein the one or more secondary surfactants have a concentration within the low interfacial tension (IFT) fluid of less than 1%, less than 0.5%, less than 0.2%, less than 0.1%, less than 0.075%, or less than 0.05%.

48. The method of any of embodiments 36-47, wherein the one or more secondary surfactants have a concentration within the low interfacial tension (IFT) fluid of from 0.05% to 0.5% by weight, based on the total weight of the low interfacial tension (IFT) fluid.

49. The method of any of embodiments 1-48, wherein combination of the single-phase liquid surfactant package with the low interfacial tension (IFT) fluid lowers the particle size distribution of the low interfacial tension (IFT) fluid when measured at the temperature and salinity of the unconventional subterranean formation.

50. The method of any of embodiments 1-49, wherein the low interfacial tension (IFT) fluid is introduced at a wellhead pressure of from 0 PSI to 30,000 PSI.

51. The method of embodiment 50, wherein the low interfacial tension (IFT) fluid is introduced at a wellhead pressure of from 6,000 PSI to 30,000 PSI.

52. The method of any of embodiments 1-51, wherein the subterranean formation has a temperature of from 75° F. to 350° F.

53. The method of embodiment 52, wherein the subterranean formation has a temperature of from 150° F. to 250° F.

54. The method of any of embodiments 1-53, wherein the subterranean formation has a salinity of at least 5,000 ppm TDS.

55. The method of embodiment 54, wherein the subterranean formation has a salinity of from 100,000 ppm to 300,000 ppm TDS.

56. The method of any of embodiments 1-55, wherein the subterranean formation has a permeability of less than 25 mD.

57. The method of any of embodiments 1-56, wherein the mean particle size distribution of the low interfacial tension (IFT) fluid is less than an average pore size of a rock matrix in the subterranean formation.

58. The method of any of embodiments 1-57, wherein the low interfacial tension (IFT) fluid further comprises an acid, a friction reducer, a gelling agent, a crosslinker, a breaker, a pH adjusting agent, a non-emulsifier agent, an iron control agent, a corrosion inhibitor, a scale inhibitor, a biocide, a clay stabilizing agent, a proppant, or any combination thereof.

59. The method of any of embodiments 1-58, wherein the low interfacial tension (IFT) fluid further comprises a wettability alteration chemical.

60. The method of any of embodiments 1-59, wherein the single-phase liquid surfactant package further comprises one or more co-solvents.

61. The method of embodiment 60, wherein the one or more co-solvents comprise a C1-C5 alcohol, an ethoxylated C1-C5 alcohol, or any combination thereof.

62. The method of any of embodiments 1-61, wherein the mean particle size distribution of the low interfacial tension (IFT) fluid is less than 0.05 micrometer in diameter when measured at the temperature and salinity of the subterranean formation.

63. The method of any of embodiments 1-62, wherein the aqueous-based injection fluid has a mean particle size distribution of greater than 10 micrometers prior to the addition of the surfactant package.

64. The method of any of embodiments 1-63, wherein the mean particle size distribution of the low interfacial tension (IFT) fluid is at least 10 micrometers smaller than a mean particle size distribution of the aqueous-based injection fluid.

65. The method of any of embodiments 1-64, wherein the aqueous-based injection fluid comprises slickwater.

66. The method of any of embodiments 1-65, wherein the aqueous-based injection fluid comprises at least 10% acid.

67. The method of any of embodiments 1-66, wherein the aqueous-based injection fluid comprises a friction reducer, an acid, a gelling agent, a crosslinker, a breaker, a pH adjusting agent, a non-emulsifier agent, an iron control agent, a corrosion inhibitor, a scale inhibitor, a biocide, a clay stabilizing agent, a proppant, or any combination thereof.

68. The method of any of embodiments 1-67, wherein the low interfacial tension (IFT) fluid has a total surfactant concentration of from 0.01% to 1% by weight, based on the total weight of the low interfacial tension (IFT) fluid.

69. The method of any of embodiments 1-68, wherein the method comprises a hydraulic fracturing operation.

70. The method of any of embodiments 1-69, wherein the method comprises a formation stimulation operation.

71. A method for fracturing an unconventional subterranean formation with a fluid, comprising:
(a) combining a single-phase liquid surfactant package with an aqueous-based injection fluid to form a low interfacial tension (IFT) injection fluid having an interfacial tension (IFT) of from 0.005 to 1 with a hydrocarbon phase present in the subterranean formation; and
(b) injecting the low interfacial tension (IFT) injection fluid through a wellbore and into the unconventional subterranean formation at a sufficient pressure and at a sufficient rate to fracture the unconventional subterranean formation.

72. The method of embodiment 71, wherein the low interfacial tension (IFT) injection fluid further comprises a proppant.

73. The method of any of embodiments 71-72, wherein the wellbore comprises a vertical trajectory.

74. The method of any of embodiments 71-73, wherein the wellbore comprises a horizontal trajectory.

75. The method of any of embodiments 71-74, wherein method comprises performing a fracturing operation on a region of the unconventional subterranean formation proximate to a new wellbore.

76. The method of any of embodiments 71-74, wherein method comprises performing a fracturing operation on a region of the unconventional subterranean formation proximate to an existing wellbore.

77. The method of any of embodiments 71-74, wherein the method comprises performing a refracturing operation on a previously fractured region of the unconventional subterranean formation proximate to a new wellbore.

78. The method of any of embodiments 71-74, wherein the method comprises performing a refracturing operation on a previously fractured region of the unconventional subterranean formation proximate to an existing wellbore.

79. The method of any of embodiments 71-74, wherein method comprises performing a fracturing operation on a naturally fractured region of the unconventional subterranean formation proximate to a new wellbore.

80. The method of any of embodiments 71-74, wherein method comprises performing a fracturing operation on a naturally fractured region of the unconventional subterranean formation proximate to an existing wellbore.

81. The method of any of embodiments 71-80, wherein the low interfacial tension (IFT) injection fluid has a total surfactant concentration of from 0.01% to 1% by weight, based on the total weight of the low interfacial tension fluid.

82. The method of any of embodiments 71-81, wherein the method further comprises producing fluids from the unconventional subterranean formation through the wellbore.

83. The method of embodiment 82, wherein the fluids comprise a hydrocarbon.

84. The method of any of embodiments 71-83, wherein the method further comprises: adding a tracer to the low interfacial tension (IFT) injection fluid prior to introducing the low interfacial tension (IFT) injection fluid through the wellbore into the unconventional subterranean formation;
recovering the tracer from the fluids produced from the unconventional subterranean formation through the wellbore, fluids recovered from a different wellbore in fluid communication with the unconventional subterranean formation, or any combination thereof, and
comparing the quantity of tracer recovered from the fluids produced to the quantity of tracer introduced to the low interfacial tension (IFT) injection fluid.

85. The method of any one of embodiments 71-84, wherein the single-phase liquid surfactant package comprises at least two non-ionic surfactants and an anionic surfactant.

86. The method of embodiment 85, wherein the single-phase liquid surfactant package comprises a first non-ionic surfactant, a second non-ionic surfactant, and an anionic surfactant.

87. The method of embodiment 86, wherein the first non-ionic surfactant comprises a branched or unbranched C6-C15:PO(7-65):EO(10-65), C16-C18:PO(7-65):EO(10-65), or C19-C32:PO(7-65):EO(10-65); a cyclic C6-C60:PO(7-65):EO(10-65), or C32-C60:PO(7-65):EO(10-65), and the second non-ionic surfactant comprises a branched or unbranched C6-C32:EO(8-65), C6-C32:EO(20-30), C6-C32:EO(20-25), C10-C25:EO(20-25), C9-C22:EO(8-65), C12-C14:EO(8-65), or C14-C22:EO(15-25).

88. The method of embodiment 86 or embodiment 87, wherein the anionic surfactant comprises a disulfonate, sulfosuccinate, or any combination thereof.

89. The method of any of embodiments 71-88, wherein the non-ionic surfactant and anionic surfactant are present in a ratio of non-ionic surfactant to anionic surfactant of from 1:1 to 2:1 (e.g., from 1:1 to 1:4, from 1:1 to 1:3, from 1:1 to 2:3, from 1:1 to 3:2, or 3:2 to 2:1).

90. The method of any of embodiments 71-89, wherein the first non-ionic surfactant and the second non-ionic surfactant are present in a ratio of first non-ionic surfactant to second non-ionic surfactant of from 4:1 to 1:2 (e.g., from 4:1 to 3:1, from 4:1 to 2:1, from 4:1 to 3:2, from 4:1 to 1:1, from 3:1 to 1:2, from 3:1 to 1:1, from 3:1 to 3:2, from 3:1 to 2:1, from 2:1 to 1:2, from 2:1 to 1:1, or from 1:2 to 1:1).

91. The method of any of embodiments 71-90, wherein the anionic surfactant and the first non-ionic surfactant are present in a ratio of anionic surfactant to first non-ionic surfactant of from 1.3:1 to 2:1 (e.g., from 1.3:1 to 3:2, or from 3:2 to 2:1).

92. The method of any one of embodiments 71-91, wherein the interfacial tension of the low interfacial tension (IFT) fluid is from 0.005 to 1 with a hydrocarbon phase present in the subterranean formation.

93. The method of any one of embodiments 71-91, wherein the interfacial tension of the low interfacial tension (IFT) fluid is from 0.005 to 0.1 with a hydrocarbon phase present in the subterranean formation.

94. The method of any one of embodiments 71-91, wherein the interfacial tension of the low interfacial tension (IFT) fluid is from 0.01 to 0.1 (e.g., 0.01 to 0.05) with a hydrocarbon phase present in the subterranean formation.

95. A method for treating a subterranean formation with a fluid, comprising:
(a) combining a single-phase liquid surfactant package with an aqueous-based injection fluid to form a low interfacial tension (IFT) injection fluid having an interfacial tension (IFT) of from 0.005 to 1 with a hydrocarbon phase present in the subterranean formation; and
(b) introducing the low IFT injection fluid into the unconventional subterranean formation; wherein the single-phase liquid surfactant comprises a first nonionic surfactant comprising C24-C32:PO(20-40):EO(20-35), a second nonionic surfactant comprising C9-C22:EO(8-45), and an anionic surfactant.

96. The method of embodiment 95, wherein the anionic surfactant comprises a disulfide.

97. The method of any one of embodiments 95-96, wherein the interfacial tension of the low interfacial tension (IFT) fluid is from 0.005 to 1 with a hydrocarbon phase present in the subterranean formation.

98. The method of any one of embodiments 95-96, wherein the interfacial tension of the low interfacial tension (IFT) fluid is from 0.005 to 0.1 with a hydrocarbon phase present in the subterranean formation.

99. The method of any one of embodiments 95-96, wherein the interfacial tension of the low interfacial tension (IFT) fluid is from 0.01 to 0.1 (e.g., 0.01 to 0.05) with a hydrocarbon phase present in the subterranean formation.

100. The method of any of embodiments 95-99, wherein the non-ionic surfactant and anionic surfactant are present in a ratio of non-ionic surfactant to anionic surfactant of from 1:1 to 2:1 (e.g., from 1:1 to 1:4, from 1:1 to 1:3, from 1:1 to 2:3, from 1:1 to 3:2, or 3:2 to 2:1).

101. The method of any of embodiments 95-100, wherein the first non-ionic surfactant and the second non-ionic surfactant are present in a ratio of first non-ionic surfactant to second non-ionic surfactant of from 4:1 to 1:2 (e.g., from 4:1 to 3:1, from 4:1 to 2:1, from 4:1 to 3:2, from 4:1 to 1:1, from 3:1 to 1:2, from 3:1 to 1:1, from 3:1 to 3:2, from 3:1 to 2:1, from 2:1 to 1:2, from 2:1 to 1:1, or from 1:2 to 1:1).

102. The method of any of embodiments 95-101, wherein the anionic surfactant and the first non-ionic surfactant are present in a ratio of anionic surfactant to first non-ionic surfactant of from 1.3:1 to 2:1 (e.g., from 1.3:1 to 3:2, or from 3:2 to 2:1).

In some embodiments, one or more surfactants may be employed herein that have the formula C12-C14:PO(7-65):EO(7-65). Such surfactants may be employed with or without an additional surfactant. In some embodiments, one or more additional surfactants could be employed such as an anionic surfactant as described herein. In some embodiments, one or more additional surfactants could be employed such as a non-ionic surfactant as described herein. In some embodiments, a surfactant with the formula C12-C14:PO(7-65):EO(7-65) may be used with or without one or more sulfonates, one or more disulfonates, and/or one or more sulfosuccinates. In some embodiments, a surfactant with the formula C12-C14:PO(7-65):EO(7-65) may be used with a non-ionic surfactant such as C9-C15:EO(7-65), C16-C18:PO(0-65):EO(7-65), and/or a Guerbet C10-C32:PO(0-65):EO(7-65), and/or may also be employed with one or more anionic surfactants.

In some embodiments, one or more surfactants may be employed herein that have the formula C16-C18:PO(7-65):EO(7-65). Such surfactants may be employed with or without an additional surfactant. In some embodiments, one or more additional surfactants could be employed such as an anionic surfactant as described herein. In some embodiments, one or more additional surfactants could be employed such as a non-ionic surfactant as described herein. In some embodiments, a surfactant with the formula C16-C18:PO(7-65):EO(7-65) may be used with or without one or more sulfonates, one or more disulfonates, and/or one or more sulfosuccinates. In some embodiments, a surfactant with the formula C16-C18:PO(7-65):EO(7-65) may be used with a non-ionic surfactant such as C9-C15:EO(7-65), C12-C14:PO(0-65):EO(7-65), and/or a Guerbet C10-C32:PO(0-65):EO(7-65), and/or may also be employed with one or more anionic surfactants.

In some embodiments, one or more surfactants may be employed herein that have the formula Guerbet C24:PO(7-65):EO(7-65). Such surfactants may be employed with or without an additional surfactant. In some embodiments, one or more additional surfactants could be employed such as an anionic surfactant as described herein. In some embodiments, one or more additional surfactants could be employed such as a non-ionic surfactant as described herein. In some embodiments, a surfactant with the formula Guerbet C24:PO(7-65):EO(7-65) may be used with or without one or more sulfonates, one or more disulfonates, and/or one or more sulfosuccinates. In some embodiments, a surfactant with the formula Guerbet C24:PO(7-65):EO(7-65) may be used with a non-ionic surfactant such as C9-C15:EO(7-65), C12-C14:PO(0-65):EO(7-65), and/or a Guerbet C10-C32:PO(0-65):EO(7-65), and/or may also be employed with one or more anionic surfactants.

In some embodiments, one or more surfactants may be employed herein that have the formula Guerbet C28:PO(7-65):EO(7-65). Such surfactants may be employed with or without an additional surfactant. In some embodiments, one or more additional surfactants could be employed such as an anionic surfactant as described herein. In some embodiments, one or more additional surfactants could be employed such as a non-ionic surfactant as described herein. In some embodiments, a surfactant with the formula Guerbet C28:PO(7-65):EO(7-65) may be used with or without one or more sulfonates, one or more disulfonates, and/or one or more sulfosuccinates. In some embodiments, a surfactant with the formula Guerbet C28:PO(7-65):EO(7-65) may be used with a non-ionic surfactant such as C9-C15:EO(7-65), C12-C14:PO(0-65):EO(7-65), and/or a Guerbet C10-C32:PO(0-65):EO(7-65), and/or may also be employed with one or more anionic surfactants.

In some embodiments, one or more surfactants may be employed herein that have the formula Guerbet C10-C20:PO(7-65):EO(7-65). Such surfactants may be employed with or without an additional surfactant. In some embodiments, one or more additional surfactants could be employed such as an anionic surfactant as described herein. In some embodiments, one or more additional surfactants could be employed such as a non-ionic surfactant as described herein. In some embodiments, a surfactant with the formula Guerbet C10-C20:PO(7-65):EO(7-65) may be used with or without one or more sulfonates, one or more disulfonates, and/or one or more sulfosuccinates. In some embodiments, a surfactant with the formula Guerbet C10-C20:PO(7-65):EO(7-65) may be used with a non-ionic surfactant such as C9-C15:EO(7-65), C12-C14:PO(0-65):EO(7-65), and/or a Guerbet C10-C32:PO(0-65):EO(7-65), and/or may also be employed with one or more anionic surfactants.

In some embodiments one or more surfactants may be employed herein such as those described in WO2025049901A1 entitled “STYRYL PHENOL-BASED SURFACTANTS FOR HYDROCARBON RECOVERY” which is incorporated herein by reference. Suitable surfactants include, for example, compounds of Formula I or salt thereof:

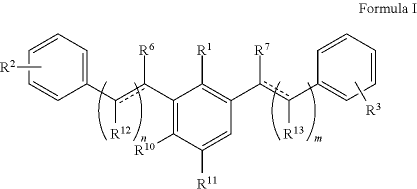

wherein:
R¹ is —OH, —OSO₃, -(PO)ₓ-(EO)_{y}-A, -(BO)_{z}-(PO)ₓ-(EO)_{y}-A, —OR¹⁶, or

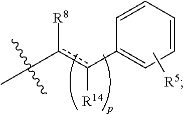

R²-R⁵ are each independently H or —SO₃;
R⁶-R⁹ and R¹²-R¹⁵ are each independently H, —OH, —SO₃, or C₁-C₆ alkyl;
R¹⁰ is H, -(PO)ₓ-(EO)_{y}-A, or -(BO)_{z}-(PO)ₓ-(EO)_{y}-A;
R¹¹ is H or

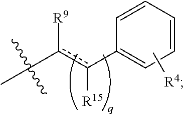

A is —OH;
R¹⁶ is alkene (e.g., —CH═CH₂), C₁-C₃₂ alkyl,

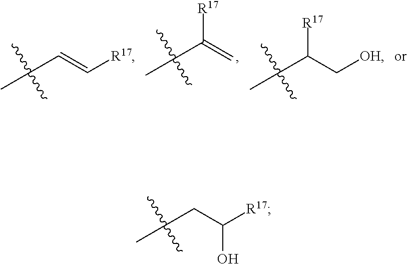

R¹⁷ is H, C₁-C₃₂ alkyl, alkenyl, aryl, -(PO)ₓ-(EO)_{y}-A, or -(BO)_{z}(PO)ₓ-(EO)_{y}-A;
BO represents —CH₂—CH(ethyl)-O—;
EO represents —CH₂—CH₂—O—;
PO represents —CH₂—CH(methyl)-O—;
x is 0 to 65;
y is 0 to 100;
z is 0 to 10;
n, m, p, and q are each independently 0 to 6;
the dotted line represents an optional double bond if valence permits;
at least two of R¹-R⁹, R¹²-R¹⁷ or A are independently —SO₃; and
wherein when:
R¹ is

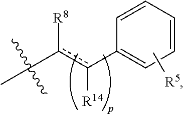

then R¹¹ is H;
R¹¹ is

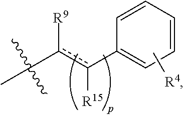

then R¹ is H;
one of R⁶ or R¹² is —SO₃, then one of R⁶ or R¹² is H, —OH, or C₁-C₆ alkyl;
one of R⁶ or R¹² is —OH, then one of R⁶ or R¹² is H, —SO₃ or C₁-C₆ alkyl;
one of R⁸ or R¹⁴ is —SO₃, then one of R⁸ or R¹⁴ is H, —OH, or C₁-C₆ alkyl;
one of R⁸ or R¹⁴ is —OH, then one of R⁸ or R¹⁴ is H, —SO₃ or C₁-C₆ alkyl;
one of R⁷ or R¹³ is —SO₃, then one of R⁷ or R¹³ is H, —OH, or C₁-C₆ alkyl;
one of R⁷ or R¹³ is —OH, then one of R⁷ or R¹³ is H, —SO₃ or C₁-C₆ alkyl;
one of R⁹ or R¹⁵ is —SO₃, then one of R⁹ or R¹⁵ is H, —OH, or C₁-C₆ alkyl; and
one of R⁹ or R¹⁵ is —OH, then one of R⁹ or R¹⁵ is H, —SO₃ or C₁-C₆ alkyl.

Also described herein are compounds of Formula II or salt thereof:

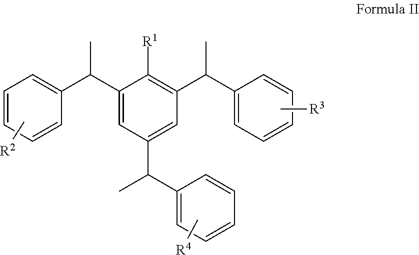

wherein:
R¹ is —OH, —OSO₃, -(PO)ₓ-(EO)_{y}-A, -(BO)_{z}-(PO)ₓ-(EO)_{y}-A, or —OR¹⁶;
R²-R⁴ are each independently H or —SO₃;
A is —OH;
R¹⁶ is alkene (e.g., —CH═CH₂), C₁-C₃₂ alkyl,

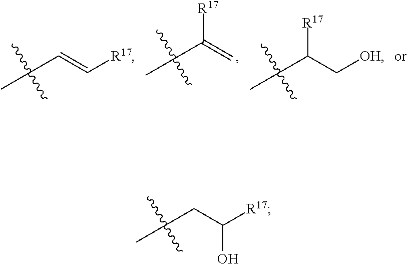

R¹⁷ is H, C₁-C₃₂ alkyl, alkenyl, aryl, -(PO)ₓ-(EO)_{y}-A, or -(BO)_{z}(PO)ₓ-(EO)_{y}-A;
EO represents —CH₂—CH₂—O—;
PO represents —CH₂—CH(methyl)-O—;
BO represents —CH₂—CH(ethyl)-O—;
x is 0 to 65;
y is 0 to 100;
z is 0 to 10; and
at least two of R¹-R⁴, R¹⁶, R¹⁷, or A are independently —SO₃.

Also described herein are compounds of Formula III or salt thereof:

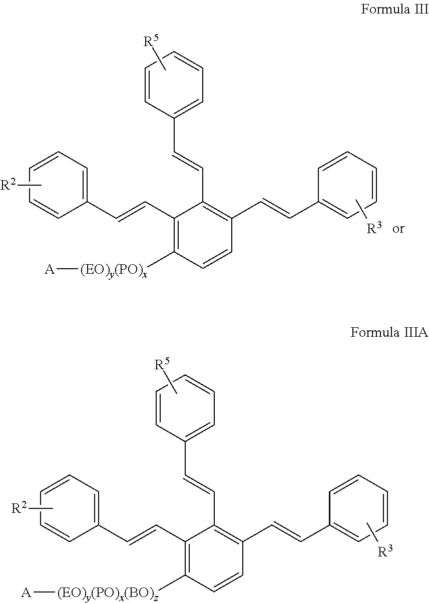

wherein:
R², R³, and R⁵ are each independently H or —SO₃;
A is —OH;
R¹⁶ is alkene (e.g., —CH═CH₂), C₁-C₃₂ alkyl,

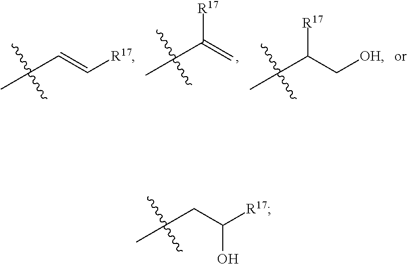

R¹⁷ is H, C₁-C₃₂ alkyl, alkenyl, aryl, -(PO)ₓ-(EO)_{y}-A, or -(BO)_{z}(PO)ₓ-(EO)_{y}-A;
EO represents —CH₂—CH₂—O—;
PO represents —CH₂—CH(methyl)-O—;
BO represents —CH₂—CH(ethyl)-O—;
x is 0 to 65;
y is 0 to 100;
z is 0 to 10; and
at least two of R², R³, R⁵, R¹⁶, R¹⁷, or A are independently —SO₃.

Also described herein are compounds of Formula IV or salt thereof:

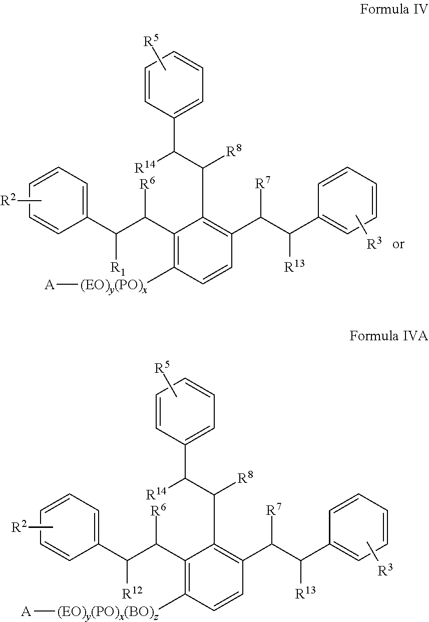

wherein:
R², R³, and R⁵ are each independently H or —SO₃;
R⁶-R⁸, and R¹²-R¹⁴ are each independently H, —OH, —SO₃, or C₁-C₆ alkyl;
A is —OH;
R¹⁶ is alkene (e.g., —CH═CH₂), C₁-C₃₂ alkyl,

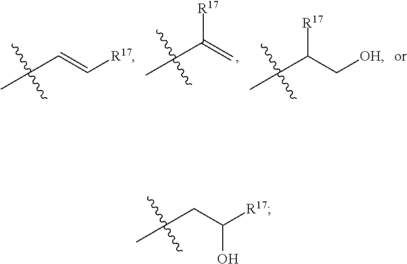

R¹⁷ is H, C₁-C₃₂ alkyl, alkenyl, aryl, -(PO)ₓ-(EO)_{y}-A, or -(BO)_{z}(PO)ₓ-(EO)_{y}-A;
EO represents —CH₂—CH₂—O—;
PO represents —CH₂—CH(methyl)-O—;
BO represents —CH₂—CH(ethyl)-O—;
x is 0 to 65;
y is 0 to 100;
z is 0 to 10; and
at least two of R¹, R³, R⁵-R⁸, R¹²-R¹⁴, R¹⁶, R¹⁷, or A are independently —SO₃;
wherein when:
one of R⁶ or R¹² is —SO₃, then one of R⁶ or R¹² is H, —OH, or C₁-C₆ alkyl;
one of R⁶ or R¹² is —OH, then one of R⁶ or R¹² is H, —SO₃ or C₁-C₆ alkyl;
one of R⁸ or R¹⁴ is —SO₃, then one of R⁸ or R¹⁴ is H, —OH, or C₁-C₆ alkyl;
one of R⁸ or R¹⁴ is —OH, then one of R⁸ or R¹⁴ is H, —SO₃ or C₁-C₆ alkyl;
one of R⁷ or R¹³ is —SO₃, then one of R⁷ or R¹³ is H, —OH, or C₁-C₆ alkyl; and
one of R⁷ or R¹³ is —OH, then one of R⁷ or R¹³ is H, —SO₃ or C₁-C₆ alkyl.

Also described herein are compounds of Formula V or salt thereof:

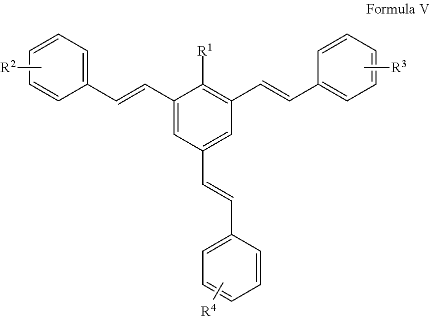

wherein:
R¹ is —OH, —OSO₃, -(PO)ₓ-(EO)_{y}-A, -(BO)_{z}-(PO)ₓ-(EO)_{y}-A, or —OR¹⁶;
R²-R⁴ are each independently H or —SO₃;
A is —OH;
R¹⁶ is alkene (e.g., —CH═CH₂), C₁-C₃₂ alkyl,

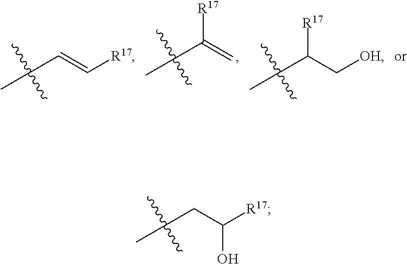

R¹⁷ is H, C₁-C₃₂ alkyl, alkenyl, aryl, -(PO)ₓ-(EO)_{y}-A, or -(BO)_{z}(PO)ₓ-(EO)_{y}-A;
EO represents —CH₂—CH₂—O—;
PO represents —CH₂—CH(methyl)-O—;
BO represents —CH₂—CH(ethyl)-O—;
x is 0 to 65;
y is 0 to 100;
z is 0 to 10; and
at least two of R¹-R⁴, R¹⁶, R¹⁷, or A are independently —SO₃.

Also described herein are compounds of Formula VI or salt thereof:

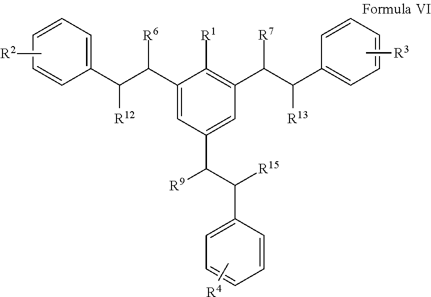

wherein:
R¹ is —OH, —OSO₃, -(PO)ₓ-(EO)_{y}-A, -(BO)_{z}-(PO)ₓ-(EO)_{y}-A, or —OR¹⁶;
R²-R⁴ are each independently H or —SO₃;
R⁶, R⁷, R⁹, and R¹², R¹³, R¹⁵ are each independently H, —OH, —SO₃, or C₁-C₆ alkyl;
A is —OH;
R¹⁶ is alkene (e.g., —CH═CH₂), C₁-C₃₂ alkyl,

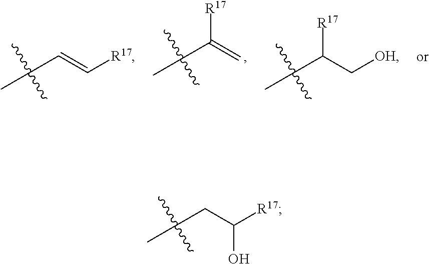

R¹⁷ is H, C₁-C₃₂ alkyl, alkenyl, aryl, -(PO)_{z}-(EO)_{y}-A,
EO represents —CH₂—CH₂—O—;
PO represents —CH₂—CH(methyl)-O—;
BO represents —CH₂—CH(ethyl)-O—;
x is to 65;
y is 0 to 100;
z is 0 to 10; and
at least two of R¹-R⁴, R⁶, R⁷, R⁹, R¹², R¹³, R¹⁵-R¹⁷ or A are independently —SO₃;
wherein when:
one of R⁶ or R¹² is —SO₃, then one of R⁶ or R¹² is H, —OH, or C₁-C₆ alkyl;
one of R⁶ or R¹² is —OH, then one of R⁶ or R¹² is H, —SO₃ or C₁-C₆ alkyl;
one of a R⁹ or R¹⁵ is —SO₃,then one ofR⁹ or R¹⁵ is H, —OH, or C₁-C₆ alkyl;
one of R⁹ or R¹⁵ is —OH, then one ofR⁹ or R¹⁵ is H, —S₃ or C₁-C₆ alkyl;
one of R⁷ or R¹³ is —SO₃, then one of R⁷ or R¹³ is H, —OH, or C₁-C₆ alkyl; and
one of R⁷ or R¹³ is —OH, then one of R⁷ or R¹³ is H, —SO₃ or C₁-C₆ alkyl.

Also described herein are compounds of Formula VII or salt thereof:

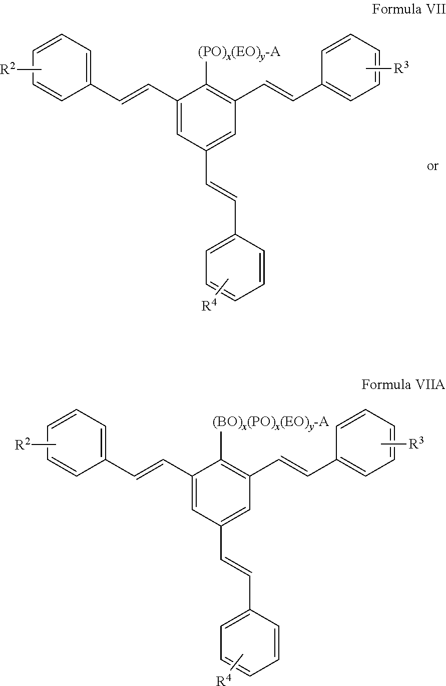

wherein:
R²-R⁴ are each independently H or —SO₃;
A is —OH;
R¹⁶ is alkene (e.g., —CH═CH₂), C₁-C₃₂ alkyl,

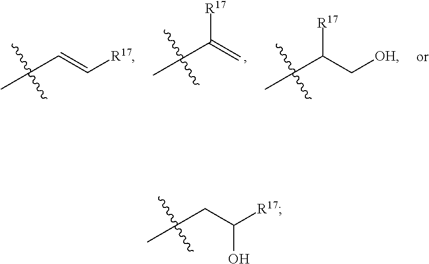

R¹⁷ is H, C₁-C₃₂ alkyl, alkenyl, aryl, -(PO)ₓ-(EO)_{y}-A, or -(BO)_{z}(PO)ₓ-(EO)_{y}-A;
EO represents —CH₂—CH₂—O—;
PO represents —CH₂—CH(methyl)-O—;
BO represents —CH₂—CH(ethyl)-O—;
x is 0 to 65;
y is 0 to 100;
z is 0 to 10; and
at least two of R²-R⁴, R¹⁶, R¹⁷, or A are independently —SO₃.

Also described herein are compounds of Formula VIII or salt thereof:

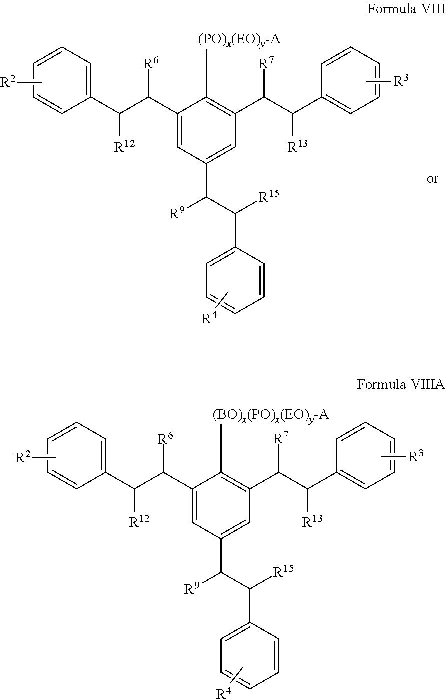

wherein:
R²-R⁴ are each independently H or —SO₃;
R⁶, R⁷, R⁹, and R¹², R¹³, R¹⁵ are each independently H, —OH, —SO₃, or C₁-C₆ alkyl;
A is —OH;
R¹⁶ is alkene (e.g., —CH═CH₂), C₁-C₃₂ alkyl,

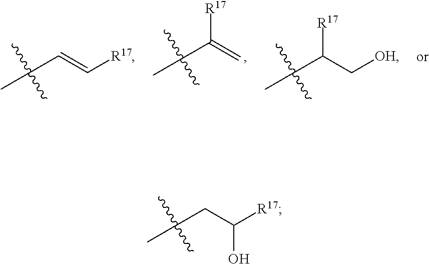

R¹⁷ is H, C₁-C₃₂ alkyl, alkenyl, aryl, -(PO)ₓ-(EO)_{y}-A, or -(BO)_{z}(PO)ₓ-(EO)_{y}-A;
EO represents —CH₂—CH₂—O—;
PO represents —CH₂—CH(methyl)-O—;
BO represents —CH₂—CH(ethyl)-O—;
x is 0 to 65;
y is 0 to 100;
z is 0 to 10; and
at least two of R²-R⁴, R⁶, R⁷, R⁹, R¹², R¹³, R¹⁵-R¹⁷ or A are independently —SO₃;
wherein when:
one of R⁶ or R¹² is —SO₃, then one of R⁶ or R¹² is H, —OH, or C₁-C₆ alkyl;
one of R⁶ or R¹² is —OH, then one of R⁶ or R¹² is H, —SO₃ or C₁-C₆ alkyl;
one of R⁹ or R¹⁵ is —SO₃, then one of R⁹ or R¹⁵ is H, —OH, or C₁-C₆ alkyl;
one of R⁹ or R¹⁵ is —OH, then one of R⁹ or R¹⁵ is H, —SO₃ or C₁-C₆ alkyl;
one of R⁷ or R¹³ is —SO₃, then one of R⁷ or R¹³ is H, —OH, or C₁-C₆ alkyl; and
one of R⁷ or R¹³ is —OH, then one of R⁷ or R¹³ is H, —SO₃ or C₁-C₆ alkyl.

Also described herein are compounds of Formula IX or salt thereof, Formula IXA or salt thereof, Formula IXB or salt thereof, Formula IXC or salt thereof, or Formula IXD or salt thereof:

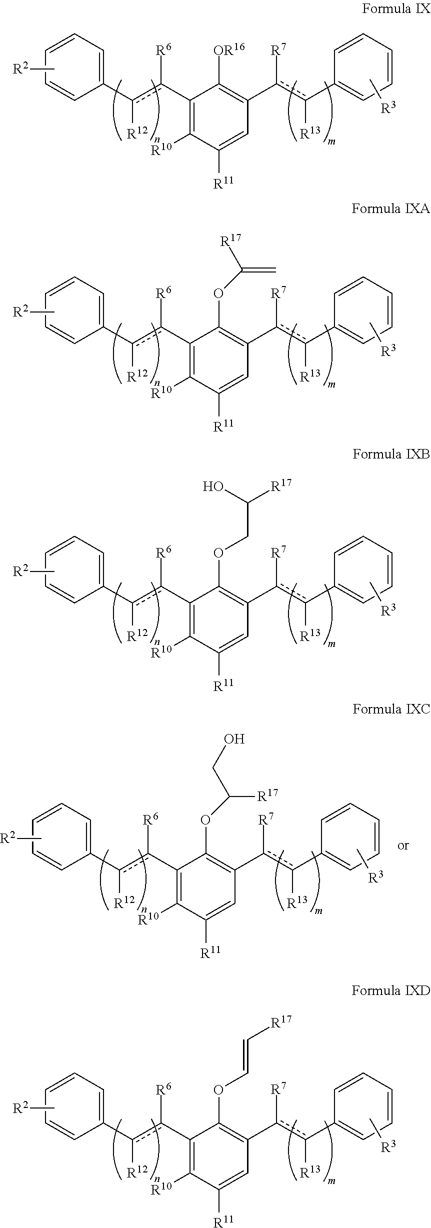

wherein:
R²-R⁴ are each independently H or —SO₃;
R⁶, R⁷, R⁹ and R¹², R¹³, R¹⁵ are each independently H, —OH, —SO₃, or C₁-C₆ alkyl;
R¹⁰ is H, -(PO)ₓ-(EO)_{y}-A, or -(BO)_{z}-(PO)ₓ-(EO)_{y}-A;
R¹¹ is H or

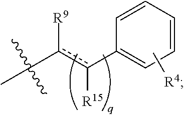

A is —OH;
R¹⁶ is alkene (e.g., —CH═CH₂), C₁-C₃₂ alkyl,

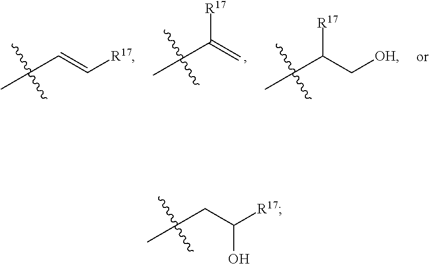

R¹⁷ is H, C₁-C₃₂ alkyl, alkenyl, aryl, -(PO)ₓ-(EO)_{y}-A, or -(BO)_{z}(PO)ₓ-(EO)_{y}-A;
BO represents —CH₂—CH(ethyl)-O—;
EO represents —CH₂—CH₂—O—;
PO represents —CH₂—CH(methyl)-O—;
x is 0 to 65;
y is 0 to 100;
z is 0 to 10;
n, m, and q are each independently 0 to 6;
the dotted line represents an optional double bond if valence permits;
at least two of R²-R⁷, R⁹, R¹²-R¹³, R¹⁵-R¹⁷, or A are independently —SO₃; and
wherein when:
one of R⁶ or R¹² is —SO₃, then one of R⁶ or R¹² is H, —OH, or C₁-C₆ alkyl;
one of R⁶ or R¹² is —OH, then one of R⁶ or R¹² is H, —SO₃ or C₁-C₆ alkyl;
one of R⁷ or R¹³ is —SO₃, then one of R⁷ or R¹³ is H, —OH, or C₁-C₆ alkyl;
one of R⁷ or R¹³ is —OH, then one of R⁷ or R¹³ is H, —SO₃ or C₁-C₆ alkyl;
one of R⁹ or R¹⁵ is —SO₃, then one of R⁹ or R¹⁵ is H, —OH, or C₁-C₆ alkyl; and
one of R⁹ or R¹⁵ is —OH, then one of R⁹ or R¹⁵ is H, —SO₃ or C₁-C₆ alkyl.

Also described herein are compounds of Formula X or salt thereof, Formula XA or salt thereof, Formula XB or salt thereof, Formula XC or salt thereof, or Formula XD or salt thereof:

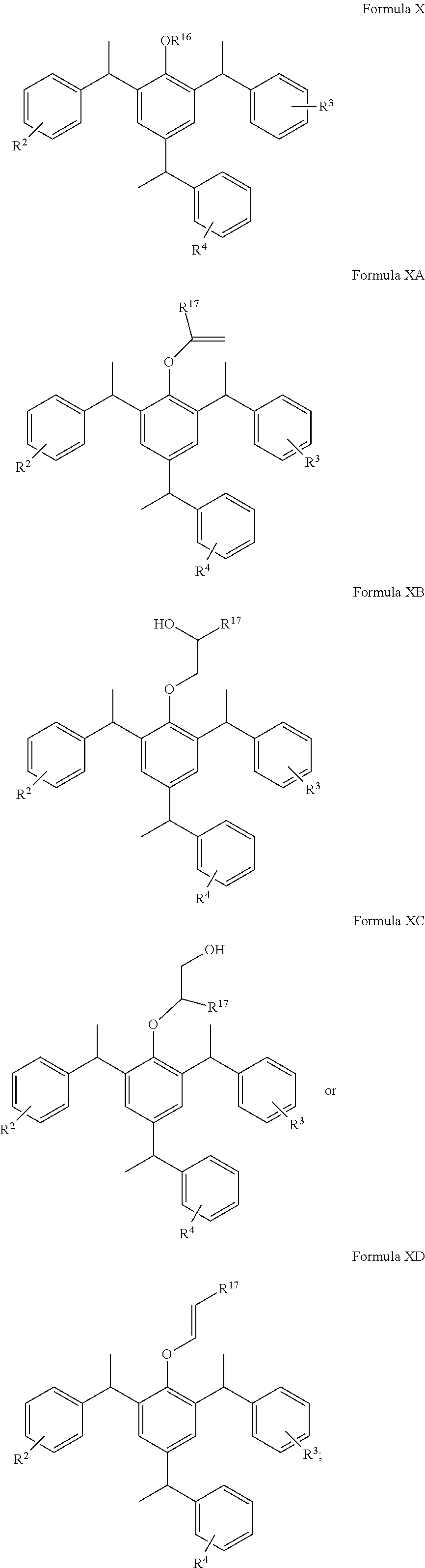

wherein.
   R²-R⁴ are each independently H or —SO₃;
   A is —OH;
   R¹⁶ is alkene (e.g., —CH═CH₂), C₁-C₃₂ alkyl,

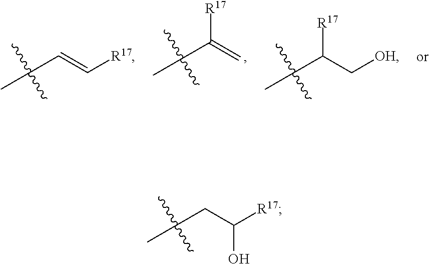

R¹⁷ is H, C₁-C₃₂ alkyl, alkenyl, aryl, -(PO)ₓ-(EO)_{y}-A, or -(BO)_{z}(PO)ₓ-(EO)_{y}-A;
EO represents —CH₂—CH₂—O—;
PO represents —CH₂—CH(methyl)-O—;
BO represents —CH₂—CH(ethyl)-O—;
x is 0 to 65;
y is 0 to 100;
z is 0 to 10; and
at least two of R²-R⁴, R¹⁶, R¹⁷, or A are independently —SO₃.

Also described herein are compounds of Formula XI or salt thereof, Formula XIA or salt thereof, Formula XIB or salt thereof, Formula XIC or salt thereof, or Formula XID or salt thereof:

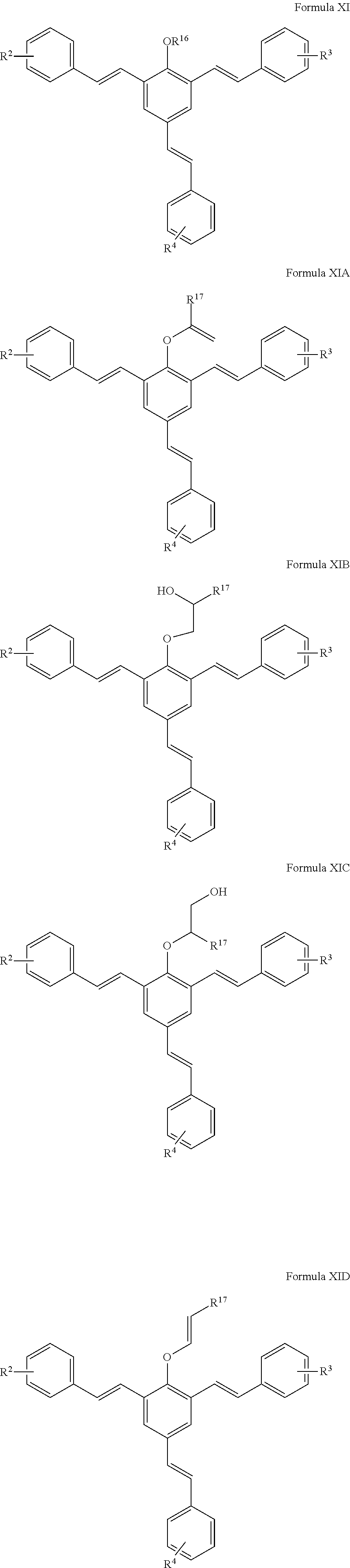

wherein:
   R²-R⁴ are each independently H or —SO₃;
   A is —OH;
   R¹⁶ is alkene (e.g., —CH═CH₂), C₁-C₃₂ alkyl,

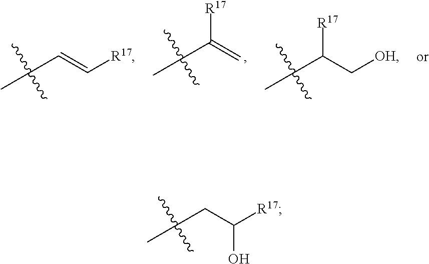

R¹⁷ is H, C₁-C₃₂ alkyl, alkenyl, aryl, -(PO)ₓ-(EO)_{y}-A, or -(BO)_{z}(PO)ₓ-(EO)_{y}-A;
EO represents —CH₂—CH₂—O—;
PO represents —CH₂—CH(methyl)-O—;
BO represents —CH₂—CH(ethyl)-O—;
x is 0 to 65;
y is 0 to 100;
z is 0 to 10; and
at least two of R²-R⁴, R¹⁶, R¹⁷, or A are independently —SO₃.

Also described herein are compounds of Formula XII or salt thereof, Formula XIIA or salt thereof, Formula XIIB or salt thereof, Formula XIIC or salt thereof, or Formula XIID or salt thereof:

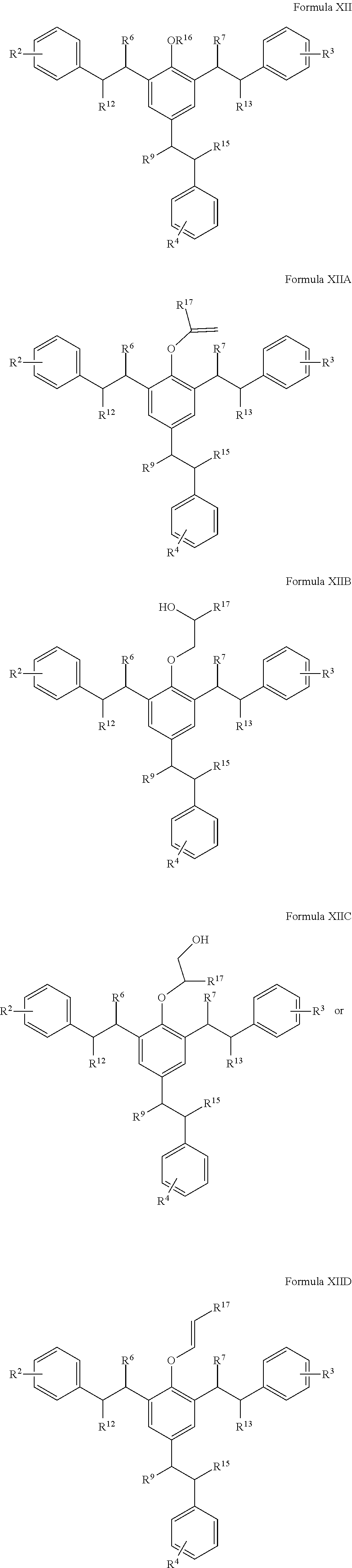

wherein.
R²-R⁴ are each independently H or —SO₃;
R⁶, R⁷, R⁹, and R¹², R¹³, R¹ are each independently H, —OH, —SO₃, or C₁-C₆ alkyl;
A is —OH;
R¹⁶ is alkene (e.g., —CH═CH₂), C₁-C₃₂ alkyl,

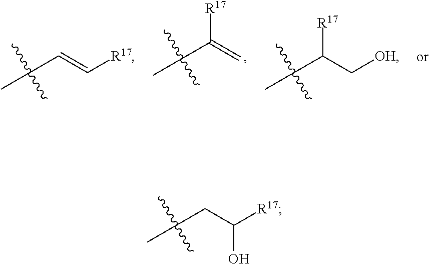

R¹⁷ is H, C₁-C₃₂ alkyl, alkenyl, aryl, -(PO)ₓ-(EO)_{y}-A, or -(BO)_{z}(PO)ₓ-(EO)_{y}-A;
EO represents —CH₂—CH₂—O—;
PO represents —CH₂—CH(methyl)-O—;
BO represents —CH₂—CH(ethyl)-O—;
x is 0 to 65;
y is 0 to 100;
z is 0 to 10; and
at least two of R¹-R⁴, R⁶, R⁷, R⁹, R¹², R¹³, R¹⁵-R¹⁷ or A are independently —SO₃;
wherein when:
one of R⁶ or R¹² is —SO₃, then one of R⁶ or R¹² is H, —OH, or C₁-C₆ alkyl;
one of R⁶ or R¹² is —OH, then one of R⁶ or R¹² is H, —SO₃ or C₁-C₆ alkyl;
one of R⁹ or R¹⁵ is —SO₃, then one of R⁹ or R¹⁵ is H, —OH, or C₁-C₆ alkyl;
one of R⁹ or R¹⁵ is —OH, then one of R⁹ or R¹⁵ is H, —SO₃ or C₁-C₆ alkyl;
one of R⁷ or R¹³ is —SO₃, then one of R⁷ or R¹³ is H, —OH, or C₁-C₆ alkyl; and
one of R⁷ or R¹³ is —OH, then one of R⁷ or R¹³ is H, —SO₃ or C₁-C₆ alkyl.

The description and illustration of one or more embodiments provided in this application are not intended to limit or restrict the scope of the invention as claimed in any way. The embodiments, examples, and details provided in this disclosure are considered sufficient to convey possession and enable others to make and use the best mode of the claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope. For instance, such other examples are intended to be within the scope of the claims if they have structural or methodological elements that do not differ from the literal language of the claims, or if they include equivalent structural or methodological elements with insubstantial differences from the literal language of the claims, etc. All citations referred to herein are expressly incorporated by reference.

What is claimed is:

1. A method for treating a subterranean formation with a fluid, comprising:
(a) combining a single-phase liquid surfactant package with an aqueous-based injection fluid to form a low interfacial tension (IFT) injection fluid having an interfacial tension (IFT) of from 0.005 to 1 dynes/cm with a hydrocarbon phase present in the subterranean formation; and
(b) introducing the low IFT injection fluid into the subterranean formation;
wherein the low IFT injection fluid has a maximum particle size of less than 0.1 micrometers in diameter in particle size distribution measurements performed at a temperature and salinity of the subterranean formation.

2. The method of claim 1, wherein the method further comprises
(c) allowing the low interfacial tension (IFT) injection fluid to contact the wellbore, the surface structures fluidly connected to the wellbore, the equipment connected to the wellbore, the subterranean formation, or any combination thereof for a period of time.

3. The method of claim 1, wherein the single-phase liquid surfactant package comprises a first non-ionic surfactant, optionally a second non-ionic surfactant, and an anionic surfactant and wherein the first non-ionic surfactant comprises a branched or unbranched C₆-C₁₅:PO(7-65):EO(10-65), C16-C18:PO(7-65):EO(10-65), or C19-C32:PO(7-65):EO(10-65); a cyclic C6-C60:PO(7-65):EO(10-65), or C32-C60:PO(7-65):EO(10-65), and the second non-ionic surfactant comprises a branched or unbranched C6-C32:EO(8-65), C6-C32:EO(20-30), C6-C32:EO(20-25), C10-C25:EO(20-25), C9-C22:EO(8-65), C12-C14:EO(8-65), or C14-C22:EO(15-25).

4. A method for treating scale deposit formation in a wellbore, on surface structures fluidly connected to a wellbore, on equipment connected to a wellbore, in a subterranean formation, or any combination thereof comprising:
(a) combining a single-phase liquid surfactant package with an aqueous-based injection fluid to form a low interfacial tension (IFT) injection fluid having an interfacial tension (IFT) of from 0.005 to 1 dynes/cm with a hydrocarbon phase present in the subterranean formation;
(b) introducing the low interfacial tension (IFT) injection fluid into the wellbore, on surface structures fluidly connected to the wellbore, on equipment connected to the wellbore, in the subterranean formation, or any combination thereof, and
(c) allowing the low interfacial tension (IFT) injection fluid to contact the wellbore, the surface structures fluidly connected to the wellbore, the equipment connected to the wellbore, the subterranean formation, or any combination thereof for a period of time.

5. The method of claim 4, wherein the single-phase liquid surfactant package comprises a first non-ionic surfactant, optionally a second non-ionic surfactant, and an anionic surfactant wherein the first non-ionic surfactant comprises a branched or unbranched C6-C15:PO(7-65):EO(10-65), C16-C18:PO(7-65):EO(10-65), or C19-C32:PO(7-65):EO(10-65); a cyclic C6-C60:PO(7-65):EO(10-65), or C32-C60:PO(7-65):EO(10-65), and the second non-ionic surfactant comprises a branched or unbranched C6-C32:EO(8-65), C6-C32:EO(20-30), C6-C32:EO(20-25), C10-C25:EO(20-25), C9-C22:EO(8-65), C12-C14:EO(8-65), or C14-C22:EO(15-25).

6. The method of claim 5, wherein the anionic surfactant comprises a disulfonate, sulfosuccinate, or any combination thereof.

7. The method of claim 4, wherein the scale deposit comprises an asphaltene precipitate, a paraffin, or any combination thereof.

8. The method of claim 4, wherein the low interfacial tension (IFT) fluid has a maximum particle size of less than 0.1 micrometers in diameter in particle size distribution measurements performed at a temperature and salinity of the subterranean formation.

9. The method of claim 4, wherein the single-phase liquid surfactant package comprises one or more secondary surfactants and wherein the one or more secondary surfactants comprise an anionic, a non-ionic surfactant, a cationic surfactant, a zwitterionic surfactant, or any combination thereof.

10. The method of claim 9, wherein the non-ionic surfactant comprises a branched or unbranched C6-C32:PO(0-65):EO(0-100), a branched or unbranched C6-C32:PO(30-40):EO(25-35), a branched or unbranched C6-C12:PO(30-40):EO(25-35), a branched or unbranched C6-C32:EO(8-30), or any combination thereof.

11. The method of claim 9, wherein the anionic surfactant comprises a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof.

12. The method of claim 9, wherein the anionic surfactant comprises a branched or unbranched C6-C32:PO(0-65):EO(0-100)-carboxylate, a branched or unbranched C6-C32:PO(30-40):EO(25-35)-carboxylate, a branched or unbranched C6-C12:PO(30-40):EO(25-35)-carboxylate, C6-C32:PO(0-65):EO(0-100)-sulfate, C6-C32:PO(0-65):EO(0-100)-disulfate, C6-C32:PO(0-65):EO(0-100)-sulfonate, C6-C32:PO(0-65):EO(0-100)-disulfonate, C6-C32:PO(0-65):EO(0-100)-sulfosuccinate, C6-C32:PO(0-65):EO(0-100)-disulfosuccinate, a branched or unbranched C6-C32:EO(8-30)-carboxylate, or any combination thereof.

13. The method of claim 9, wherein the anionic surfactant comprises a surfactant defined by the formula below
R1-R2-R3
wherein
R1 comprises a branched or unbranched, saturated or unsaturated, cyclic or non-cyclic, hydrophobic carbon chain having 6-32 carbon atoms and an oxygen atom linking R1 and R2;
R2 comprises an alkoxylated chain comprising at least one oxide group selected from the group consisting of ethylene oxide, propylene oxide, butylene oxide, and combinations thereof, and
R3 comprises a branched or unbranched hydrocarbon chain comprising 2-12 carbon atoms and from 2 to 5 carboxylate groups.

14. The method of claim 9, wherein the anionic surfactant comprises a surfactant defined by the formula below 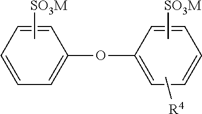
wherein
R4 is a branched or unbranched, saturated or unsaturated, cyclic or non-cyclic, hydrophobic carbon chain having 6-32 carbon atoms; and
M represents a counterion.

15. A method for fracturing an unconventional subterranean formation with a fluid, comprising:
(a) combining a single-phase liquid surfactant package with an aqueous-based injection fluid to form a low interfacial tension (IFT) injection fluid having an interfacial tension (IFT) of from 0.005 to 1 dynes/cm with a hydrocarbon phase present in the subterranean formation; and
(b) injecting the low interfacial tension (IFT) injection fluid through a wellbore and into the unconventional subterranean formation at a sufficient pressure and at a sufficient rate to fracture the unconventional subterranean formation.

16. The method of claim 15, wherein the low interfacial tension (IFT) injection fluid further comprises a proppant and a friction reducer.

17. The method of claim 15, wherein the single-phase liquid surfactant package comprises a first non-ionic surfactant, optionally a second non-ionic surfactant, and an anionic surfactant wherein the first non-ionic surfactant comprises a branched or unbranched C6-C15:PO(7-65):EO(10-65), C16-C18:PO(7-65):EO(10-65), or C19-C32:PO(7-65):EO(10-65); a cyclic C6-C60:PO(7-65):EO(10-65), or C32-C60:PO(7-65):EO(10-65), and the second non-ionic surfactant comprises a branched or unbranched C6-C32:EO(8-65), C6-C32:EO(20-30), C6-C32:EO(20-25), C10-C25:EO(20-25), C9-C22:EO(8-65), C12-C14:EO(8-65), or C14-C22:EO(15-25).

18. The method of claim 17, wherein the anionic surfactant comprises a disulfonate, sulfosuccinate, or any combination thereof.

19. A method for treating a subterranean formation with a fluid, comprising:
(a) combining a single-phase liquid surfactant package with an aqueous-based injection fluid to form a low interfacial tension (IFT) injection fluid having an interfacial tension (IFT) of from 0.005 to 1 dynes/cm with a hydrocarbon phase present in the subterranean formation; and
(b) introducing the low IFT injection fluid into the unconventional subterranean formation;
wherein the single-phase liquid surfactant comprises (1) a first nonionic surfactant comprising C24-C32:PO(20-40):EO(20-35), a second nonionic surfactant comprising C9-C22:EO(8-45), and an anionic surfactant; or (2) a first nonionic surfactant comprising C16-C28:PO(20-40):EO(20-45) and an anionic surfactant.

20. The method of claim 19, wherein the anionic surfactant comprises a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof.
